(19) United States
(12) Patent Application Publication
(10) Pub. No.: US 2009/0233059 A1
(43) Pub. Date: Sep. 17, 2009

(54) Pigment dispersion, method for producing pigment dispersion, water-based ink composition comprising pigment dispersion, ink jet recording method using ink composition and ink jet recorded matter using ink composition

(75) Inventors: Hitoshi Ota, Shiojiri-shi (JP); Hiroshi Nagasaki, Hagena-ken (JP); Yoshimasa Tamura, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/381,025

(22) Filed: Mar. 6, 2009

(30) Foreign Application Priority Data
Mar. 6, 2008 (JP) 2008-055900
Feb. 20, 2009 (JP) 2009-038154

(51) Int. Cl. C09D 11/10; B05D 5/00; B41M 5/00

(52) U.S. Cl. 428/195.1; 427/256; 524/556; 524/380; 524/261; 524/81; 524/210; 524/105; 524/104; 524/99; 524/91; 524/378; 524/377; 524/27; 524/215

(57) ABSTRACT

A water-based ink composition that has high ejection stability even when it is used in an ink jet recording method that involves a high driving frequency and that can achieve high-resolution printing, a pigment dispersion for use in the water-based ink composition, and a method for producing the pigment dispersion are provided. Moreover, an inkjet recording method and a recorded matter using the water-based ink composition are provided.

A pigment dispersion of the present invention is a pigment dispersion at least containing a pigment, a water-insoluble polymer that coats the pigment to make the pigment dispersible in water, a wetting agent, and water, wherein the pigment dispersion is prepared by heating a dispersion at least containing the pigment, the water-insoluble polymer, and 0.1 mass % to 10 mass % of the wetting agent relative to the total amount of the dispersion.

### CROSS-REFERENCES TO RELATED APPLICATIONS

The entire disclosure of Japanese Patent Application No. 2008-55900, filed on Mar. 6, 2008, and No. 2009-038154, filed on Feb. 20, 2009, is expressly incorporated by reference herein.

### FIELD OF THE INVENTION

The present invention relates to a pigment dispersion having excellent dispersion stability (storage stability) and a method for producing the pigment dispersion. The present invention also relates to a water-based ink composition containing the pigment dispersion and suitable for ink-jet recording methods. The present invention further relates to an ink jet recording method and a recorded matter using the water-based ink composition.

### BACKGROUND OF THE INVENTION

Ink jet recording methods are recording methods by which ink droplets are allowed to fly (ejected) and adhere on a recording medium such as paper or the like to conduct recording. Due to recent innovative advancements in ink jet recording technology, ink jet recording methods are being increasingly employed in high-resolution image recording (printing) which has been carried out by silver halide photography or offset printing heretofore. In this regard, one of the properties required for ink used in ink jet recording methods is the capacity to form ink droplets to be ejected stably over a long term so as to avoid disturbances of images.

The mainstream ink used in the ink jet recording methods is water-based ink mainly composed of water and containing coloring matters, water-soluble organic solvents, surfactants, etc., since this ink has high safety, is available at low cost, can be handled easily, etc. Although dyes and pigments are available as the coloring matters, a large number of water-soluble dyes have been used and studied heretofore since they have colors of high chroma, can be made from a wide variety of materials, have stability (solubility) in the main component, i.e., water, etc. However, recorded matters recorded with ink containing water-soluble dyes (hereinafter referred to as “dye ink”) are sometimes inferior in properties (i.e., storage property of the recorded matter) such as light fastness, gas resistance, water resistance, etc. In contrast, pigments have light fastness, gas resistance, and water resistance superior to those of water-based dyes; thus, development of the ink containing pigments (hereinafter referred to as “pigment ink”) has accelerated in recent years. However, pigments are generally insoluble in water and have poor compatibility with water. Thus, in order to use pigments in water-based ink, pigments must be made compatible with water so that they remain stably dispersed in water while preventing problems such as sedimentation and the like. Examples of the methods for making pigments compatible with water proposed heretofore include a method using dispersants such as surfactants, resin, or the like with pigments, methods in which pigments are coated with water-dispersive resin to form colored fine particles, and methods in which water-based functional groups are chemically and/or physically bonded to surfaces of pigments so as to make pigments self-dispersible. There have been many studies and proposals, in using these pigments to form water-based pigment ink, as to the types, amounts, combinations, etc., of additives (e.g., water-soluble organic solvents, surfactants, etc.) to be used in the ink in order to satisfy the required properties (ejection stability and the like) described above.

For example, Japanese Patent No. 3509013 (Patent Document 1) proposes a pigment ink involving a combination of an acetylene glycol-based surfactant having a particular structure, triethylene glycol monobutyl ether, 2-pyrrolidone, and a water-soluble organic solvent. The ink is described as having good ejection stability and clogging reliability. Moreover, Japanese Unexamined Patent Application Publication No. 2005-120181 (Patent Document 2), Japanese Unexamined Patent Application Publication No. 2005-263967 (Patent Document 3), and Japanese Unexamined Patent Application Publication No. 2005-263969 (Patent Document 4) propose pigment ink containing silicon-based surfactants. This ink is described as having good continuous printing stability and capacity to form images with less blurs. Japanese Unexamined Patent Application Publication No. 2006-316243 (Patent Document 5) proposes a pigment ink containing a fluorine-based surfactant, and this ink is described as inflicting less blurs and exhibiting good ejection stability.

On the other hand, a technique for more stably dispersing pigment particles in pigment ink has been investigated in which pigment ink or a pigment dispersion used for the pigment ink is subjected to treatment to achieve stability. For example, Japanese Unexamined Patent Application Publication No. 2000-345093 (Patent Document 6) proposes a technique of heat-treating a pigment dispersion containing a pigment, water, and an alkali-soluble-type resin dispersant having an acid value of 90 or less, or a pigment ink. It is described that the physical properties of this ink change little and the ink has good dispersion stability. Japanese Unexamined Patent Application Publication No. 2008-38007 (Patent Document 7) proposes a heat sterilization treatment technique in which a water-based pigment dispersion is treated for 1 to 10 hours at a heating temperature of 50° C. to 95° C. It is described that such a heat sterilization treatment conducted on the water-based pigment dispersion suppresses contamination of the water-based pigment dispersion with microorganisms and thus changes in physical properties such as particle diameter, viscosity, pH, and the like are suppressed. It is also described that the ink using this dispersion prevents clogging of head nozzles when applied to ink jet recording methods.

### RELATED ART

[Patent Document 1] Japanese Patent No. 3509013

[Patent Document 2] Japanese Unexamined Patent Application Publication No. 2005-120181

[Patent Document 3] Japanese Unexamined Patent Application Publication No. 2005-263967

[Patent Document 4] Japanese Unexamined Patent Application Publication No. 2005-263969

[Patent Document 5] Japanese Unexamined Patent Application Publication No. 2006-316243

[Patent Document 6] Japanese Unexamined Patent Application Publication No. 2000-345093

[Patent Document 7] Japanese Unexamined Patent Application Publication No. 2008-38007

### SUMMARY OF THE INVENTION

### Problems to be Solved by the Invention

Presently, ever higher resolution and speed for printing are desired in ink jet recording methods. Under such trends, the amount of ink droplets ejected is decreasing as the density of the nozzles of ink-ejecting heads increases. Moreover, the driving frequency for ejecting ink tends to be higher. Thus, the ink to be used is required to fly straight at a low ink droplet amount and at a high driving frequency, i.e., required to exhibit a higher ejection stability. However, studies by the inventor of the present invention on the inks that have been proposed in the related art described above have found that ejection stability is not sufficient in some cases. In particular, phenomena such as blurring of images caused by unstable ink droplet ejection were observed. Occurrence of such phenomena was particularly frequent in high-speed printing (i.e., high-driving-frequency regions).

Thus, an object of the present invention is to provide a water-based ink composition that has high ejection stability even at a high driving frequency and can create high-resolution printing by ink jet recording methods, a pigment dispersion used in the water-based ink composition, and a method for producing the pigment dispersion. Another object of the present invention is to provide an ink jet recording method using the water-based ink composition and a recorded matter.

### Means for Solving the Problems

In other words, the present invention is as follows:

(1) A pigment dispersion at least comprising a pigment, a water-insoluble polymer that coats the pigment to make the pigment dispersible in water, a wetting agent, and water,

wherein the pigment dispersion is prepared by heating a dispersion at least containing the pigment, the water-insoluble polymer, and 0.1 mass % to 10 mass % of the wetting agent relative to the total amount of the dispersion.

(2) The pigment dispersion according to (1) above at least comprising the pigment, the water-insoluble polymer that coats the pigment to make the pigment dispersible in water, the wetting agent, and water,

wherein the pigment dispersion is prepared by heating a dispersion at least containing a dispersoid constituted by the pigment coated with the water-insoluble polymer, 0.1 mass % to 10 mass % of the wetting agent relative to the total amount of the dispersion, and water.

(3) The pigment dispersion according to (1) or (2) above, wherein the wetting agent contained in the dispersion is at least one selected from the group consisting of an acetylene glycol-based surfactant, an acetylene alcohol-based surfactant, a siloxane-based surfactant, a fluorine-based surfactant, a polyoxyalkylene-based nonionic surfactant, an anionic surfactant, a resin solvent, a glycerol ether compound represented by formula (I) below, an amide compound, an imidazole derivative, an azine compound, an azole compound, an amidine derivative, a hydroxypyridine derivative, a purine derivative, and a hydroxy cyclic amine compound.

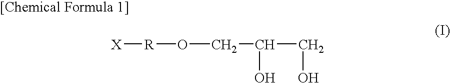

(In the formula, R represents a linear, branched, or cyclic alkyl group having 1 to 20 carbon atoms and optionally containing a double bond, a triple bond, or a substituent, or a substituted or unsubstituted aryl group. X represents a hydrogen atom, a hydroxyl group, or a linear or branched alkoxy group having 1 to 5 carbon atoms.)
(4) The pigment dispersion according to any one of (1) to (3) above, wherein the heating temperature during the heat treatment is in the range of 65° C. to 100° C. and the heating time is in the range of 30 minutes to 100 hours.
(5) The pigment dispersion according to any one of (1) to (4) above, wherein the dispersion further contains a water-soluble organic solvent.
(6) The pigment dispersion according to (5) above, wherein the water-soluble organic solvent is at least one selected from the group consisting of a monohydric alcohol, a polyhydric alcohol, a sugar, a glycol ether, and a 1,2-alkyldiol.
(7) A method for producing a pigment dispersion for use in a water-based ink composition, the method comprising:

a heat treatment step of heating a dispersion at least containing a pigment, a water-insoluble polymer that coats the pigment to make the pigment dispersible in water, and a wetting agent,

wherein, in the heat treatment step, the total amount of the wetting agent is in the range of 0.1 mass % to 10 mass % relative to the total amount of the dispersion.

(8) The method for producing a pigment dispersion according to (7) above, wherein the heat treatment step comprises heating a dispersion at least containing a dispersoid constituted by the pigment coated with the water-insoluble polymer, the wetting agent, and water, and

in the heat treatment step, the total amount of the wetting agent is in the range of 0.1 mass % to 10 mass % relative to the total amount of the dispersion.

(9) The method for producing a pigment dispersion according to (7) or (8) above, wherein the wetting agent is at least one selected from the group consisting of an acetylene glycol-based surfactant, an acetylene alcohol-based surfactant, a siloxane-based surfactant, a fluorine-based surfactant, a polyoxyalkylene-based nonionic surfactant, an anionic surfactant, a resin solvent, a glycerol ether compound represented by formula (I) below, an amide compound, an imidazole derivative, an azine compound, an azole compound, an amidine derivative, a hydroxypyridine derivative, a purine derivative, and a hydroxy cyclic amine compound.

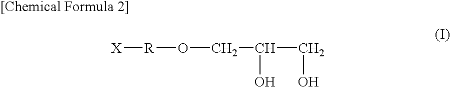

(In the formula, R represents a linear, branched, or cyclic alkyl group having 1 to 20 carbon atoms and optionally containing a double bond, a triple bond, or a substituent, or a substituted or unsubstituted aryl group. X represents a hydrogen atom, a hydroxyl group, or a linear or branched alkoxy group having 1 to 5 carbon atoms.)
(10) The method for producing a pigment dispersion according to any one of (7) to (9) above, wherein, in the heat treatment step, the heating temperature is in the range of 65° C. to 100° C. and the heating time is in the range of 30 minutes to 100 hours.
(11) The method for producing a pigment dispersion according to any one of (7) to (10) above, wherein the dispersion further contains a water-soluble organic solvent.
(12) The method for producing a pigment dispersion according to (11) above, wherein the water-soluble organic solvent is at least one selected from the group consisting of a monohydric alcohol, a polyhydric alcohol, a sugar, a glycol ether, and a 1,2-alkyldiol.
(13) A water-based ink composition containing the pigment dispersion according to any one of (1) to (6) above or a pigment dispersion obtained by the method for producing a pigment dispersion according to any one of (7) to (12) above.
(14) The water-based ink composition according to (13) above, comprising at least one penetrant selected from the group consisting of a monohydric alcohol, a glycol ether, and a 1,2-alkyldiol.
(15) The water-based ink composition according to (13) or (14) above, comprising at least one humectant selected from the group consisting of a polyhydric alcohol, a sugar, a lactam, and a urea.
(16) The water-based ink composition according to any one of (13) to (15) above, further comprising a polymer emulsion.
(17) An ink jet recording method including ejecting droplets of an ink composition and causing the droplets to adhere on a recording medium to conduct printing, wherein the water-based ink composition according to any one of (13) to (16) above is used.
(18) A recorded matter recorded by the ink jet recording method of (17) above.

### ADVANTAGES

A pigment dispersion of the present invention has excellent dispersion stability (storage stability). Moreover, a water-based ink composition containing the pigment dispersion has good flight stability, i.e., ejection stability, even when continuously ejected at a high driving frequency, and is thus suitable for high-resolution, high-speed ink jet recording methods.

### DETAILED DESCRIPTION OF THE PRESENT INVENTION

A pigment dispersion of the present invention at least contains a pigment, a water-insoluble polymer that coats the pigment to make the pigment dispersible in water, a wetting agent, and water.

The pigment dispersion is prepared by heating a dispersion at least containing the pigment, the water-insoluble polymer, and 0.1 mass % to 10 mass % of the wetting agent relative to the total amount of the dispersion. The dispersion used in the heat treatment is preferably prepared by dispersing, in water, a dispersoid constituted by the pigment coated with the water-insoluble polymer.

A method for producing a pigment dispersion according to the present invention is a method for producing a pigment dispersion to be used in a water-based ink composition, the method including a heat treatment step of heating a dispersion at least containing a pigment, a water-insoluble polymer that coats the pigment to make the pigment dispersible in water, and a wetting agent, in which, in the heat treatment step, the total amount of the wetting agent is in the range of 0.1 mass % to 10 mass % relative to the total amount of the dispersion. The dispersion used in the heat treatment is preferably prepared by dispersing, in water, a dispersoid constituted by the pigment coated with the water-insoluble polymer.

A water-based ink composition of the present invention contains the pigment dispersion described above or a pigment dispersion obtained by the method for producing a pigment dispersion described above.

An ink jet recording method of the present invention is an ink jet recording method including ejecting droplets of an ink composition and causing the droplets to adhere on a recording medium to conduct printing, in which the water-based ink composition described above is used.

A recorded matter of the present invention is recorded by the ink jet recording method described above.

The constitutional components of the pigment dispersion, the method for producing the pigment dispersion, and the constitutional components of the water-based ink composition according to the present invention are described below.

[Pigment Dispersion]

The pigment dispersion of the present invention uses a pigment as a coloring matter.

(Pigment)

Pigments are insoluble or hardly soluble in water and have a property to resist discoloration by light, gas, etc. Thus, recorded matters printed with ink compositions containing pigments have excellent water resistance, gas resistance, light fastness, and the like, and exhibit good storage property. Pigments that can be used in the present invention may be any inorganic pigments, organic pigments, and carbon black known in the art. Among these, carbon black and organic pigments are particularly preferred since they have good color development and do not easily settle during dispersing due to low specific gravity.

In the present invention, specific examples of preferable carbon black include No. 2300, 900, MCF88, No. 20B, No. 33, No. 40, No. 45, No. 52, MA7, MA8, MA100, and No 2200B (all of the foregoing are trade names, products of Mitsubishi Chemical Corporation), Color Black FW1, FW2, FW2V, FW18, FW200, S150, S160, and S170, Pritex 35, U, V, and 140U, Special Black 6, 5, 4A, 4, and 250 (all of the foregoing are trade names, products of Degussa Corporation), Conductex SC, Raben 1255, 5750, 5250, 5000, 3500, 1255, and 700 (all of the foregoing are trade names, products of Columbia Carbon Corporation), and Regal 400R, 330R, and 660R, Mogul L, Monarch 700, 800, 880, 900, 1000, 1100, 1300, and 1400, and Elftex 12 (all of the foregoing are trade names, products of Cabot Corporation). These are merely examples of the carbon black preferred in the present invention and do not limit the scope of the present invention. These carbon blacks may be used alone or in combination.

The pigment content is 0.5 to 40 mass % and preferably 5 to 20 mass % relative to the total amount of the pigment dispersion.

Examples of the organic pigments preferred in the present invention include quinacridon-based pigments, quinacridon quinone-based pigments, dioxazine-based pigments, phthalocyanine-based pigments, anthrapyrimidine-based pigments, anthanthrone-based pigments, indanthrone-based pigments, flavanthrone-based pigments, perylene-based pigments, diketopyrrolopyrrole-based pigments, perinone-based pigments, quinophthalone-based pigments, anthraquinone-based pigments, thioindigo-based pigments, benzimidazolone-based pigments, isoindolinone-based pigments, azomethine-based pigments, and azo-based pigments.

Specific examples of the organic pigments used in the pigment dispersion of the present invention include the following.

Examples of the pigments used in a cyan pigment dispersion include C. I. pigment blue 1, 2, 3, 15:3, 15:4, 15:34, 16, 22, 60, etc.; and C. I. vat blue 4, 60, etc. Preferably, the pigment is one or a mixture of a combination of two or more selected from the group consisting of C. I. pigment blue 15:3, 15:4, and 60. The pigment content is 0.5 to 40 mass % and preferably 5 to 20 mass % relative to the total amount of the cyan pigment dispersion.

Examples of the pigments used in a magenta pigment dispersion include C. I. pigment red 5, 7, 12, 48 (Ca), 48 (Mn), 57 (Ca), 57:1, 112, 122, 123, 168, 184, and 202, C. I. pigment violet 19, etc. Preferably, the pigment is one or a mixture of a combination of two or more selected from the group consisting of C. I. pigment red 122, 202, and 209 and C. I. pigment violet 19. The pigment content is 0.5 to 40 mass % and preferably 5 to 20 mass % relative to the total amount of the magenta pigment dispersion.

Examples of the pigments used in an yellow pigment dispersion include C. I. pigment yellow 1, 2, 3, 12, 13, 14C, 16, 17, 73, 74, 75, 83, 93, 95, 97, 98, 119, 110, 114, 128, 129, 138, 150, 151, 154, 155, 180, and 185. Preferably, the pigment is one or a mixture of a combination of two or more selected from the group consisting of C. I. pigment yellow 74, 109, 110, 128, 138, and 180. The pigment content is 0.5 to 40 mass % and preferably 5 to 20 mass % relative to the total amount of the yellow pigment dispersion.

Examples of the pigments used in an orange pigment dispersion include C. I. pigment orange 36 and 43 and mixtures thereof. The pigment content is 0.5 to 40 mass % and preferably 5 to 20 mass % relative to the total amount of the orange pigment dispersion.

Examples of the pigments used in a green pigment dispersion include C. I. pigment green 7 and 36 and mixtures thereof. The pigment content is 0.5 to 40 mass % and preferably 5 to 20 mass % relative to the total amount of the green pigment dispersion.

(Water-Insoluble Polymer)

The pigment dispersion of the present invention contains a water-insoluble polymer that coats the above-described pigment to make the pigment dispersible in water. The water-insoluble polymer is composed of a block copolymer resin constituted by a monomer having a hydrophobic group and a monomer having a hydrophilic group, at least contains a monomer having a salt-forming group, and has a solubility of less than 1 g in 100 g of water at 25° C. after neutralization.

Examples of the monomer having a hydrophobic group include methacrylic acid esters such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, and glycidyl methacrylate; vinyl esters such as vinyl acetate; vinyl cyan compounds such as acrylonitrile and methacrylonitrile; and aromatic vinyl monomers such as styrene, α-methyl styrene, vinyl toluene, 4-tert-butyl styrene, chlorostyrene, vinyl anisole, and vinyl naphthalene. These may be used alone or as a mixture of two or more.

Examples of the monomer having a hydrophilic group include polyethylene glycol monomethacrylate, polypropylene glycol monomethacrylate, and ethylene glycol.propylene glycol monomethacrylate. These monomers may be used alone or as a mixture of two or more. In particular, when monomer components that constitute branched chains, such as polyethylene glycol (2-30) monomethacrylate, (poly)ethylene glycol (1-15).(poly)propylene glycol (1-15) monomethacrylate, polypropylene glycol (2-30) monomethacrylate, methoxypolyethylene glycol (2-30) methacrylate, methoxypolytetramethylene glycol (2-30) methacrylate, and methoxy(ethylene glycol.propylene glycol copolymer) (1-30) methacrylate are used, the glossiness of printed images tends to improve, which is preferable.

Examples of the monomer having a salt-forming group include acrylic acid, methacrylic acid, styrene carboxylic acid, and maleic acid. These may be used alone or as a mixture of two or more.

In addition, macromonomers having a polymerizable functional group at one end, such as a styrene-based macromonomer, a silicone-based macromonomer, or the like and other monomers may be used in combination.

The water-insoluble polymer of the present invention is obtained by copolymerizing monomers by a known polymerization technique such as mass polymerization, solution polymerization, suspension polymerization, and emulsion polymerization techniques. In particular, the solution polymerization technique is preferred. During polymerization, a known radical polymerization initiator and/or a known polymerization chain transfer agent may be added.

The water-insoluble polymer of the present invention preferably has a weight-average molecular weight in the range of about 10,000 to 150,000 from the viewpoint of coating the pigment and making the pigment stably dispersible in water and the viewpoint of adjusting the viscosity of the water-based ink composition containing the water-insoluble polymer to a level that enables stable ejection by ink jet recording methods. The weight-average molecular weight can be measured by molecular weight analysis through gel permeation chromatography (GPC).

The water-insoluble polymer obtained from monomer species and by synthetic methods described above contains hydrophilic groups and hydrophobic groups at a proper balance. The pigment can be coated since the hydrophobic group moieties efficiently and effectively adsorb on the hydrophobic pigment particle surfaces, and the pigment can be made stably dispersible in water since the hydrophilic group moieties are compatible with water. Thus, the pigment particles originally poorly compatible with water can be stably dispersed in water, which is preferable.

(Dispersoid)

In the pigment dispersion of the present invention, the coloring matter (pigment) is preferably present by taking form of a dispersoid which has been rendered dispersible in water as a result of the pigment being coated with the water-insoluble polymer (hereinafter the dispersoid may also be referred to as “pigment dispersoid”). One example of the method for coating the pigment with the water-insoluble polymer according to the present invention involves dissolving the polymer obtained from and by the materials and methods described above in an organic solvent such as methanol, ethanol, isopropanol, n-butanol, acetone, methyl ethyl ketone, dibutyl ether, or the like, adding the pigment to the resulting solution, adding a neutralizer and water to conduct kneading and dispersing treatment to prepare an oil-in-water type dispersoid, and removing the organic solvent from the resulting dispersoid dispersion to prepare a water dispersoid dispersion. In the kneading and dispersing treatment, a ball mill, a roll mill, a bead mill, a high-pressure homogenizer, a high-speed kneader-type dispersing machine, or the like may be used, for example. In the pigment-water-insoluble polymer coating step, the wetting agent described below may be added to conduct heat treatment.

The neutralizer is preferably an organic amine, e.g., a volatile amine compound such as ethylamine, trimethylamine, triethylamine, tributylamine, dimethylethanolamine, diisopropanolamine, or morpholine, a low-volatility high-boiling-point amine such as diethanolamine, triethanolamine, or tripropanolamine, an alkali metal hydroxide such as lithium hydroxide, potassium hydroxide, or sodium hydroxide, ammonia, or the like. The pH of the resulting water dispersoid dispersion is preferably in the range of 6 to 10 at 25° C.

The dispersoid prepared from and by the materials and method described above preferably has a pigment-to-water insoluble-polymer ratio of pigment:water insoluble polymer=10:2 to 10:10 on a mass basis. When the ratio of the pigment to the water insoluble polymer is within this range, the dispersion stability and storage stability of the pigment dispersion and the water-based composition using the pigment dispersion, and the glossiness of images are satisfactory. The particle diameter of the dispersoid is preferably in the range of 50 nm to 150 nm in terms of volume-average particle diameter. When the particle diameter is within this range, the dispersion stability and glossiness can be further improved. The particle diameter can be measured with Microtrac UPA150 (trade name, product of Micro Track Co., Ltd.), particle size distribution analyzer, LPA3100 (trade name, product of Otsuka Electronics Co., Ltd.), or the like.

As for the dispersoid of the present invention constituted by the pigment coated with the water-insoluble polymer, the pigment need not be completely coated with the water-insoluble polymer and some parts of the pigment surfaces may remain exposed.

(Wetting Agent)

The pigment dispersion of the present invention contains a wetting agent in addition to the pigment and the water-insoluble polymer described above. The wetting agent of the present invention is selected from those which have good compatibility with both the pigment and the water-insoluble polymer. As a result, in the heating treatment described below, the effect of interadsorption between the pigment and the water-insoluble polymer becomes stronger, the dispersion stability of the dispersoid constituted by the pigment and the water-insoluble polymer improves, and the ejection stability of the water-based ink composition containing the dispersion can be dramatically improved. Examples of the wetting agent that has such properties include an acetylene glycol-based surfactant, an acetylene alcohol-based surfactant, a siloxane-based surfactant, a fluorine-based surfactant, a polyoxyalkylene-based nonionic surfactant, an anionic surfactant, a resin solvent, a glycerol ether compound represented by formula (I) below, an amide compound, an imidazole derivative, an azine compound, an azole compound, an amidine derivative, a hydroxypyridine derivative, a purine derivative, and a hydroxy cyclic amine compound. The wetting agent is preferably at least one selected from this group. For the pigment dispersion of the present invention, the wetting agent is more preferably at least one selected from the group consisting of acetylene glycol, acetylene alcohol, a siloxane-based wetting agent, a fluorine-based wetting agent, a resin solvent, and a glycerol ether. Acetylene glycol and/or acetylene alcohol is particularly preferred.

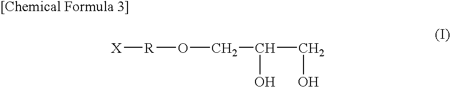

(In the formula, R represents a linear, branched, or cyclic alkyl group having 1 to 20 carbon atoms and optionally containing a double bond, a triple bond, or a substituent, or a substituted or unsubstituted aryl group. X represents a hydrogen atom, a hydroxyl group, or a linear or branched alkoxy group having 1 to 5 carbon atoms.)

The wetting agents described above will now be described in detail.

(A) Acetylene Glycol-Based Surfactant and Acetylene Alcohol-Based Surfactant

The pigment dispersion of the present invention preferably contains, in addition to the pigment and water-insoluble polymer described above, an acetylene glycol-based surfactant and/or an acetylene alcohol-based surfactant as one of the wetting agents. These surfactants have excellent capacity of maintaining the surface tension and interfacial tension to adequate levels and exhibit no or little foaming property. Thus, a water-based ink composition containing such a surfactant maintains adequate levels of surface tension and interfacial tension for a printer part, such as head nozzle face, contacting the ink. When the water-based ink composition is applied to an ink jet recording method, excellent ejection stability is achieved, which is preferable. Since the permeability of the water-based ink composition into the recording medium is satisfactory, images with higher resolution can be easily created. In the heating treatment described below, since the compatibility with both the pigment and the water-insoluble polymer is high, the effect of causing the water-insoluble polymer to strongly adsorb onto the pigment is increased. When the water-based ink composition containing such a wetting agent is applied to the ink jet recording method, ejection stability is improved, which is preferred.

Specific examples of the preferable acetylene glycol-based surfactants and acetylene alcohol-based surfactants include Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, and GA (all of the foregoing are trade names, products of Air Products and Chemicals. Inc.), Olfine B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (all of the foregoing are trade names, products of Nissin Chemical Industry Co., Ltd.), and Acetylenol E00, E00P, E40, and E100 (all of the foregoing are trade names, products of Kawaken Fine Chemicals Co., Ltd.). Among these, Olfine E1010, Surfynol 104PG-50, Acetylenol E00, Surfynol 465, Surfynol 61, Olfine B, and Surfynol 420 are more preferred.

The amount of the acetylene glycol-based surfactant and acetylene alcohol-based surfactant added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the water-based ink composition using the pigment dispersion can be achieved by the heat treatment described below. When not contained, the effect does not appear even when the heat treatment is conducted. When the surfactant is added in an amount more than 10 mass %, the interaction between the water-insoluble polymer and the pigment is obstructed, dispersibility is inhibited, and dispersion stability is not achieved.

(B) Siloxane-Based Surfactant

The pigment dispersion of the present invention preferably contains, in addition to the pigment and the water-insoluble polymer described above, a siloxane-based surfactant as one of the wetting agents. Since this surfactant has excellent compatibility with both the pigment and the water-insoluble polymer, the effect of causing the water-insoluble polymer to strongly adsorb onto the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred. Specific examples of the siloxane-based surfactant preferred in the present invention include BYK-300, BYK-301, BYK-302, BYK-303, BYK-306, BYK-307, BYK-310, BYK-315, BYK-320, BYK-322, BYK-323, BYK-325, BYK-330, BYK-331, BYK-333, BYK-337, BYK-341, BYK-344, BYK-345, BYK-346, BYK-347, BYK-348, BYK-370, BYK-375, BYK-377, and BYK-378 (all of the foregoing are trade names, products of BYK Japan KK), KF-96, KS-604, KF-6702, FA-630, KM-71, KM-75, KM-85, KM-89, KM-90, KM-98, KM-68-1F, KS-508, KS-530, KS-531, KS-537, KS-538, KF-6004, KF-351A, KF-352A, KF-353, KF-354L, KF-355A, KF-615A, KF-945, KF-640, KF-642, KF-643, KF-6020, X-22-6191, X-22-4515, KF-6011, KF-6012, KF-6015, and KF-6017 (all of the foregoing are trade names, products of Shin-Etsu Chemical Co., Ltd.), and SH200, FS1265, DK Q1-071, FS ANTIFOAM92, DK Q1-1247, FS ANTIFOAM 1277, FS ANTIFOAM 013A, 74 ANTIFOAM FLUID, 71 ANTIFOAM FLUID, 82 ANTIFOAM FLUID, 1247 ANTIFOAM EMULSION, 1266 ANTIFOAM EMULSION, 1287 ANTIFOAM FLUID, SH5561, SM5512, 19 ADDITIVE, 29 ADDITIVE, 32 ADDITIVE, 52 ADDITIVE, 54 ADDITIVE, 57 ADDITIVE, 67 ADDITIVE, 8028 ADDITIVE, 8029 ADDITIVE, 8211 ADDITIVE, 8503 ADDITIVE, 8598 ADDITIVE, FZ-77, FZ-720, FZ-7001, FZ-7002, FZ-7006, FZ-7604, FZ-2101, FZ-2104, FZ-2105, FZ-2110, FZ-2118, FZ-2120, FZ-2122, FZ-2123, FZ-2130, FZ-2154, FZ-2161, FZ-2162, FZ-2164, FZ-2166, FZ-2191, SF8410, SH8400, SH8700, SH3746, SH3771, SM8706EX, SM7036EX, SM7060EX, SH7024, BY22-737EX, FZ-460, FZ-4157, SM7037EX, SM490EX, BY22-744EX, FZ-4658, FZ-4640, FZ-4634, SM8709, SM8716EX, FZ-4602, BY22-840, SM7001EX, SM7002EX, SM8627EX, DY33-430M, BY22-882, BY22-736EX, BY22-749, and BY22-826EX (all of the foregoing are trade names, products of Dow Corning Toray). Among these, BYK-347, KF-6015, FZ-2118, FZ-2162, KF-640, KF-354L, FZ-7002, and KF-6011 are more preferred.

The amount of the siloxane-based surfactant added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the water-based ink composition using the pigment dispersion can be achieved by the heat treatment described below. When not contained, the effect does not appear even when the heat treatment is conducted. When the surfactant is added in an amount more than 10 mass %, the interaction between the water-insoluble polymer and the pigment is obstructed, dispersibility is inhibited, and dispersion stability is not achieved.

(C) Fluorine-Based Surfactant

The pigment dispersion of the present invention preferably contains, in addition to the pigment and the water-insoluble polymer described above, a fluorine-based surfactant as one of the wetting agents. Since this surfactant has excellent compatibility with both the pigment and the water-insoluble polymer, the effect of causing the water-insoluble polymer to strongly adsorb onto the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred.

Specific examples of the fluorine-based surfactants preferred in the present invention include Megaface F-114, F-410, F-493, F-494, F-443, F-444, F-445, F-446, F-470, F-471, F-474, F-475, F-477, F-478, F-479, F-480SF, F-482, F-483, F-484, F-486, F-487, F-489, F-172D, F-178K, F-178RM, ESM-1, MCF-350SF, R-08, F-472SF, R-30, BL-20, R-61, and R-90 (all of the foregoing are trade names, products of DIC Corporation), FC-430 and FC-4432 (all of the foregoing are trade names, products of Sumitomo 3M Co., Ltd.), EFTOP EF-101, EF-102, EF-103, EF-104, EF-105, EF-112, EF-121, EF-122A, EF-122B, EF-122C, EF-123A, EF-123B, EF-125M, EF-132, EF-201, and EF-204 (all of the foregoing are trade names, products of JEMCO), Surflon S-111n, S-113, S-121, S-131, S-132, S-141, and S-145 (all of the foregoing are trade names, products of AGC Seimi Chemical Co., Ltd.), and Ftergent 100, 100C, 110, 150, 150CH, A-K, 501, 250, 251, 222F, and 208G (all of the foregoing are trade names, products of Neos Company Ltd.). Of these, EFTOP EF-105, Megaface F-470, Megaface F-477, Ftergent 150CH, EFTOP EF-122B, EFTOP EF-122A, and Megaface F-494 are more preferred.

The amount of the fluorine-based surfactant added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the ink composition using the pigment dispersion can be achieved by the heat treatment described below. When not contained, the effect does not appear even when the heat treatment is conducted. When the surfactant is added in an amount more than 10 mass %, the interaction between the water-insoluble polymer and the pigment is obstructed, dispersibility is inhibited, and dispersion stability is not achieved.

(D) Polyoxyalkylene-Based Nonionic Surfactant

The pigment dispersion of the present invention preferably contains, in addition to the pigment and the water-insoluble polymer described above, a polyoxyalkylene-based nonionic surfactant as one of the wetting agents. Since this surfactant has excellent compatibility with both the pigment and the water-insoluble polymer, the effect of causing the water-insoluble polymer to strongly adhere to the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred.

Specific examples of the polyoxyalkylene-based nonionic surfactants preferred in the present invention include polyoxyalkylene alkyl ether, polyoxyalkylene alkenyl ether, polyoxyethylene alkyl ether, polyoxyethylene octyl dodecyl ether, polyoxyethylene oleyl ether, polyoxyethylene distyrenated phenyl ether, polyoxyethylene stearyl ether, polyoxyethylene cetyl ether, polyoxyethylene sorbitan triisostearate, polyoxyethylene sorbitan trioleate, polyoxyethylene sorbitan monostearate, polyoxyethylene sorbitan monooleate, polyoxyethylene sorbitan monopalmitate, polyoxyethylene sorbitan monococoate, polyoxyethylene sorbitan monolaurate, polyoxyethylene tribenzyl phenyl ether, polyoxyethylene bisphenol A laurate, polyoxyethylene.polyoxypropylene glycol, polyoxyethylene myristyl ether, polyoxyethylene lauryl ether, polyoxyethylene hydrogenated castor oil, polyoxyethylene lauryl ether, polyoxyethylene.polyoxypropylene decyl ether, polyoxyethylene behenyl ether, polyoxyethylene cholesteryl ether, polyoxyethylene isocetyl ether, polyoxyethylene isostearyl ether, polyoxyethylene octyldodecyl ether, polyoxyethylene decyl tetradecyl ether, polyoxyethylene glyceryl ether fatty acid ester, polyoxyethylene castor oil, stearic acid polyoxyethylene lauryl ether, isostearic acid polyoxyethylene lauryl ether, stearic acid polyoxyethylene cetyl ether, stearic acid polyoxyethylene stearyl ether, polyoxyethylene hydrogenated castor oil laurate, polyoxyethylene hydrogenated castor oil isostearate, polyoxyethylene hydrogenated castor oil triisostearate, polyoxyethylene trimethylolpropane trimyristate, polyoxyethylene trimethylolpropane distearate, polyoxyethylene trimethylolpropane tristearate, polyoxyethylene trimethylolpropane triisostearate, polyoxyethylene-2-ethylhexyl ether, polyoxyethylene tridecyl ether, polyoxyethylene polycyclic phenyl ether, polyoxyalkylene polycyclic phenyl ether, polyoxyethylene aryl ether, polyoxyalkylene aryl ether, polyoxyethylene cumyl phenyl ether, and polyoxyethylene alkylamine ether. Alternatively, commercially available products belonging to these categories may be used directly. Among these, polyoxyethylene alkyl ether, polyoxyethylene lauryl ether, polyoxyethylene.polyoxypropylene decyl ether, polyoxyethylene octyl dodecyl ether, polyoxyethylene sorbitan monostearate, polyoxyethylene polycyclic phenyl ether, polyoxyethylene hydrogenated castor oil isostearate, polyoxyethylene cumyl phenyl ether, and polyoxyethylene tristearic acid are more preferred.

The amount of the polyoxyalkylene-based nonionic surfactant added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the ink composition using the dispersion can be achieved by the heat treatment described below. When not contained, the effect does not appear even when the heat treatment is conducted. When the surfactant is added in an amount more than 10 mass %, the interaction between the water-insoluble polymer and the pigment is obstructed, dispersibility is inhibited, and dispersion stability is not achieved.

(E) Anionic Surfactant

The pigment dispersion of the present invention preferably contains, in addition to the pigment and the water-insoluble polymer described above, an anionic surfactant as one of the wetting agents. Since this surfactant has excellent compatibility with both the pigment and the water-insoluble polymer, the effect of causing the water-insoluble polymer to strongly adhere to the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred.

Specific examples of the anionic surfactants preferred in the present invention include dodecyl benzene sulfonic acid salt, alkylene disulfonic acid salt, dialkyl succinate sulfonic acid sodium salt, monoalkyl succinate sulfonic acid disodium salt, naphthalene sulfonic acid formalin condensate sodium salt, polyoxyethylene polycyclic phenyl ether sulfuric acid ester salt, polyoxyethylene aryl ether sulfuric acid ester salt, polyoxyethylene alkyl ether sulfuric acid ester salt, polyoxyethylene castor oil ether sulfuric acid ester salt, polyoxyalkylene alkyl ether phosphoric acid ester, polyacrylic acid sodium salt, alkyl diphenyl ether disulfonic acid sodium salt, alkyl naphthalene sulfonic acid sodium salt, oleic acid sodium salt, oleic acid potassium salt, higher alcohol sulfuric acid sodium salt, dialkyl sulfosuccinic acid sodium salt, stearic acid sodium salt, stearic acid potassium salt, partially hydrogenated tallow fatty acid sodium salt, partially hydrogenated tallow fatty acid potassium salt, and lauryl sulfuric acid sodium salt. Alternatively, commercially available products belonging to these categories may be used directly. Among these, naphthalene sulfonic acid formalin condensate sodium salt, sodium stearate, polyoxyethylene polycyclic phenyl ether sulfuric acid ester salt, sodium alkylbenzenesulfonate, polyoxyalkylene alkyl ether phosphoric acid ester, polyoxyethylene aryl ether sulfuric acid ester salt, dialkyl succinate sulfonic acid sodium salt, polyoxyethylene castor oil ether sulfuric acid ester salt, and monoalkyl succinate sulfonic acid disodium salt are more preferred.

The amount of the anionic surfactant added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the ink composition using the dispersion can be achieved by the heat treatment described below. When not contained, the effect does not appear even when the heat treatment is conducted. When the surfactant is added in an amount more than 10 mass %, the interaction between the water-insoluble polymer and the pigment is obstructed, dispersibility is inhibited, and dispersion stability is not achieved.

(F) Resin Solvent

The pigment dispersion of the present invention preferably contains, in addition to the pigment and the water-insoluble polymer described above, a resin solvent as one of the wetting agents. Since this resin solvent has excellent compatibility with both the pigment and the water-insoluble polymer, the effect of causing the water-insoluble polymer to strongly adhere to the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred.

Specific examples of the resin solvent preferred in the present invention include alcohols such as 1-butanol, isobutyl alcohol, tert-butyl alcohol, 2-pentanol, 3-pentanol, tert-pentyl alcohol, 3-methyl-2-butanol, neopentyl alcohol, allyl alcohol, propargyl alcohol, benzyl alcohol, cyclohexanol, 2-methylcyclohexanol, 1,3-butanediol, 2,3-butanediol, 2-methyl-2,4-pentanediol, 2-ethyl-1,3-hexanediol, 2-ethyl-2-(hydroxymethyl)-1,3-propanediol, 1,2,6-hexanetriol, furfuryl alcohol, tetrahydrofurfuryl alcohol, diacetone alcohol, 2-methyl-1-butanol, 3-methyl-1-butanol, 1-hexanol, 2-methyl-1-pentanol, 4-methyl-2-pentanol, 2-ethyl-1-butanol, 1-heptanol, 2-heptanol, 3-heptanol, 1-octanol, 2-octanol, 2-ethyl-1-hexanol, 1-nonanol, 3,5,5-trimethyl-1-hexanol, 1-decanol, and 2-(benzyloxy)ethanol; ethers such as dioxane, trioxane, tetrahydrofuran, tetrahydropyran, 1,2-dimethoxyethane, 1,2-diethoxyethane, diethylene glycol dimethyl ether, diethylene glycol diethyl ether, diethylene glycol dibutyl ether, methylal, acetal, dibutyl ether, dihexyl ether, propylene oxide, furan, and 2-methylfuran; ketones such as acetone, methyl ethyl ketone, 2-pentanone, 3-pentanone, acetonitrile acetone, cyclohexanone, 2-hexanone, 2-methyl-4-pentanone, 2-heptanone, 4-heptanone, 2,6-dimethyl-4-heptanone, mesityl oxide, phorone, and isophorone; esters such as methyl formate, ethyl formate, methyl acetate, ethyl acetate, 3-methoxybutyl acetate, methyl propionate, γ-butyrolactone, diethyl oxalate, dimethyl maleate, monoacetin, diacetin, triacetin, ethylene carbonate, propylene carbonate, triethyl phosphate, acetonitrile, methyl lactate, ethyl lactate, butyl lactate, 2-methoxyethyl acetate, 2-ethoxyethyl acetate, diethylene glycol monoethyl ether acetate, diethylene glycol monobutyl ether acetate, methyl acetoacetate, ethyl acetoacetate, hexamethylphosphoric acid triamide, n-propyl formate, n-butyl formate, isobutyl formate, n-amyl formate, n-propyl acetate, n-butyl acetate, isobutyl acetate, sec-butyl acetate, n-amyl acetate, isopentyl acetate, sec-hexyl acetate, 2-ethyl butyl acetate, 2-ethyl hexyl acetate, cyclohexyl acetate, benzyl acetate, ethyl propionate, butyl propionate, isopentyl propionate, methyl butyrate, ethyl butyrate, butyl butyrate, isopentyl butyrate, isobutyl isobutyrate, ethyl isovalerate, isopentyl isovalerate, butyl stearate, pentyl stearate, methyl benzoate, ethyl benzoate, propyl benzoate, butyl benzoate, isopentyl benzoate, benzyl benzoate, ethyl abietate, benzyl abietate, bis(2-ethylhexyl) adipate, dibutyl tartrate, tributyl citrate, dibutyl sebacate, bis(2-ethylhexyl) sebacate, dimethyl phthalate, diethyl phthalate, dibutyl phthalate, bis(2-ethylhexyl) phthalate, dioctyl phthalate, diethyl carbonate, and 2-butoxyethyl acetate; nitrogen-containing compounds such as pyridine, α-picoline, β-picoline, γ-picoline, ethylenediamine, propylenediamine, tetraethylenepentamine, formamide, N-methylformamide, N,N-dimethylformamide, N,N-diethylformamide, acetamide, N-methylacetamide, N,N-dimethylacetamide, N,N,N′,N′-tetramethyl urea, ε-caprolactam, morpholine, N-methylmorpholine, 1-nitropropane, and 2-nitropropane; and sulfur-containing compounds such as sulfolane, dimethyl sulfide, diethyl sulfide, and thiophene. Among these, ethyl acetate, propylene oxide, sulfolane, 1-nitropropane, acetonylacetone, N,N-dimethylformamide, 2-ethylhexyl acetate, thiophene, and 2-heptanol are more preferred.

The amount of the resin solvent added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the ink composition using the pigment dispersion can be achieved by the heat treatment described below. When not contained, the effect does not appear even when the heat treatment is conducted. When the surfactant is added in an amount more than 10 mass %, the interaction between the water-insoluble polymer and the pigment is obstructed, dispersibility is inhibited, and dispersion stability is not achieved.

(G) Glycerol Ether Compound

The pigment dispersion of the present invention preferably contains, in addition to the pigment and the water-insoluble polymer described above, a glycerol ether compound represented by the formula below as one of the wetting agents.

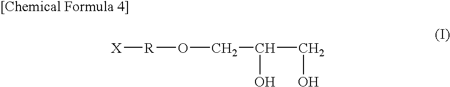

(In the formula, R represents a linear, branched, or cyclic alkyl group having 1 to 20 carbon atoms and optionally containing a double bond, a triple bond, or a substituent, or a substituted or unsubstituted aryl group. X represents a hydrogen atom, a hydroxyl group, or a linear or branched alkoxy group having 1 to 5 carbon atoms.)

Since this glycerol ether compound has excellent compatibility with both the pigment and the water-insoluble polymer, the effect of causing the water-insoluble polymer to strongly adhere to the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred.

Any compound having the structure represented by the above-described formula may be used as the glycerol ether compound preferred in the present invention. In particular, the glycerol ether compound is preferably one selected from the group consisting of 3-methoxy-1,2-propanediol, 3-ethoxy-1,2-propanediol, 3-allyloxy-1,2-propanediol, 3-(octadecyloxy)-1,2-propanediol, monoolein, 1,2-dihydroxy-3-(2-methoxyphenoxy)propane, and 3-phenoxy-1,2-propanediol. The compound selected from this group has the above-described properties superior to those of other glycerol ether compounds and is thus suitable for use in the pigment dispersion and water-based ink composition of the present invention.

The amount of the glycerol ether compound added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the ink composition using the pigment dispersion can be achieved by the heat treatment described below. When not contained, the effect does not appear even when the heat treatment is conducted. When the compound added in an amount more than 10 mass %, the interaction between the water-insoluble polymer and the pigment is obstructed, dispersibility is inhibited, and dispersion stability is not achieved.

(H) Amide Compound

The pigment dispersion of the present invention preferably contains, in addition to the pigment and the water-insoluble polymer described above, an amide compound as one of the wetting agents. Since the amide compound is a linear or cyclic compound and has excellent compatibility with both the pigment and the water-insoluble polymer, the effect of causing the water-insoluble polymer to strongly adhere to the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred.

Examples of the linear or cyclic amide compound include lactamide, methyl carbamate, ethyl carbamate, propyl carbamate, formamide, N-methylformamide, N,N-diethylformamide, N,N-dimethylformamide, acetamide, N-methylacetamide, N,N-dimethylacetamide, propionamide, N-methylpropionamide, nicotinamide, 6-aminonicotinamide, N,N-diethylnicotinamide, N-ethylnicotinamide, N-methyl-2-pyrrolidone, 5-methyl-2-pyrrolidone, 5-hydroxymethyl-2-pyrrolidone, δ-valerolactam, ε-caprolactam, heptanolactam, pyroglutamic acid, N-methyl-ε-caprolactam, and β-propiolactam. Among these, lactamide, methyl carbamate, ethyl carbamate, propionamide, nicotinamide, 5-methyl-2-pyrrolidone, 5-hydroxymethyl-2-pyrrolidone, δ-valerolactam, and pyroglutamic acid are more preferred. The amount of the amide compound added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the ink composition using the pigment dispersion can be achieved by the heat treatment described below. When not contained, the effect does not appear even when the heat treatment is conducted. When the amide compound is added in an amount more than 10 mass %, the interaction between the water-insoluble polymer and the pigment is obstructed, dispersibility is inhibited, and dispersion stability is not achieved.

(I) Imidazole Derivative

The pigment dispersion of the present invention preferably contains, in addition to the pigment and the water-insoluble polymer described above, an imidazole derivative as one of the wetting agents. The imidazole derivative is a water-soluble compound having a hydroxyl group, a carboxyl group, an alkyl group or the like bonded to an imidazole ring. Since the imidazole derivative has excellent compatibility with both the pigment and the water-insoluble polymer, the effect of causing the water-insoluble polymer to strongly adhere onto the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred.

Specific examples of the imidazole derivative include imidazole, N-methylimidazole, 2-methylimidazole, 2-hydroxyimidazole, 4-hydroxyimidazole, 5-hydroxyimidazole, pyrimidazole, 2-ethylimidazole, 2-ethyl-4-methylimidazole, histamine, histidine, imidazoleacetic acid, 4-methylimidazole, 4-imidazoleacrylic acid, 4,5-imidazoledicarboxylic acid, and pilocarpine. Among these, imidazole, N-methylimidazole, 2-methylimidazole, 2-hydroxyimidazole, 4-hydroxyimidazole, 2-ethylimidazole, histamine, imidazoleacetic acid, and 4-methylimidazole are more preferred. The amount of the imidazole derivative added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the ink composition using the pigment dispersion can be achieved by the heat treatment described below. When not contained, the effect does not appear even when the heat treatment is conducted. When the imidazole derivative is added in an amount more than 10 mass %, the interaction between the water-insoluble polymer and the pigment is obstructed, dispersibility is inhibited, and dispersion stability is not achieved.

(J) Azine Compound

The pigment dispersion of the present invention preferably contains, in addition to the pigment and the water-insoluble polymer described above, an azine compound as one of the wetting agents. The azine compound is a generic name for six-membered ring compounds containing two or more nitrogen atoms, oxygen atoms, or sulfur atoms, at least one of which is a nitrogen atom. The azine compound has excellent compatibility with both the pigment and the water-insoluble polymer, and thus the effect of causing the water-insoluble polymer to strongly adhere to the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred.

Specific examples of the azine compound include pyrazine, pyrazinamide, hexahydropyrazine, 3-ethyl-2,6-dimethylpyrazine, pyrazine-2,3-dicarboxylic acid, pyrazine carbonitrile, 2,3-pyrazine dicarbonitrile, 2,3-pyrazine carboxyamide, 2,3-pyrazine dicarboxylic anhydride, pyrazine ethanethiol, triazine, cyanuric acid, methyl cyanurate, melamine, trithiocyanuric acid, pyridazine, 4-pyridazine carboxylic acid, cytosine, and cytosine-5-carboxylic acid. Among these, pyrazine, hexahydropyrazine, pyrazine-2,3-dicarboxylic acid, pyridazine, 4-pyridazine carboxylic acid, cytosine, cytosine-5-carboxylic acid, triazine, and cyanuric acid are more preferred.

The amount of the azine compound added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the ink composition using the pigment dispersion can be achieved by the heat treatment described below. When not contained, the effect does not appear even when the heat treatment is conducted. When the azine compound is added in an amount more than 10 mass %, the interaction between the water-insoluble polymer and the pigment is obstructed, dispersibility is inhibited, and dispersion stability is not achieved.

(K) Azole Compound

The pigment dispersion of the present invention preferably contains, in addition to the pigment and the water-insoluble polymer described above, an azole compound as one of the wetting agents. The azole compound is a generic name for five-membered heterocyclic compounds containing two or more nitrogen atoms, oxygen atoms, or sulfur atoms, at least one of which is a nitrogen atom. The azole compound has excellent compatibility with both the pigment and the water-insoluble polymer, and thus the effect of causing the water-insoluble polymer to strongly adhere to the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred.

Specific examples of the azole compound include 1,2,3-triazole, 1,2,4-triazole, 1,2,3-triazole-4,5-dicarboxylic acid, 1H-1,2,4-triazole-3-thiol, benzotriazole, benzotriazole-5-carboxylic acid, 1H-benzotriazole-1-methanol, pyrazole, tetrazole, oxazole, N1-(4,5-dimethyl-2-oxazolyl)sulfanilamide, thiazole, 2-aminothiazole, 2-thiazole carboxyaldehyde, 5-thiazole methanol, 1,2,3-thiadiazole, benzoimidazole, benzoimidazole-2-carbamic acid, (2-benzoimidazolyl)acetonitrile, 5-benzoimidazole carboxylic acid, 2-benzoimidazole ethanol, 2-benzoimidazole propionic acid, and 2-mercaptobenzoimidazole. Among these, 1,2,3-triazole, 1,2,4-triazole, 1H-benzotriazole-1-methanol, pyrazole, tetrazole, thiazole, 1,2,3-thiadiazole, oxazole, and 2-aminothiazole are more preferable.

The amount of the azole compound added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the ink composition using the pigment dispersion can be achieved by the heat treatment described below. When not contained, the effect does not appear even when the heat treatment is conducted. When the azole compound is added in an amount more than 10 mass %, the interaction between the water-insoluble polymer and the pigment is obstructed, dispersibility is inhibited, and dispersion stability is not achieved.

(L) Amidine Derivative

The pigment dispersion of the present invention preferably contains, in addition to the pigment and the water-insoluble polymer described above, an amidine derivative as one of the wetting agents. The amidine derivative is a generic name for compounds having the ═O moiety of the carbonyl group of carboxylic acid substituted with ═NH and the —OH moiety substituted with —NH₂. Since the amidine derivative has excellent compatibility with both the pigment and the water-insoluble polymer, the effect of causing the water-insoluble polymer to strongly adhere to the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred.

Specific examples of the amidine derivative include guanidine, 1-methyl-3-nitro-1-nitrosoguanidine, 1-amyl-3-nitro-1-nitrosoguanidine, nitroguanidine, sulfaguanidine, guanidinoacetic acid, guanetidine, aminoguanidine, canavanine, argininosuccinic acid, arginine, and biguanide. Among these, guanidine, 1-methyl-3-nitro-1-nitrosoguanidine, 1-amyl-3-nitro-1-nitrosoguanidine, nitroguanidine, sulfaguanidine, guanidinoacetic acid, aminoguanidine, canavanine, and arginine are more preferred.

The amount of the amidine derivative added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the ink composition using the pigment dispersion can be achieved by the heat treatment described below. When not contained, the effect does not appear even when the heat treatment is conducted. When the amidine derivative is added in an amount more than 10 mass %, the interaction between the water-insoluble polymer and the pigment is obstructed, dispersibility is inhibited, and dispersion stability is not achieved.

(M) Hydroxypyridine Derivative

The pigment dispersion of the present invention preferably contains, in addition to the pigment and the water-insoluble polymer described above, a hydroxypyridine derivative as one of the wetting agents. The hydroxypyridine derivative is a water-soluble compound having a hydroxyl group bonded to a pyridine ring either directly or through a methylene chain. Since the hydroxypyridine derivative has excellent compatibility with both the pigment and the water-insoluble polymer, the effect of causing the water-insoluble polymer to strongly adhere to the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred.

Specific examples of the hydroxypyridine derivatives include 2-pyridinol, 3-pyridinol, 4-pyridinol, 3-methyl-2-pyridinol, 4-methyl-2-pyridinol, 6-methyl-2-pyridinol, 2-pyridinemethanol, 3-pyridinemethanol, 4-pyridinemethanol, 2-pyridineethanol, 3-pyridineethanol, 4-pyridineethanol, 2-pyridinepropanol, 3-pyridinepropanol, 4-pyridinepropanol, α-methyl-2-pyridinemethanol, and 2,3-pyridinediol. Among these, 2-pyridinol, 3-methyl-2-pyridinol, 6-methyl-2-pyridinol, 2-pyridinemethanol, 2-pyridineethanol, 4-pyridineethanol, 3-pyridinepropanol, α-methyl-2-pyridinemethanol, and 2,3-pyridinediol are more preferred.

The amount of the hydroxypyridine derivative added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the ink composition using the pigment dispersion can be achieved by the heat treatment described below. When not contained, the effect does not appear even when the heat treatment is conducted. When the hydroxypyridine derivative is added in an amount more than 10 mass %, the interaction between the water-insoluble polymer and the pigment is obstructed, dispersibility is inhibited, and dispersion stability is not achieved.

(N) Purine Derivative

The pigment dispersion of the present invention preferably contains, in addition to the pigment and the water-insoluble polymer described above, a purine derivative as one of the wetting agents. The purine derivative is a generic name for compounds having a dicyclic heterocyclic skeleton consisting of a pyrimidine ring fused to an imidazole ring. Since the purine derivative has excellent compatibility with both the pigment and the water-insoluble polymer, the effect of causing the water-insoluble polymer to strongly adhere to the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred. Specific examples of the purine derivative include purine, purine riboside, 2-amino-6-mercaptopurine, 6-(methylthio)purine riboside, 6-benzylaminopurine, xanthosine, guanine, 2′-deoxyguanosine, guanosine, O-methylguanine, methylguanine, caffeine, xanthine, theophylline, theobromine, adenine, adenosine, 2′-deoxyadenosine, N-benzyl-9-(2-tetrahydropyranyl)adenine, and adenosine triphosphoric acid. Among these, purine, 2-amino-6-mercaptopurine, guanine, 2′-deoxyguanosine, methylguanine, xanthine, theophylline, theobromine, and adenosine are more preferred.

The amount of the purine derivative added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the ink composition using the pigment dispersion can be achieved by the heat treatment described below. When not contained, the effect does not appear even when the heat treatment is conducted. When the purine derivative is added in an amount more than 10 mass %, the interaction between the water-insoluble polymer and the pigment is obstructed, dispersibility is inhibited, and dispersion stability is not achieved.

(O) Hydroxy Cyclic Amine Compound

The pigment dispersion of the present invention preferably contains, in addition to the pigment and the water-insoluble polymer described above, a hydroxy cyclic amine compound as one of the wetting agents. The hydroxy cyclic amine compound is a water-soluble compound having a hydroxyl group bonded to a cyclic amine either directly or through a methylene chain. Since the hydroxy cyclic amine compound has excellent compatibility with both the pigment and the water-insoluble polymer, the effect of causing the water-insoluble polymer to strongly adhere to the pigment is high. Moreover, by the heat treatment described below, the water-insoluble polymer can adsorb onto the pigment more strongly and the dispersion stability can be improved. When the water-based ink composition containing this is applied to the ink jet recording method, ejection stability is improved, which is preferred.

Specific examples of the hydroxy cyclic amine compound include 4-hydroxypiperidine, 3-hydroxypiperidine, 2-hydroxypiperidine, N-methyl-3-hydroxypiperidine, N-ethyl-3-hydroxypiperidine, N-methyl-3-hydroxymethylpiperidine, N-methyl-2-hydroxymethylpiperidine, N-(2-hydroxyethyl)piperidine, 2-(2-hydroxyethyl)piperidine, 4-(2-hydroxyethyl)piperidine, N-(2-hydroxyethyl)piperazine, N-(2-hydroxyethyl)morpholine, N-(2-hydroxypropyl)morpholine, N-(2-hydroxyethyl)pyrrole, pyrrolinol, N-(2-hydroxyethyl)pyrrolidine, N-methyl-2-(2-hydroxyethyl)pyrrolidine, N-(2-hydroxyethyl)ethylene imine, 3-oxypyrazole, and 5-oxypyrazole. These compounds may be used alone or in combination. Among these, 4-hydroxypiperidine, N-methyl-3-hydroxypiperidine, N-methyl-3-hydroxymethylpiperidine, N-(2-hydroxyethyl)piperidine, N-(2-hydroxyethyl)morpholine, N-(2-hydroxyethyl)pyrrole, pyrrolinol, N-(2-hydroxyethyl)ethylene imine, and 3-oxypyrazole are more preferred.

The amount of the hydroxy cyclic amine compound added to the pigment dispersion is preferably in the range of 0.1 to 10 mass % and more preferably in the range of 0.2 to 5 mass % relative to the total amount of the dispersion used in the heat treatment described below. When the content is within the above-described range, the effect of improving the ejection stability of the ink composition using the pigment dispersion can be achieved by the heat treatment described below. When not contained, the effect does not appear even when the heat treatment is conducted. When the hydroxy cyclic amine compound is added in an amount more than 10 mass %, the interaction between the water-insoluble polymer and the pigment is obstructed, dispersibility is inhibited, and dispersion stability is not achieved.

(Water)

Water is the medium which is the main component of the pigment dispersion and the water-based ink composition using the pigment dispersion according to the present invention. Pure water or ultrapure water such as ion exchange water, ultrafiltrated water, reverse osmosis water, distilled water, or the like can be used as preferable water to reduce ionic impurities as much as possible. It is preferable to use water sterilized by UV irradiation, addition of hydrogen peroxide, or the like since occurrence of fungi and bacteria can be prevented during long-term storage of the pigment dispersion and the water-based ink composition using the pigment dispersion.

(Heat Treatment of Dispersion)

In order to prepare a pigment dispersion of the present invention by using the pigment, water-insoluble polymer, wetting agent, and water described above, heat treatment is ultimately necessary. Heat treatment significantly improves the ejection stability of the water-based ink composition using the dispersion. Moreover, there are also effects of improving the dispersion stability and storage stability of the pigment dispersion and dispersion stability and storage stability of the water-based ink composition using the pigment dispersion.

Heat treatment may be conducted after adding a predetermined amount of the wetting agent to a dispersion containing the dispersoid constituted by the pigment coated with the water-insoluble polymer prepared in advance. Alternatively, heat treatment may be conducted after adding a predetermined amount of the wetting agent during the process of coating the pigment with the water-insoluble polymer. From the standpoints of equipment used, process, and ease of handling, it is preferable to conduct heat treatment after a predetermined amount of the wetting agent is added to a preliminarily prepared dispersion stock solution containing the pigment dispersoid.

The heating temperature during the heat treatment of the present invention is preferably in the range of 65° C. to 100° C. and more preferably in the range of 70° C. to 90° C. The heat treatment time is preferably in the range of 30 minutes to 100 hours and more preferably in the range of 1 hour to 50 hours. When the heating temperature and the heat treatment time are within the above-described ranges, the dispersion as a whole can be effectively and efficiently heat-treated. When the heating temperature is lower than 65° C. and the heat treatment time is shorter than 30 minutes, the heat treatment may not be effectively conducted. In contrast, when the heating temperature is higher than 100° C. or the heat treatment time is longer than 100 hours, the interaction between the pigment and the water-insoluble polymer in the dispersion is destructed, resulting in inhibition of coating, and dispersion may become stable.

As for the techniques of heat treatment of the present invention, various techniques can be employed such as a technique in which a dispersion containing a wetting agent is sealed inside a container or the like and heated together with the container or the like, a technique in which a dispersion containing a wetting agent is charged in a container or the like equipped with a stirrer and a reflux condenser and heated under stirring, a technique in which a dispersion containing a wetting agent is allowed to flow in a hollow fine tube of glass, metal, or the like while heating the fine tube, etc.

The pigment dispersion can be prepared from the materials and by the methods described above. The water-based ink composition using the pigment dispersion obtained as such has excellent ejection stability. Although the exact reasons for this are not clear, the following can be presumed.

According to the ink jet recording method, droplets are formed by thrusting ink out from micro nozzle apertures by compression or foaming pressure caused by heating, and are allowed to fly (ejected). In order to eject the ink droplets, it is necessary that the ink droplets depart from the head nozzle face and the ink matrix by forming clean droplets. In particular, during high-speed printing where the cycle of thrusting-formation of droplets-making droplets fly is performed at a higher speed (in other words, at a higher driving frequency), it is particularly important to improve this property (ejection stability). Examples of the properties that largely affect the ejection stability include dispersion stability and storage stability of pigment ink and the surface and interfacial tension (in particular, the interfacial tension between the pigment ink and the head nozzle face). It is important that these properties be within adequate ranges. As described above, it is common practice for a pigment ink to contain a pigment insoluble or hardly soluble in water and a dispersant for making the pigment dispersible in water. In order to stably disperse in water the pigment originally poorly compatible with water, it is necessary that the dispersant strongly adhere on the pigment particle surfaces to avoid easy separation and that cohesion or the like resulting from interaction between the dispersoids be prevented. A prior art, i.e., Japanese Unexamined Patent Application Publication No. 2000-345093, suggests that heat treatment is effective as one of such methods. However, when the inventor of the present invention studied the material and the methods described in this prior art, although some effects were observed with respect to the dispersion stability and the storage stability, ejection stability was sometimes insufficient. The inventor found that this was attributable to the method of preparing a pigment dispersion using the dispersant (alkali-soluble-type resin dispersant) used in the prior art. In Japanese Unexamined Patent Application Publication No. 2000-345093, a pigment dispersion at least containing a pigment and an alkali-soluble-type resin dispersant with an acid value of 90 or less is used. The document also describes a method for preparing the dispersion in which a pigment is formed into fine particle in water under the presence of a surfactant, an aqueous solution of a resin dispersant made water-soluble by complete neutralization using neutralizer (alkaline agent) is added thereto, followed by mixing under stirring, and then heat treatment is conducted. Based on thorough investigations on the preparation method, the inventor of the present invention has found that the resin dispersant remaining dissolved in the dispersion without adhering onto the pigment particles is present to no small extent. In such a case, the ink composition using the dispersion also contains the resin dispersant that remains dissolved. The inventor has found that, as a result of this, the resin dispersant dissolved in the ink adsorbs onto a member in the ink channel inside a printer, in particular, a head nozzle face, and decreases the interfacial tension between the ink and the head nozzle face, inhibiting ink droplets from making clean separation. The pigment dispersion that does not suffer from such a phenomenon has been extensively studied and it has been found that a water-insoluble polymer should be used as the dispersant for the pigment as in the present invention and that heat-treating the dispersant together with a particular amount of the wetting agent described above dramatically improves the ejection stability enhancing effect. Thus, the present invention has been made.

In the present invention, the reason why heat-treating the dispersion containing a pigment, a water-insoluble polymer that coats the pigment to make the pigment dispersible in water, and a wetting agent significantly improves the ejection stability of a water-based ink composition using the dispersion is not yet clear. Presumably, the wetting agent preferred in the present invention has a molecular structure that hits a proper balance between hydrophobic moieties and hydrophilic moieties and thus has high compatibility with both the pigment surface and the water-insoluble polymer. As a result, presumably, once heat-treated, the wetting agent enters gaps between the pigment and the water-insoluble polymer to bridge the two, improves the adsorption property of the water-insoluble polymer to the pigment surfaces to thereby improve the dispersion stability, and thus contributes to improving the ejection stability. The wetting agent preferred in the present invention has an excellent property of adjusting the surface and interfacial tension of the ink composition used in the ink jet recording methods to adequate ranges and readily adsorbs onto the surfaces of the dispersoid (water-insoluble polymer surfaces). Presumably, this action is significantly enhanced by the heat treatment, resulting in a decrease in the interaction between the dispersoids and suppressing cohesion. Presumably, this has resulted in improved flowability and ejection stability of the ink composition.

(Other Additives Etc.)

As for the constituent materials of the pigment dispersion of the present invention, a water-soluble organic solvent is preferably contained in addition to the pigment, the water-insoluble polymer, the wetting agent, and water described above. The water-soluble organic solvent is selected from those having capacity to adjust the surface tension, interfacial tension, viscosity, etc., of the pigment dispersion to appropriate ranges. The water-soluble organic solvent may be contained together with the wetting agent in the dispersion used in the heat treatment or may be added after the heat treatment. Preferably, the water-soluble organic solvent is contained together with the wetting agent in the dispersion used in the heat treatment. In a preferred embodiment, the water-soluble organic solvent is preferably selected from those having a property to enhance the interaction between the pigment and the water-insoluble polymer during the heat treatment to make the water-insoluble polymer adhere onto and cover the pigment particle surfaces more strongly in addition to the above-described properties required for the water-soluble organic solvent.

Examples of the water-soluble organic solvent having such an effect include a monohydric alcohol, a polyhydric alcohol, a sugar, a glycol ether, and a 1,2-alkyldiol. At least one selected from such a group is preferred as the water-soluble organic solvent.

Examples of the monohydric alcohol include water-soluble monohydric alcohols such as methanol, ethanol, n-propyl alcohol, iso-propyl alcohol, 2,2-dimethyl-1-propanol, n-butanol, 2-butanol, tert-butanol, iso-butanol, 2-methyl-1-butanol, 3-methyl-1-butanol, 3-methyl-2-butanol, n-pentanol, 2-pentanol, 3-pentanol, and tert-pentanol. The amount of the monohydric alcohol added is preferably in the range of 10 mass % or less relative to the total amount of the pigment dispersion.

Examples of the polyhydric alcohol include glycerol, ethylene glycol, diethylene glycol, triethylene glycol, tetraethylene glycol, polyethylene glycol, propylene glycol, dipropylene glycol, polypropylene glycol, 1,3-propanediol, 1,4-butanediol, 1,5-pentanediol, 2,3-butanediol, 2-methyl-2,4-pentanediol, 2-ethyl-1,3-hexanediol, 1,2,6-hexanetriol, pentaerythritol, 1,6-hexanediol, 1,8-octanediol, 2,2-dimethyl-1,3-propanediol, 2,2-diethyl-1,3-propanediol, trimethylolethane, and trimethylolpropane. The amount of the polyhydric alcohol added is preferably in the range of 20 mass % or less relative to the total amount of the pigment dispersion.

Examples of the sugar include monosaccharides, disaccharides, oligosaccharides, and polysaccharides such as glucose, mannose, fructose, ribose, xylose, arabinose, galactose, aldonic acid, glucitol (sorbitol), maltose, cellobiose, lactose, sucrose, trehalose, and maltotriose, and derivatives of these sugars such as reducing sugars, oxidizing sugars, amino acids, and thiosugars of these sugars. In particular, sugar alcohols, e.g., maltitol, sorbitol, and the like, are preferred. The amount of the sugar added is preferably in the range of 20 mass % or less relative to the total amount of the pigment dispersion.

Examples of the glycol ether include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-tert-butyl ether, diethylene glycol mono-n-butyl ether, triethylene glycol mono-n-butyl ether, diethylene glycol mono-tert-butyl ether, 1-methyl-1-methoxybutanol, propylene glycol mono-tert-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether. The amount of the glycol ether added is preferably in the range of 15 mass % or less relative to the amount of the pigment dispersion.

Preferable examples of the 1,2-alkyldiol include 1,2-alkyldiols having 4 to 8 carbon atoms such as butanediol, pentanediol, hexanediol, heptanediol, and octanediol. Among these, 1,2-alkyldiols having 6 to 8 carbon atoms such as 1,2-hexanediol, 1,2-heptanediol, and 1,2-octanediol are more preferred. The amount of the 1,2-alkyldiol added is preferably in the range of 5 mass % or less relative to the total amount of the pigment dispersion.

Examples of the optional additives other than the water-soluble organic solvent include an antioxidant/UV absorber, an antimicrobial/preservative agent, an anticorrosive, a chelating agent, and the like. Examples of the antioxidant/UV absorber used include allophanates such as allophanate and methyl allophanate, biurets such as biuret, dimethyl biuret, and tetramethyl biuret, L-ascorbic acid and its salts or the like, Tinuvin 328, 900, 1130, 384, 292, 123, 144, 622, 770, and 292, Irgacor 252 and 153, Irganox 1010, 1076, 1035, and MD1024 produced by Nihon Ciba-Geigy K.K., and lanthanide oxides. The antimicrobial/preservative agent may be selected from sodium benzoate, sodium pentachlorophenol, sodium 2-pyridinethiol-1-oxide, sodium sorbate, sodium dehydroacetate, 1,2-dibenzisothiazolin-3-one, and the like. Commercial products such as Proxel XL2 and Proxel GXL (trade names, products of AVECIA Co.) and Denicide CSA and NS-500W (trade names, products of Nagase ChemteX Corporation) may also be used. The amount of these antioxidant/UV absorber, antimicrobial/preservative agent, anticorrosive, and chelating agent is preferably in the range of 1 mass % or less relative to the total amount of the pigment dispersion. The antioxidant/UV absorber, antimicrobial/preservative agent, anticorrosive, chelating agent, and the like may be contained in the dispersion used in the heat treatment together with the wetting agent or may be added to the dispersion after the heat treatment.

[Water-Based Ink Composition]

The water-based ink composition of the present invention contains the pigment dispersion prepared from and by the materials and the method described above. Accordingly, the ink has good flight stability, i.e., ejection stability, even when continuously ejected at a high driving frequency, and is thus suitable for high-resolution, high-speed ink jet recording methods. However, in order to further improve these properties and the drying properties of the ink composition, prevent clogging of the head nozzles, etc., the ink composition preferably further contains various additives.

(Penetrant)

The water-based ink composition of the present invention preferably further contains a penetrant. The penetrant is an additive for increasing the penetrability of the ink into a recording medium and is properly selected according to the desired ink drying time.

Examples of the penetrant having an effect of adjusting the surface tension of the water-based ink composition to an adequate range include glycol ethers, 1,2-alkyldiols, and monoalcohols described above as the water-soluble organic solvents usable in the pigment dispersion of the present invention. The penetrant is preferably selected from these. The amount of the penetrant added is preferably in the range of 15 mass % or less relative to the total amount of the water-based ink composition.

(Humectant)

The water-based ink composition of the present invention preferably further contains a humectant. The humectant is added to suppress drying of the water-based ink composition and has an effect of preventing aggregation and solidification of the water-based ink composition by suppressing the loss of moisture caused by drying of the printer head nozzle tips.

The humectant is selected from water-soluble materials having a high hygroscopicity. Preferable examples of the humectant include polyhydric alcohols and sugars described above as the water-soluble organic solvents usable in the pigment dispersion of the present invention. In addition, lactams such as 2-pyrrolidone and ureas such as 1,3-dimethylimidazolidinones and the like may also be used. In order to enhance the performance of the materials described above, a water-soluble solid humectant may be used together and added. Specifically, urea derivatives such as urea, thiourea, ethylene urea, and the like can be used. The amount of one or a combination of humectants added is preferably 40 mass % or less relative to the total amount of the water-based ink composition. These humectants may be added in an amount at which the ink viscosity is 25 cPs or less at 25° C. when combined with other ink additives.

### (Polymer Emulsion)

The ink composition of the present invention may further contain a polymer emulsion. The polymer emulsion is added to improve the fixing property and dispersion stability and to give glossiness. The polymer emulsion of the present invention is not particularly limited but is preferably a water dispersion in which the dispersoid is the above-described water-insoluble polymer or a water-insoluble polymer having a structural component similar to that of the above-described water-insoluble polymer. When such a polymer emulsion is further contained, the glossiness-improving effect and the bronze-improving effect on the recorded images become more notable.

The larger the amount of the water-insoluble polymer contained in the pigment dispersion, the greater the glossiness improving effects and bronze-improving effects on the recorded images. However, if the water-insoluble polymer is to be introduced solely as a coating material for the pigment, the dispersion stability tends to deteriorate when the ratio of the pigment to the water-insoluble polymer coating the pigment is out of the range of pigment:water-insoluble polymer=10:2 to 10:10 on a mass basis. Thus, the water-insoluble polymer content in the pigment dispersion can be increased by adding a polymer emulsion as a water-insoluble polymer separately from the water-insoluble polymer coating the pigment. Thus, notable glossiness and bronze improving effects on the recorded images can be achieved while retaining the dispersion stability.

The polymer emulsion can be obtained by dissolving a water-insoluble polymer in an organic solvent to prepare a solution, adding a neutralizer and water to the solution to conduct dispersion treatment and to thereby prepare an oil-in-water-type dispersion, and removing the organic solvent from the resulting dispersion. The neutralizer used here is preferably an organic amine, e.g., a volatile amine compound such as ethylamine, trimethylamine, triethylamine, tributylamine, dimethylethanolamine, diisopropanolamine, or morpholine, a low-volatility high-boiling-point amine such as diethanolamine, triethanolamine, or tripropanolamine, an alkali metal hydroxide such as lithium hydroxide, potassium hydroxide, or sodium hydroxide, ammonia, or the like. The pH of the resulting polymer emulsion is preferably in the range of 6 to 10 at 25° C. The average particle diameter of the water-insoluble polymer dispersoid in the polymer emulsion is preferably in the range of 20 nm to 200 nm in terms of volume-average particle diameter from the viewpoints of achieving dispersion stability and the glossiness and bronze improving effects on the recorded images.

(Other Additives and the Like)

In addition to those described above, the antioxidant/UV absorber, antimicrobial/preservative agent, anticorrosive, chelating agent, and the like described above as examples of the additives that can be used in the pigment dispersion of the present invention can be used as the additives added if necessary. Surfactants and the like may also be added. Surfactants are additives for further increasing the ink penetrability into a recording medium, and surfactants described above as examples of the wetting agent used in the pigment dispersion of the present invention are suitable for use.

(Physical Property Values and the Like of Water-Based Ink Composition)

The pH of the water-based ink composition of the present invention is preferably adjusted to neutral or alkaline from the standpoints of achieving storage stability (particle diameter fluctuation, viscosity fluctuation, etc.), dispersion stability, and prevention of corrosion of metal parts occasionally used in channels of the water-based ink composition in the ink jet recording device. More preferably, the pH of the water-based ink composition is in the range of 7.0 to 10.0 at 25° C. If the pH is out of this range, problems related to storage stability, dispersion stability, and corrosion are likely to occur.

The viscosity of the water-based ink composition of the present invention is preferably 25 cPs or less at 25° C. from the standpoint of ensuring the ejection stability in the ink jet recording device. More preferably, the viscosity is 15 cPs or less.

[Ink Jet Recording Method]

The ink jet recording method, of the present invention may be any method by which the water-based ink composition described above is ejected as droplets from fine nozzles and the droplets are made to adhere onto a recording medium. Some of the methods are described below. The first method is an electrostatic attraction technique by which a strong electrical field is applied between a nozzle and an acceleration electrode disposed in front of the nozzle, ink droplets are continuously discharged from the nozzle, and a print information signal is given to a deflection electrodes while the ink droplets fly between the deflection electrodes to conduct recording. Alternatively, the ink droplets may be ejected according to the print information signals without any deflection.

The second method is a technique for forcibly ejecting ink droplets by applying pressure to an ink solution with a small pump and mechanically vibrating a nozzle with a quartz oscillator or the like. The ejected droplets are electrified at the same time as ejection and recording is conducted by giving a print information signal to the deflection electrodes while ink droplets fly between the deflection electrodes.

The third method involves use of a piezoelectric element, by which a pressure and a print information signal are simultaneously applied to an ink solution to eject ink droplets and conduct recording.

The fourth method involves a technique by which the volume of an ink solution is rapidly increased by thermal energy, the technique involving thermally foaming the ink solution by using a microelectrode according to a print information signal to eject ink droplets and conduct recording.

The recorded matter of the present invention is obtained by printing by an ink jet recording method with the water-based ink composition described above.

### EXAMPLES

The present invention will now be described in further details by using examples. However, the present invention is not limited to these examples. In the description below, “part(s)” means “part(s) by mass” unless otherwise noted.

[Preparation of Pigment Dispersion]

(Synthesis of Water-Insoluble Polymer)

A four-necked flask equipped with a stirrer, a reflux condenser, a nitrogen gas feed tube, and a dropping funnel was prepared. Into the four-necked flask, 20 parts of methyl ethyl ketone, i.e., an organic solvent, 0.03 parts of 2-mercaptoethanol, i.e., a polymerization chain transfer agent, and 100 parts of a mixture of monomers shown in Table 1 below were charged. The flask was purged with nitrogen gas, and the liquid temperature was adjusted to 80° C. While stirring the liquid mixture in the four-necked flask, a solution, preliminarily placed in the dropping funnel, prepared by dissolving 0.9 parts of 2,2′-azobis(2,4-dimethylvaleronitrile), i.e., a polymerization initiator, in 40 parts of methyl ethyl ketone was gradually added dropwise. While maintaining the liquid temperature to 80° C., polymerization was conducted for 10 hours under stirring and mixing to obtain solutions of water-insoluble polymer 1 to water-insoluble polymer 4. The resulting water-insoluble polymer solutions were vacuum dried to obtain dry solids of water-insoluble polymer 1 to water-insoluble polymer 4 of this example. The monomer constitutions of water-insoluble polymer 1 to water-insoluble polymer 4 obtained in this example are shown in Table 1. In the table, figures represent mass %.

TABLE 1

| | Water- | Water- | Water- | Water- |
|---|---|---|---|---|
| | insoluble | insoluble | insoluble | insoluble |
| Monomer species used | polymer 1 | polymer 2 | polymer 3 | polymer 4 |
| Methacrylic acid | 20 | 15 | 20 | 20 |
| Styrene | 45 | 30 | 40 | 40 |
| Benzyl methacrylate | — | 20 | — | — |
| Polyethylene glycol | 5 | 10 | — | 15 |
| monomethacrylate | | | | |
| (EO = 15) | | | | |
| Polypropylene glycol | — | 10 | 25 | — |
| monomethacrylate | | | | |
| (PO = 9) | | | | |
| Poly(ethylene | 10 | — | 5 | 15 |
| glycol•propylene glycol) | | | | |
| monomethacrylate | | | | |
| (EO = 5, PO = 7) | | | | |
| Styrene macromonomer | 20 | 15 | 10 | 10 |

### Example 1A

### Pigment Dispersion K1A

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)).

To 98 parts of the dispersion obtained from and by the materials and method described above, 2 parts of Olfine E1010 (trade name, product of Nissin Chemical Industry Co., Ltd.), i.e., an acetylene glycol-based surfactant, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1A (pigment-water-insoluble polymer solid concentration: 19.6 mass %) of this example.

### Example 2A

### Pigment Dispersion Y1A

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 parts of Surfynol 104PG-50 (trade name, product of Nissin Chemical Industry Co., Ltd.), i.e., an acetylene glycol-based surfactant serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain a pigment dispersion Y1A (pigment-water-insoluble polymer solid concentration: 18.0 mass %) of this example.

### Example 3A

### Pigment Dispersion M1A

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of Acetylenol E00 (trade name, product of Kawaken Fine Chemicals Co., Ltd.), i.e., an acetylene glycol-based surfactant serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain a pigment dispersion M1A (pigment-water-insoluble polymer solid concentration: 19.0 mass %) of this example.

### Example 4A

### Pigment Dispersion C1A

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of Surfynol 465 (trade name, product of Air Products and Chemicals. Inc.), i.e., an acetylene glycol-based surfactant serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain a pigment dispersion C1A (pigment-water-insoluble polymer solid concentration: 18.0 mass %) of this example.

### Example 5A

### Pigment Dispersion K2A

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer 10:6.7 (mass ratio)).

To 95 parts of the pigment dispersion obtained from and by the materials and method described above, 5 parts of Surfynol 61 (trade name, product of Nissin Chemical Industry Co., Ltd.), i.e., an acetylene alcohol-based surfactant, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2A (pigment-water-insoluble polymer solid concentration: 19.0 mass %) of this example.

### Example 6A

### Pigment Dispersion Y2A

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer 10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of Olfine B (trade name, product of Nissin Chemical Industry Co., Ltd.), i.e., an acetylene alcohol-based surfactant serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2A (pigment-water-insoluble polymer solid concentration: 17.0 mass %) of this example.

### Example 7A

### Pigment Dispersion M2A

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of Surfynol 420 (trade name, product of Air Products and Chemicals. Inc.), i.e., an acetylene glycol-based surfactant serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain a pigment dispersion M2A (pigment-water-insoluble polymer solid concentration: 19.0 mass %) of this example.

### Example 8A

### Pigment Dispersion C2A

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of Olfine E1010 (trade name, product of Nissin Chemical Industry Co., Ltd.) and 0.2 parts of Surfynol 104PG-50 (trade name, product of Air Products and Chemicals. Inc.), i.e., acetylene glycol-based surfactants serving as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain a pigment dispersion C2 (pigment-water-insoluble polymer solid concentration: 18.0 mass %) of this example.

### Comparative Example 1A

### Pigment Dispersion K3A

Pigment dispersion K3A of this comparative example having a pigment-water-insoluble polymer solid concentration of 19.6 mass % (pigment:water-insoluble polymer=10:5 (mass ratio)) was prepared from and by the same materials and method for pigment dispersion K1A (Example 1A) described above except that the heat treatment was not conducted.

### Comparative Example 2A

### Pigment Dispersion Y3A

Pigment dispersion Y3A of this comparative example having a pigment-water-insoluble polymer solid concentration of 18.4 mass % (pigment:water-insoluble polymer=10:3 (mass ratio)) was prepared from and by the same materials and method for pigment dispersion Y1A (Example 2A) described above except that, during the heat treatment, Surfynol 104PG-50 (trade name, product of Nissin Chemical Industry Co., Ltd.), i.e., an acetylene glycol-based surfactant serving as a wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3A

### Pigment Dispersion M3A

Pigment dispersion M3A of this reference example having a pigment-water-insoluble polymer solid concentration of 19.0 mass % (pigment:water-insoluble polymer=10:2 (mass ratio)) was prepared from and by the same materials and method for pigment dispersion M1A (Example 3A) described above except that, during the heat treatment, the heating temperature was changed to 120° C. and the heating time was changed to 30 minutes.

### Reference Example 4A

### Pigment Dispersion C3A

Pigment dispersion C3A of this reference example having a pigment-water-insoluble polymer solid concentration of 18.0 mass % (pigment:water-insoluble polymer=10:10 (mass ratio)) was prepared from and by the same materials and method for pigment dispersion C1A (Example 4A) described above except that, during the heat treatment, the heating temperature was changed to 60° C. and the heating time was changed to 100 hours.

### Reference Example 5A

### Pigment Dispersion K4A

Pigment dispersion K4A of this reference example having a pigment-water-insoluble polymer solid concentration of 19.6 mass % (pigment:water-insoluble polymer=10:5 (mass ratio)) was prepared from and by the same materials and method for pigment dispersion K1A (Example 1A) described above except that, during the heat treatment, the heating time was changed to 20 minutes.

### Reference Example 6A

### Pigment Dispersion Y4A

Pigment dispersion Y4A of this reference example having a pigment-water-insoluble polymer solid concentration of 18.0 mass % (pigment:water-insoluble polymer=10:3 (mass ratio)) was prepared from and by the same materials and method for pigment dispersion Y1A (Example 2A) described above except that, during the heat treatment, the heating time was changed to 120 hours.

### Comparative Example 7A

### Pigment Dispersion M4A

Pigment dispersion M4A of this comparative example having a pigment-water-insoluble polymer solid concentration of 19.4 mass % (pigment:water-insoluble polymer=10:2 (mass ratio)) was prepared from and by the same materials and method for pigment dispersion M1A (Example 3A) described above except that, during the heat treatment, 0.05 parts of Acetylenol E00 (trade name, product of Kawaken Fine Chemicals Co., Ltd.), i.e., an acetylene glycol-based surfactant serving as a wetting agent, and 4.9 parts of 1,2-hexanediol, i.e., a water-soluble organic solvent, were used.

### Comparative Example 8A

### Pigment Dispersion C4A

Pigment dispersion C4A of this comparative example having a pigment-water-insoluble polymer solid concentration of 16.0 mass % (pigment:water-insoluble polymer=10:10 (mass ratio)) was prepared from and by the same materials and method for pigment dispersion C1A (Example 4A) described above except that, during the heat treatment, 11 parts of Surfynol 465 (trade name, product of Air Products and Chemicals. Inc.), i.e., an acetylene glycol-based surfactant serving as a wetting agent, and 80 parts of the dispersion were used.

### Comparative Example 9A

### Pigment Dispersion K5A

Twenty parts of MA 100 (trade name, product of Mitsubishi Chemical Corporation), i.e., carbon black serving as a pigment, 5 parts of polyoxyethylene acetyl ether (product of Nicco Chemicals Co., Ltd.), i.e., a surfactant, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass %, aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5A of this comparative example having a pigment-water-insoluble polymer solid concentration of 23 mass % (pigment:water-insoluble polymer=10:1.5 (mass ratio)).

[Preparation of Water-Based Ink Composition A]

(Preparation of Polymer Emulsion)

The polymer emulsion (also used in water-based ink compositions B to 0 described below) of the present invention can be prepared by using the water-insoluble polymer obtained as above (synthesis of water-insoluble polymer).

(1) Polymer Emulsion 1

An aqueous sodium hydroxide solution was added to a water-insoluble polymer 1 solution prepared by dissolving 10 parts of dry solid of water-insoluble polymer 1 prepared from and by the materials and method described above (synthesis of water-insoluble polymer) in 50 parts of methyl ethyl ketone to conduct neutralization. To the resulting mixture, 100 parts of ion exchange water was added, followed by stirring and mixing, and the resulting mixture was transferred to an evaporator to remove all methyl ethyl ketone and part of water while heating at 60° C. in a reduced pressure environment to thereby prepare polymer emulsion 1 having a solid concentration of 20 mass %.

(2) Polymer Emulsion 2

Polymer emulsion 2 having a solid concentration of 20 mass % was prepared from and by the materials and method described above for (1) polymer emulsion 1 except that dry solid of water-insoluble polymer 2 prepared from and by the materials and method described above (synthesis of water-insoluble polymer) was used.

(3) Polymer Emulsion 3

Polymer emulsion 3 having a solid concentration of 20 mass % was prepared from and by the materials and method described above for (1) polymer emulsion 1 except that dry solid of water-insoluble polymer 3 prepared from and by the materials and method described above (synthesis of water-insoluble polymer) was used.

(4) Polymer Emulsion 4

Polymer emulsion 4 having a solid concentration of 20 mass % was prepared from and by the materials and method described above for (1) polymer emulsion 1 except that dry solid of water-insoluble polymer 4 prepared from and by the materials and method described above (synthesis of water-insoluble polymer) was used.

Water-based ink compositions of Examples 9A to 24A, comparative Examples 10A, 11A, and 16A to 18A, and Reference Examples 12A to 15A were prepared from the pigment dispersions and polymer emulsions obtained from and by the materials and methods described above according to the compositions shown in Table 2A. Each water-based ink composition was prepared by stirring and mixing materials described in Table 2A in amounts described in the table at room temperature for 2 hours and filtering the resulting mixture with a membrane filter having 5 μm pores. In Table 2A, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2A

| | Examples | | | | | | | |
|---|---|---|---|---|---|---|---|---|
| Ink composition | 9A | 10A | 11A | 12A | 13A | 14A | 15A | 16A |
| Pigment dispersion K1A | 40 (5.2) | | | | | | | |
| Pigment dispersion K2A | | | | | 60 (6.8) | | | |
| Pigment dispersion K3A | | | | | | | | |
| Pigment dispersion K4A | | | | | | | | |
| Pigment dispersion K5A | | | | | | | | |
| Pigment dispersion Y1A | | 40 (5.5) | | | | | | |
| Pigment dispersion Y2A | | | | | | 50 (6.1) | | |
| Pigment dispersion Y3A | | | | | | | | |
| Pigment dispersion Y4A | | | | | | | | |
| Pigment dispersion M1A | | | 40 (6.3) | | | | | |
| Pigment dispersion M2A | | | | | | | 50 (6.3) | |
| Pigment dispersion M3A | | | | | | | | |
| Pigment dispersion M4A | | | | | | | | |
| Pigment dispersion C1A | | | | 40 (3.6) | | | | |
| Pigment dispersion C2A | | | | | | | | 40 (4.0) |
| Pigment dispersion C3A | | | | | | | | |
| Pigment dispersion C4A | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17A | 18A | 19A | 20A | 21A | 22A | 23A | 24A |
| Pigment dispersion K1A | 35 (4.6) | | | | | | | |
| Pigment dispersion K2A | | | | | 50 (5.7) | | | |
| Pigment dispersion K3A | | | | | | | | |
| Pigment dispersion K4A | | | | | | | | |
| Pigment dispersion K5A | | | | | | | | |
| Pigment dispersion Y1A | | 45 (6.2) | | | | | | |
| Pigment dispersion Y2A | | | | | | 45 (5.5) | | |
| Pigment dispersion Y3A | | | | | | | | |
| Pigment dispersion Y4A | | | | | | | | |
| Pigment dispersion M1A | | | 35 (5.5) | | | | | |
| Pigment dispersion M2A | | | | | | | 45 (5.7) | |
| Pigment dispersion M3A | | | | | | | | |
| Pigment dispersion M4A | | | | | | | | |
| Pigment dispersion C1A | | | | 45 (4.1) | | | | |
| Pigment dispersion C2A | | | | | | | | 50 (4.5) |
| Pigment dispersion C3A | | | | | | | | |
| Pigment dispersion C4A | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10A | 11A | 12A | 13A | 14A | 15A | 16A | 17A | 18A |
| Pigment dispersion K1A | | | | | | | | | |
| Pigment dispersion K2A | | | | | | | | | |
| Pigment dispersion K3A | 40 (5.2) | | | | | | | | |
| Pigment dispersion K4A | | | | | 40 (5.2) | | | | |
| Pigment dispersion K5A | | | | | | | | | 20 (4.0) |
| Pigment dispersion Y1A | | | | | | | | | |
| Pigment dispersion Y2A | | | | | | | | | |
| Pigment dispersion Y3A | | 40 (5.7) | | | | | | | |
| Pigment dispersion Y4A | | | | | | 40 (5.5) | | | |
| Pigment dispersion M1A | | | | | | | | | |
| Pigment dispersion M2A | | | | | | | | | |
| Pigment dispersion M3A | | | 40 (6.3) | | | | | | |
| Pigment dispersion M4A | | | | | | | 40 (6.3) | | |
| Pigment dispersion C1A | | | | | | | | | |
| Pigment dispersion C2A | | | | | | | | | |
| Pigment dispersion C3A | | | | 40 (3.6) | | | | | |
| Pigment dispersion C4A | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1B

### Pigment Dispersion K1B

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)).

To 98 parts of the dispersion obtained from and by the materials and method described above, 2 parts of BYK-347 (trade name, product of BYK Japan KK)), i.e., a siloxane-based surfactant, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1B (pigment-water-insoluble polymer solid concentration: 19.6 mass %) of this example.

### Example 2B

### Pigment Dispersion Y1B

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 parts of KF-6015 (trade name, product of Shin-Etsu Chemical Co., Ltd.), i.e., a siloxane-based surfactant serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain pigment dispersion Y1B (pigment-water-insoluble polymer solid concentration: 18.0 mass %) of this example.

### Example 3B

### Pigment Dispersion M1B

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of FZ-2118 (trade name, product of Dow Corning Toray), i.e., a siloxane-based surfactant serving as a wetting agent, and 0.05 parts of Proxel XL2 (trade names, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain pigment dispersion M1B (pigment-water-insoluble polymer solid concentration: 19.0 mass %) of this example.

### Example 4B

### Pigment Dispersion C1B

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of FZ-2162 (trade name, product of Dow Corning Toray), i.e., a siloxane-based surfactant serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain pigment dispersion C1B (pigment-water-insoluble polymer solid concentration: 18.0 mass %) of this example.

### Example 5B

### Pigment Dispersion K2B

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the pigment dispersion obtained from and by the materials and method described above, 5 parts of KF-640 (trade name, product of Shin-Etsu Chemical Co., Ltd.), i.e., a siloxane-based surfactant, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2B (pigment-water-insoluble polymer solid concentration: 19.0 mass %) of this example.

### Example 6B

### Pigment Dispersion Y2B

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of KF-354L (trade name, product of Shin-Etsu Chemical Co., Ltd.), i.e., a siloxane-based surfactant serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2B (pigment-water-insoluble polymer solid concentration: 17.0 mass %) of this example.

### Example 7B

### Pigment Dispersion M2B

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of Surfynol FZ-7002 (trade name, product of Dow Corning Toray), i.e., a siloxane-based surfactant serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain pigment dispersion M2B (pigment-water-insoluble polymer solid concentration: 19.0 mass %) of this example.

### Example 8B

### Pigment Dispersion C2B

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of KF-6011 (trade name, product of Shin-Etsu Chemical Co., Ltd.) and 0.2 parts of KF-6015 (trade name, product of Shin-Etsu Chemical Co., Ltd.), i.e., siloxane-based surfactants serving as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain pigment dispersion C2B (pigment-water-insoluble polymer solid concentration: 18.0 mass %) of this example.

### Comparative Example 1B

### Pigment Dispersion K3B

Pigment dispersion K3B of this comparative example having a pigment-water-insoluble polymer solid concentration of 19.6 mass % (pigment:water-insoluble polymer=10:5 (mass ratio)) was prepared from and by the same materials and method for pigment dispersion K1B (Example 1B) described above except that the heat treatment was not conducted.

### Comparative Example 2B

### Pigment Dispersion Y3B

Pigment dispersion Y3B of this comparative example having a pigment-water-insoluble polymer solid concentration of 18.4 mass % (pigment:water-insoluble polymer=10:3 (mass ratio)) was prepared from and by the same materials and method for pigment dispersion Y1B (Example 2B) described above except that, during the heat treatment, KF-6015 (trade name, product of Shin-Etsu Chemical Co., Ltd.), i.e., a siloxane-based surfactant serving as a wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3B

### Pigment Dispersion M3B

Pigment dispersion M3B of this reference example having a pigment-water-insoluble polymer solid concentration of 19.0 mass % (pigment:water-insoluble polymer=10:2 (mass ratio)) was prepared from and by the same materials and method for pigment dispersion M1B (Example 3B) described above except that, during the heat treatment, the heating temperature was changed to 120° C. and the heating time was changed to 30 minutes.

### Reference Example 4B

### Pigment Dispersion C3B

Pigment dispersion C3B of this reference example having a pigment-water-insoluble polymer solid concentration of 18.0 mass % (pigment:water-insoluble polymer=10:10 (mass ratio)) was prepared from and by the same materials and method for pigment dispersion C1B (Example 4B) described above except that, during the heat treatment, the heating temperature was changed to 60° C. and the heating time was changed to 100 hours.

### Reference Example 5B

### Pigment Dispersion K4B

Pigment dispersion K4B of this reference example having a pigment-water-insoluble polymer solid concentration of 19.6 mass % (pigment:water-insoluble polymer=10:5 (mass ratio)) was prepared from and by the same materials and method for pigment dispersion K1B (Example 1B) described above except that, during the heat treatment, the heating time was changed to 20 minutes.

### Reference Example 6B

### Pigment Dispersion Y4B

Pigment dispersion Y4B of this reference example having a pigment-water-insoluble polymer solid concentration of 18.0 mass % (pigment:water-insoluble polymer=10:3 (mass ratio)) was prepared from and by the same materials and method for pigment dispersion Y1B (Example 2B) described above except that, during the heat treatment, the heating time was changed to 120 hours.

### Comparative Example 7B

### Pigment Dispersion M4B

Pigment dispersion M4B of this comparative example having a pigment-water-insoluble polymer solid concentration of 19.4 mass % (pigment:water-insoluble polymer=10:2 (mass ratio)) was prepared from and by the same materials and method for pigment dispersion M1B (Example 3B) described above except that, during the heat treatment, 0.05 parts of FZ-2118 (trade name, product of Dow Corning Toray), i.e., a siloxane-based surfactant serving as a wetting agent, and 4.9 parts of 1,2-hexanediol, i.e., a water-soluble organic solvent, were used.

### Comparative Example 8B

### Pigment Dispersion C4B

Pigment dispersion C4B of this comparative example having a pigment-water-insoluble polymer solid concentration of 16.0 mass % (pigment:water-insoluble polymer=10:10 (mass ratio)) was prepared from and by the same materials and method for pigment dispersion C1B (Example 4B) described above except that, during the heat treatment, 11 parts of FZ-2162 (trade name, product of Dow Corning Toray), i.e., a siloxane-based surfactant serving as a wetting agent, and 80 parts of the dispersion were used.

### Comparative Example 9B

### Pigment Dispersion K5B

Twenty parts of MA 100 (trade name, product of Mitsubishi Chemical Corporation), i.e., carbon black serving as a pigment, 5 parts of KF-640 (product of Shin-Etsu Chemical Co., Ltd.), i.e., a siloxane-based surfactant, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5B of this comparative example having a pigment-water-insoluble polymer solid concentration of 23 mass % (pigment:water-insoluble polymer=10:1.5 (mass ratio)).

[Preparation of Water-Based Ink Composition B]

Water-based ink compositions of Examples 9B to 24B, Comparative Examples 10B, 11B, and 16B to 18B, and Reference Examples 12B to 15B were prepared from the pigment dispersions and polymer emulsions obtained from and by the materials and methods described above according to the compositions shown in Table 2B. Each water-based ink composition was prepared by stirring and mixing materials described in Table 2B in amounts described in the table at room temperature for 2 hours and filtering the resulting mixture with a membrane filter having 5 μm pores. In Table 2B, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2B

| | Examples | | | | | | | |
|---|---|---|---|---|---|---|---|---|
| Ink composition | 9B | 10B | 11B | 12B | 13B | 14B | 15B | 16B |
| Pigment dispersion K1B | 40 (5.2) | | | | | | | |
| Pigment dispersion K2B | | | | | 60 (6.8) | | | |
| Pigment dispersion K3B | | | | | | | | |
| Pigment dispersion K4B | | | | | | | | |
| Pigment dispersion K5B | | | | | | | | |
| Pigment dispersion Y1B | | 40 (5.5) | | | | | | |
| Pigment dispersion Y2B | | | | | | 50 (6.1) | | |
| Pigment dispersion Y3B | | | | | | | | |
| Pigment dispersion Y4B | | | | | | | | |
| Pigment dispersion M1B | | | 40 (6.3) | | | | | |
| Pigment dispersion M2B | | | | | | | 50 (6.3) | |
| Pigment dispersion M3B | | | | | | | | |
| Pigment dispersion M4B | | | | | | | | |
| Pigment dispersion C1B | | | | 40 (3.6) | | | | |
| Pigment dispersion C2B | | | | | | | | 40 (4.0) |
| Pigment dispersion C3B | | | | | | | | |
| Pigment dispersion C4B | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17B | 18B | 19B | 20B | 21B | 22B | 23B | 24B |
| Pigment dispersion K1B | 35 (4.6) | | | | | | | |
| Pigment dispersion K2B | | | | | 50 (5.7) | | | |
| Pigment dispersion K3B | | | | | | | | |
| Pigment dispersion K4B | | | | | | | | |
| Pigment dispersion K5B | | | | | | | | |
| Pigment dispersion Y1B | | 45 (6.2) | | | | | | |
| Pigment dispersion Y2B | | | | | | 45 (5.5) | | |
| Pigment dispersion Y3B | | | | | | | | |
| Pigment dispersion Y4B | | | | | | | | |
| Pigment dispersion M1B | | | 35 (5.5) | | | | | |
| Pigment dispersion M2B | | | | | | | 45 (5.7) | |
| Pigment dispersion M3B | | | | | | | | |
| Pigment dispersion M4B | | | | | | | | |
| Pigment dispersion C1B | | | | 45 (4.1) | | | | |
| Pigment dispersion C2B | | | | | | | | 50 (4.5) |
| Pigment dispersion C3B | | | | | | | | |
| Pigment dispersion C4B | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10B | 11B | 12B | 13B | 14B | 15B | 16B | 17B | 18B |
| Pigment dispersion K1B | | | | | | | | | |
| Pigment dispersion K2B | | | | | | | | | |
| Pigment dispersion K3B | 40 (5.2) | | | | | | | | |
| Pigment dispersion K4B | | | | | 40 (5.2) | | | | |
| Pigment dispersion K5B | | | | | | | | | 20 (4.0) |
| Pigment dispersion Y1B | | | | | | | | | |
| Pigment dispersion Y2B | | | | | | | | | |
| Pigment dispersion Y3B | | 40 (5.7) | | | | | | | |
| Pigment dispersion Y4B | | | | | | 40 (5.5) | | | |
| Pigment dispersion M1B | | | | | | | | | |
| Pigment dispersion M2B | | | | | | | | | |
| Pigment dispersion M3B | | | 40 (6.3) | | | | | | |
| Pigment dispersion M4B | | | | | | | 40 (6.3) | | |
| Pigment dispersion C1B | | | | | | | | | |
| Pigment dispersion C2B | | | | | | | | | |
| Pigment dispersion C3B | | | | 40 (3.6) | | | | | |
| Pigment dispersion C4B | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1C

### Pigment Dispersion K1C

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)).

To 98 parts of the dispersion obtained from and by the materials and method described above, 2 parts of EFTOP EF-105 (trade name, product of JEMCO), i.e., a fluorine-based surfactant, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1C (pigment-water-insoluble polymer solid concentration: 19.6 mass %) of this example.

### Example 2C

### Pigment Dispersion Y1C

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 parts of Megaface F-470 (trade name, product of DIC Corporation), i.e., a fluorine-based surfactant serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain pigment dispersion Y1C (pigment-water-insoluble polymer solid concentration: 18.0 mass %) of this example.

### Example 3C

### Pigment Dispersion M1C

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of Megaface F-477 (trade name, product of DIC Corporation), i.e., a fluorine-based surfactant serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain pigment dispersion M1C (pigment-water-insoluble polymer solid concentration: 19.0 mass %) of this example.

### Example 4C

### Pigment Dispersion C1C

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of Ftergent 150CH (trade name, product of Neos Company Ltd.), i.e., a fluorine-based surfactant serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain pigment dispersion C1C (pigment-water-insoluble polymer solid concentration: 18.0 mass %) of this example.

### Example 5C

### Pigment Dispersion K2C

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the dispersion obtained from and by the materials and method described above, 5 parts of EFTOP EF-122B (trade name, product of JEMCO), i.e., a fluorine-based surfactant, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2C (pigment-water-insoluble polymer solid concentration: 19.0 mass %) of this example.

### Example 2C

### Pigment Dispersion Y2C

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of EFTOP EF-122A (trade name, product of JEMCO), i.e., a fluorine-based surfactant serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2C (pigment-water-insoluble polymer solid concentration: 17.0 mass %) of this example.

### Example 7C

### Pigment Dispersion M2C

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of Megaface F-494 (trade name, product of DIC Corporation), i.e., a fluorine-based surfactant serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain pigment dispersion M2C (pigment-water-insoluble polymer solid concentration: 19.0 mass %) of this example.

### Example 8C

### Pigment Dispersion C2C

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of EFTOP EF-105 (trade name, product of JEMCO) and 0.2 parts of Megaface F-470 (trade name, product of DIC Corporation), i.e., fluorine-based surfactants serving as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain pigment dispersion C2C (pigment-water-insoluble polymer solid concentration: 18.0 mass %) of this example.

### Comparative Example 1C

### Pigment Dispersion K3C

Pigment dispersion K3C of this comparative example having a pigment-water-insoluble polymer solid concentration of 19.6 mass % (pigment:water-insoluble polymer=10:5 (mass ratio)) was prepared from and by the same materials and method for pigment dispersion K1C (Example 1C) described above except that the heat treatment was not conducted.

### Comparative Example 2C

### Pigment Dispersion Y3C

Pigment dispersion Y3C of this comparative example having a pigment-water-insoluble polymer solid concentration of 18.4 mass % (pigment:water-insoluble polymer=10:3 (mass ratio)) was prepared from and by the same materials and method for pigment dispersion Y1C (Example 2C) described above except that, during the heat treatment, Megaface F-470 (trade name, product of DIC Corporation), i.e., a fluorine-based surfactant serving as a wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3C

### Pigment Dispersion M3C

Pigment dispersion M3C of this reference example having a pigment-water-insoluble polymer solid concentration of 19.0 mass % (pigment:water-insoluble polymer=10:2 (mass ratio)) was prepared from and by the same materials and method for pigment dispersion M1C (Example 3C) described above except that, during the heat treatment, the heating temperature was changed to 120° C. and the heating time was changed to 30 minutes.

### Reference Example 4C

### Pigment Dispersion C3C

Pigment dispersion C3C of this reference example having a pigment-water-insoluble polymer solid concentration of 18.0 mass % (pigment:water-insoluble polymer=10:10 (mass ratio)) was prepared from and by the same materials and method for pigment dispersion C1C (Example 4C) described above except that, during the heat treatment, the heating temperature was changed to 60° C. and the heating time was changed to 100 hours.

### Reference Example 5C

### Pigment Dispersion K4C

Pigment dispersion K4C of this reference example having a pigment-water-insoluble polymer solid concentration of 19.6 mass % (pigment:water-insoluble polymer=10:5 (mass ratio)) was prepared from and by the same materials and method for pigment dispersion K1C (Example 1C) described above except that, during the heat treatment, the heating time was changed to 20 minutes.

### Reference Example 6C

### Pigment Dispersion Y4C

Pigment dispersion Y4C of this reference example having a pigment-water-insoluble polymer solid concentration of 18.0 mass % (pigment:water-insoluble polymer=10:3 (mass ratio)) was prepared from and by the same materials and method for pigment dispersion Y1C (Example 2C) described above except that, during the heat treatment, the heating time was changed to 120 hours.

### Comparative Example 7C

### Pigment Dispersion M4C

Pigment dispersion M4C of this comparative example having a pigment-water-insoluble polymer solid concentration of 19.4 mass % (pigment:water-insoluble polymer=10:2 (mass ratio)) was prepared from and by the same materials and method for pigment dispersion M1C (Example 3C) described above except that, during the heat treatment, 0.05 parts of Megaface F-477 (trade name, product of DIC Corporation), i.e., an acetylene glycol-based surfactant serving as a wetting agent, and 4.9 parts of 1,2-hexanediol, i.e., a water-soluble organic solvent, were used.

### Comparative Example 8C

### Pigment Dispersion C4C

Pigment dispersion C4C of this comparative example having a pigment-water-insoluble polymer solid concentration of 16.0 mass % (pigment:water-insoluble polymer=10:10 (mass ratio)) was prepared from and by the same materials and method for pigment dispersion C1C (Example 4C) described above except that, during the heat treatment, 11 parts of Ftergent 150CH (trade name, product of Neos Company Ltd.), i.e., a fluorine-based surfactant serving as a wetting agent, and 80 parts of the dispersion were used.

### Comparative Example 9C

### Pigment Dispersion K5C

Twenty parts of MA 100 (trade name, product of Mitsubishi Chemical Corporation), i.e., carbon black serving as a pigment, 5 parts of EFTOP EF-122B (product of JEMCO), i.e., a fluorine-based surfactant, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5C of this comparative example having a pigment-water-insoluble polymer solid concentration of 23 mass % (pigment:water-insoluble polymer=10:1.5 (mass ratio)).

[Preparation of Water-Based Ink Composition C]

Water-based ink compositions of Examples 9C to 24C, Comparative Examples 10C, 11C, and 16C to 18C, and Reference Examples 12B to 15B were prepared from the pigment dispersions and polymer emulsions obtained from and by the materials and methods described above according to the compositions shown in Table 2C. Each water-based ink composition was prepared by stirring and mixing materials described in Table 2C in amounts described in the table at room temperature for 2 hours and filtering the resulting mixture with a membrane filter having 5 μm pores. In Table 2C, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2C

| | Examples | | | | | | | |
|---|---|---|---|---|---|---|---|---|
| Ink composition | 9C | 10C | 11C | 12C | 13C | 14C | 15C | 16C |
| Pigment dispersion K1C | 40 (5.2) | | | | | | | |
| Pigment dispersion K2C | | | | | 60 (6.8) | | | |
| Pigment dispersion K3C | | | | | | | | |
| Pigment dispersion K4C | | | | | | | | |
| Pigment dispersion K5C | | | | | | | | |
| Pigment dispersion Y1C | | 40 (5.5) | | | | | | |
| Pigment dispersion Y2C | | | | | | 50 (6.1) | | |
| Pigment dispersion Y3C | | | | | | | | |
| Pigment dispersion Y4C | | | | | | | | |
| Pigment dispersion M1C | | | 40 (6.3) | | | | | |
| Pigment dispersion M2C | | | | | | | 50 (6.3) | |
| Pigment dispersion M3C | | | | | | | | |
| Pigment dispersion M4C | | | | | | | | |
| Pigment dispersion C1C | | | | 40 (3.6) | | | | |
| Pigment dispersion C2C | | | | | | | | 40 (4.0) |
| Pigment dispersion C3C | | | | | | | | |
| Pigment dispersion C4C | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17C | 18C | 19C | 20C | 21C | 22C | 23C | 24C |
| Pigment dispersion K1C | 35 (4.6) | | | | | | | |
| Pigment dispersion K2C | | | | | 50 (5.7) | | | |
| Pigment dispersion K3C | | | | | | | | |
| Pigment dispersion K4C | | | | | | | | |
| Pigment dispersion K5C | | | | | | | | |
| Pigment dispersion Y1C | | 45 (6.2) | | | | | | |
| Pigment dispersion Y2C | | | | | | 45 (5.5) | | |
| Pigment dispersion Y3C | | | | | | | | |
| Pigment dispersion Y4C | | | | | | | | |
| Pigment dispersion M1C | | | 35 (5.5) | | | | | |
| Pigment dispersion M2C | | | | | | | 45 (5.7) | |
| Pigment dispersion M3C | | | | | | | | |
| Pigment dispersion M4C | | | | | | | | |
| Pigment dispersion C1C | | | | 45 (4.1) | | | | |
| Pigment dispersion C2C | | | | | | | | 50 (4.5) |
| Pigment dispersion C3C | | | | | | | | |
| Pigment dispersion C4C | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10C | 11C | 12C | 13C | 14C | 15C | 16C | 17C | 18C |
| Pigment dispersion K1C | | | | | | | | | |
| Pigment dispersion K2C | | | | | | | | | |
| Pigment dispersion K3C | 40 (5.2) | | | | | | | | |
| Pigment dispersion K4C | | | | | 40 (5.2) | | | | |
| Pigment dispersion K5C | | | | | | | | | 20 (4.0) |
| Pigment dispersion Y1C | | | | | | | | | |
| Pigment dispersion Y2C | | | | | | | | | |
| Pigment dispersion Y3C | | 40 (5.7) | | | | | | | |
| Pigment dispersion Y4C | | | | | | 40 (5.5) | | | |
| Pigment dispersion M1C | | | | | | | | | |
| Pigment dispersion M2C | | | | | | | | | |
| Pigment dispersion M3C | | | 40 (6.3) | | | | | | |
| Pigment dispersion M4C | | | | | | | 40 (6.3) | | |
| Pigment dispersion C1C | | | | | | | | | |
| Pigment dispersion C2C | | | | | | | | | |
| Pigment dispersion C3C | | | | 40 (3.6) | | | | | |
| Pigment dispersion C4C | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1D

### Pigment Dispersion K1D

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)).

To 98 parts of the dispersion obtained from and by the materials and method described above, 2 parts of Newcol 2308 (trade name, polyoxyethylene alkyl ether, product of Nippon Nyukazai Co., Ltd.), i.e., a polyoxyalkylene-based nonionic surfactant, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1D (pigment-water-insoluble polymer solid concentration: 19.6 mass %) of this example.

### Example 2D

### Pigment Dispersion Y1D

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 parts of EMULGEN 105 (trade name, polyoxyethylene lauryl ether, product of KAO CORPORATION), i.e., a polyoxyalkylene-based nonionic surfactant serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain pigment dispersion Y1D (pigment-water-insoluble polymer solid concentration: 18.0 mass %) of this example.

### Example 3D

### Pigment Dispersion M1D

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of EMALEX DAPE-0207 (trade name, polyoxyethylene.polyoxypropylene decyl ether, product of NIHON EMULSION Co., Ltd.), i.e., a polyoxyethylene-based nonionic surfactant serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain a pigment dispersion M1D (pigment-water-insoluble polymer solid concentration: 19.0 mass %) of this example.

### Example 4D

### Pigment Dispersion C1D

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of EMALEX OD-5 (trade name, polyoxyethylene octyldodecyl ether, product of NIHON EMULSION Co., Ltd.), i.e., a polyoxyalkylene-based nonionic surfactant serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain pigment dispersion C1D (pigment-water-insoluble polymer solid concentration: 18.0 mass %) of this example.

### Example 5D

### Pigment Dispersion K2D

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the dispersion obtained from and by the materials and method described above, 5 parts of RHEODOL TW-S120V (trade name, polyoxyethylene sorbitan monostearate, product of KAO CORPORATION), i.e., a polyoxyalkylene-based nonionic surfactant, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare pigment dispersion K2D (pigment-water-insoluble polymer solid concentration: 19.0 mass %) of this example.

### Example 6D

### Pigment Dispersion Y2D

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of Newcol 747 (trade name, polyoxyethylene polycyclic phenyl ether, product of Nippon Nyukazai Co., Ltd.), i.e., a polyoxyalkylene-based nonionic surfactant serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2D (pigment-water-insoluble polymer solid concentration: 17.0 mass %) of this example.

### Example 7D

### Pigment Dispersion M2D

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of EMALEX RWIS-105 (trade name, polyoxyethylene hydrogenated castor oil isostearate, product of product of NIHON EMULSION Co., Ltd.), i.e., a polyoxyalkylene-based nonionic surfactant serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain a pigment dispersion M2D (pigment-water-insoluble polymer solid concentration: 19.0 mass %) of this example.

### Example 8D

### Pigment Dispersion C2D

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of Newcol CMP-1 (trade name, polyoxyethylene cumyl phenyl ether, product of Nippon Nyukazai Co., Ltd.) and 0.2 parts of EMALEX TPS-305 (trade name, polyoxyethylene trimethylolpropane tristearate, product of NIHON EMULSION Co., Ltd.), i.e., polyoxyalkylene-based nonionic surfactants serving as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain pigment dispersion C2D (pigment-water-insoluble polymer solid concentration: 18.0 mass %) of this example.

### Comparative Example 1D

### Pigment Dispersion K3D

Pigment dispersion K3D of this comparative example having a pigment-water-insoluble polymer solid concentration of 19.6 mass % (pigment:water-insoluble polymer=10:5 (mass ratio)) was prepared from and by the same materials and method for pigment dispersion K1D (Example 1D) described above except that the heat treatment was not conducted.

### Comparative Example 2D

### Pigment Dispersion Y3D

Pigment dispersion Y3D of this comparative example having a pigment-water-insoluble polymer solid concentration of 18.4 mass % (pigment:water-insoluble polymer=10:3 (mass ratio)) was prepared from and by the same materials and method for pigment dispersion Y1D (Example 2D) described above except that, during the heat treatment, EMULGEN 105 (trade name, polyoxyethylene lauryl ether, product of KAO CORPORATION), i.e., a polyoxyalkylene-based nonionic surfactant serving as a wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3D

### Pigment Dispersion M3D

Pigment dispersion M3D of this reference example having a pigment-water-insoluble polymer solid concentration of 19.0 mass % (pigment:water-insoluble polymer=10:2 (mass ratio)) was prepared from and by the same materials and method for pigment dispersion M1D (Example 3D) described above except that, during the heat treatment, the heating temperature was changed to 120° C. and the heating time was changed to 30 minutes.

### Reference Example 4D

### Pigment Dispersion C3D

Pigment dispersion C3D of this reference example having a pigment-water-insoluble polymer solid concentration of 18.0 mass % (pigment:water-insoluble polymer=10:10 (mass ratio)) was prepared from and by the same materials and method for pigment dispersion C1D (Example 4D) described above except that, during the heat treatment, the heating temperature was changed to 60° C. and the heating time was changed to 100 hours.

### Reference Example 5D

### Pigment Dispersion K4D

Pigment dispersion K4D of this reference example having a pigment-water-insoluble polymer solid concentration of 19.6 mass % (pigment:water-insoluble polymer=10:5 (mass ratio)) was prepared from and by the same materials and method for pigment dispersion K1D (Example 1D) described above except that, during the heat treatment, the heating time was changed to 20 minutes.

### Reference Example 6D

### Pigment Dispersion Y4D

Pigment dispersion Y4D of this reference example having a pigment-water-insoluble polymer solid concentration of 18.0 mass % (pigment:water-insoluble polymer=10:3 (mass ratio)) was prepared from and by the same materials and method for pigment dispersion Y1D (Example 2D) described above except that, during the heat treatment, the heating time was changed to 120 hours.

### Comparative Example 7D

### Pigment Dispersion M4D

Pigment dispersion M4D of this comparative example having a pigment-water-insoluble polymer solid concentration of 19.4 mass % (pigment:water-insoluble polymer=10:2 (mass ratio)) was prepared from and by the same materials and method for pigment dispersion M1D (Example 3D) described above except that, during the heat treatment, 0.05 parts of EMALEX DAPE-0207 (trade name, polyoxyethylene.polyoxypropylene decyl ether, product of NIHON EMULSION Co., Ltd.), i.e., a polyoxyethylene-based nonionic surfactant serving as a wetting agent, and 4.9 parts of 1,2-hexanediol, i.e., a water-soluble organic solvent, were used.

### Comparative Example 8D

### Pigment Dispersion C4D

Pigment dispersion C4D of this comparative example having a pigment-water-insoluble polymer solid concentration of 16.0 mass % (pigment:water-insoluble polymer=10:10 (mass ratio)) was prepared from and by the same materials and method for pigment dispersion C1D (Example 4D) described above except that, during the heat treatment, 11 parts of EMALEX OD-5 (trade name, polyoxyethylene octyldodecyl ether, product of NIHON EMULSION Co., Ltd.), i.e., a polyoxyalkylene-based nonionic surfactant serving as a wetting agent, and 80 parts of the dispersion were used.

### Comparative Example 9D

### Pigment Dispersion K5D

Twenty parts of MA 100 (trade name, product of Mitsubishi Chemical Corporation), i.e., carbon black serving as a pigment, 5 parts of polyoxyethylene acetyl ether (product of Nicco Chemicals Co., Ltd.), i.e., a polyoxyalkylene-based nonionic surfactant, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5D of this comparative example having a pigment-water-insoluble polymer solid concentration of 23 mass % (pigment:water-insoluble polymer=10:1.5 (mass ratio)).

[Preparation of Water-Based Ink Composition D]

Water-based ink compositions of Examples 9D to 24D, Comparative Examples 10D, 11D, and 16D to 18D, and Reference Examples 12D to 15D were prepared from the pigment dispersions and polymer emulsions obtained from and by the materials and methods described above according to the compositions shown in Table 2D. Each water-based ink composition was prepared by stirring and mixing materials described in Table 2D in amounts described in the table at room temperature for 2 hours and filtering the resulting mixture with a membrane filter having 5 μm pores. In Table 2D, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2D

| | Examples | | | | | | | |
|---|---|---|---|---|---|---|---|---|
| Ink composition | 9D | 10D | 11D | 12D | 13D | 14D | 15D | 16D |
| Pigment dispersion K1D | 40 (5.2) | | | | | | | |
| Pigment dispersion K2D | | | | | 60 (6.8) | | | |
| Pigment dispersion K3D | | | | | | | | |
| Pigment dispersion K4D | | | | | | | | |
| Pigment dispersion K5D | | | | | | | | |
| Pigment dispersion Y1D | | 40 (5.5) | | | | | | |
| Pigment dispersion Y2D | | | | | | 50 (6.1) | | |
| Pigment dispersion Y3D | | | | | | | | |
| Pigment dispersion Y4D | | | | | | | | |
| Pigment dispersion M1D | | | 40 (6.3) | | | | | |
| Pigment dispersion M2D | | | | | | | 50 (6.3) | |
| Pigment dispersion M3D | | | | | | | | |
| Pigment dispersion M4D | | | | | | | | |
| Pigment dispersion C1D | | | | 40 (3.6) | | | | |
| Pigment dispersion C2D | | | | | | | | 40 (4.0) |
| Pigment dispersion C3D | | | | | | | | |
| Pigment dispersion C4D | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17D | 18D | 19D | 20D | 21D | 22D | 23D | 24D |
| Pigment dispersion K1D | 35 (4.6) | | | | | | | |
| Pigment dispersion K2D | | | | | 50 (5.7) | | | |
| Pigment dispersion K3D | | | | | | | | |
| Pigment dispersion K4D | | | | | | | | |
| Pigment dispersion K5D | | | | | | | | |
| Pigment dispersion Y1D | | 45 (6.2) | | | | | | |
| Pigment dispersion Y2D | | | | | | 45 (5.5) | | |
| Pigment dispersion Y3D | | | | | | | | |
| Pigment dispersion Y4D | | | | | | | | |
| Pigment dispersion M1D | | | 35 (5.5) | | | | | |
| Pigment dispersion M2D | | | | | | | 45 (5.7) | |
| Pigment dispersion M3D | | | | | | | | |
| Pigment dispersion M4D | | | | | | | | |
| Pigment dispersion C1D | | | | 45 (4.1) | | | | |
| Pigment dispersion C2D | | | | | | | | 50 (4.5) |
| Pigment dispersion C3D | | | | | | | | |
| Pigment dispersion C4D | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10D | 11D | 12D | 13D | 14D | 15D | 16D | 17D | 18D |
| Pigment dispersion K1D | | | | | | | | | |
| Pigment dispersion K2D | | | | | | | | | |
| Pigment dispersion K3D | 40 (5.2) | | | | | | | | |
| Pigment dispersion K4D | | | | | 40 (5.2) | | | | |
| Pigment dispersion K5D | | | | | | | | | 20 (4.0) |
| Pigment dispersion Y1D | | | | | | | | | |
| Pigment dispersion Y2D | | | | | | | | | |
| Pigment dispersion Y3D | | 40 (5.7) | | | | | | | |
| Pigment dispersion Y4D | | | | | | 40 (5.5) | | | |
| Pigment dispersion M1D | | | | | | | | | |
| Pigment dispersion M2D | | | | | | | | | |
| Pigment dispersion M3D | | | 40 (6.3) | | | | | | |
| Pigment dispersion M4D | | | | | | | 40 (6.3) | | |
| Pigment dispersion C1D | | | | | | | | | |
| Pigment dispersion C2D | | | | | | | | | |
| Pigment dispersion C3D | | | | 40 (3.6) | | | | | |
| Pigment dispersion C4D | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1E

### Pigment Dispersion K1E

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)).

To 98 parts of the dispersion obtained from and by the materials and method described above, 2 parts of Disrol SH (trade name, naphthalene sulfonic acid formalin condensate sodium salt, product of Nippon Nyukazai Co., Ltd.), i.e., an anionic surfactant, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1E (pigment-water-insoluble polymer solid concentration: 19.6 mass %) of this example.

### Example 2E

### Pigment Dispersion Y1E

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer 10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 parts of SS-40N (trade name, sodium stearate, product of KAO CORPORATION), i.e., an anionic surfactant serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain a pigment dispersion Y1E (pigment-water-insoluble polymer solid concentration: 18.0 mass %) of this example.

### Example 3E

### Pigment Dispersion M1E

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of Newcol 707-SFC (trade name, polyoxyethylene polycyclic phenyl ether sulfuric acid ester salt, product of Nippon Nyukazai Co., Ltd.), i.e., an anionic surfactant serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain pigment dispersion M1E (pigment-water-insoluble polymer solid concentration: 19.0 mass %) of this example.

### Example 4E

### Pigment Dispersion C1E

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of NEOPELEX G-65 (trade name, sodium alkylbenzene sulfonate, product of KAO CORPORATION), i.e., an anionic surfactant serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain a pigment dispersion C1E (pigment-water-insoluble polymer solid concentration: 18.0 mass %) of this example.

### Example 5E

### Pigment Dispersion K2E

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the pigment dispersion obtained from and by the materials and method described above, 5 parts of Antox EHD-PNA (trade name, polyoxyalkylene alkyl ether phosphoric acid ester, product of Nippon Nyukazai Co., Ltd.), i.e., an anionic surfactant, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2E (pigment-water-insoluble polymer solid concentration: 19.0 mass %) of this example.

### Example 6E

### Pigment Dispersion Y2E

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of Newcol B13-SN (trade name, polyoxyethylene aryl ether sulfuric acid ester salt, product of Nippon Nyukazai Co., Ltd.), i.e., an anionic surfactant serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2E (pigment-water-insoluble polymer solid concentration: 17.0 mass %) of this example.

### Example 7E

### Pigment Dispersion M2E

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of Newcol 290-A (trade name, dialkyl succinate sulfonic acid sodium salt, product of product of Nippon Nyukazai Co., Ltd.), i.e., an anionic surfactant serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain pigment dispersion M2E (pigment-water-insoluble polymer solid concentration: 19.0 mass %) of this example.

### Example 8E

### Pigment Dispersion C2E

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of Newcol 1525-SFC (trade name, polyoxyethylene castor oil ether sulfuric acid ester salt, product of Nippon Nyukazai Co., Ltd.) and 0.2 parts of Newcol 293 (trade name, monoalkyl succinate sulfonic acid disodium salt, product of Co., Ltd.), i.e., anionic surfactants serving as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain a pigment dispersion C2E (pigment-water-insoluble polymer solid concentration: 18.0 mass %) of this example.

### Comparative Example 1E

### Pigment Dispersion K3E

Pigment dispersion K3E of this comparative example having a pigment-water-insoluble polymer solid concentration of 19.6 mass % (pigment:water-insoluble polymer=10:5 (mass ratio)) was prepared from and by the same materials and method for pigment dispersion K1E (Example 1E) described above except that the heat treatment was not conducted.

### Comparative Example 2E

### Pigment Dispersion Y3E

Pigment dispersion Y3E of this comparative example having a pigment-water-insoluble polymer solid concentration of 18.4 mass % (pigment:water-insoluble polymer=10:3 (mass ratio)) was prepared from and by the same materials and method for pigment dispersion Y1E (Example 2E) described above except that, during the heat treatment, SS-40N (trade name, sodium stearate, product of KAO CORPORATION), i.e., an anionic surfactant serving as a wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3E

### Pigment Dispersion M3E

Pigment dispersion M3E of this reference example having a pigment-water-insoluble polymer solid concentration of 19.0 mass % (pigment:water-insoluble polymer=10:2 (mass ratio)) was prepared from and by the same materials and method for pigment dispersion M1E (Example 3E) described above except that, during the heat treatment, the heating temperature was changed to 120° C. and the heating time was changed to 30 minutes.

### Reference Example 4E

### Pigment Dispersion C3E

Pigment dispersion C3E of this reference example having a pigment-water-insoluble polymer solid concentration of 18.0 mass % (pigment:water-insoluble polymer=10:10 (mass ratio)) was prepared from and by the same materials and method for pigment dispersion C1E (Example 4E) described above except that, during the heat treatment, the heating temperature was changed to 60° C. and the heating time was changed to 100 hours.

### Reference Example 5E

### Pigment Dispersion K4E

Pigment dispersion K4E of this reference example having a pigment-water-insoluble polymer solid concentration of 19.6 mass % (pigment:water-insoluble polymer=10:5 (mass ratio)) was prepared from and by the same materials and method for pigment dispersion K1E (Example 1E) described above except that, during the heat treatment, the heating time was changed to 20 minutes.

### Reference Example 6E

### Pigment Dispersion Y4E

Pigment dispersion Y4E of this reference example having a pigment-water-insoluble polymer solid concentration of 18.0 mass % (pigment:water-insoluble polymer=10:3 (mass ratio)) was prepared from and by the same materials and method for pigment dispersion Y1E (Example 2E) described above except that, during the heat treatment, the heating time was changed to 120 hours.

### Comparative Example 7E

### Pigment Dispersion M4E

Pigment dispersion M4A of this comparative example having a pigment-water-insoluble polymer solid concentration of 19.4 mass % (pigment:water-insoluble polymer=10:2 (mass ratio)) was prepared from and by the same materials and method for pigment dispersion M1E (Example 3E) described above except that, during the heat treatment, 0.05 parts of Newcol 707-SFC (trade name, polyoxyethylene polycyclic phenyl ether sulfuric acid ester salt, product of Nippon Nyukazai Co., Ltd.), i.e., an anionic surfactant serving as a wetting agent, and 4.9 parts of 1,2-hexanediol, i.e., a water-soluble organic solvent, were used.

### Comparative Example 8E

### Pigment Dispersion C4E

Pigment dispersion C4E of this comparative example having a pigment-water-insoluble polymer solid concentration of 16.0 mass % (pigment:water-insoluble polymer=10:10 (mass ratio)) was prepared from and by the same materials and method for pigment dispersion C1E (Example 4E) described above except that, during the heat treatment, 11 parts of NEOPELEX G-65 (trade name, sodium alkylbenzene sulfonate, product of KAO CORPORATION), i.e., an anionic surfactant serving as a wetting agent, and 80 parts of the dispersion were used.

### Comparative Example 9E

### Pigment Dispersion K5E

Twenty parts of MA 100 (trade name, product of Mitsubishi Chemical Corporation), i.e., carbon black serving as a pigment, 5 parts of Antox EHD-PNA (trade name, polyoxyalkylene alkyl ether phosphoric acid ester, product of Nippon Nyukazai Co., Ltd.), i.e., an anionic surfactant, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5E of this comparative example having a pigment-water-insoluble polymer solid concentration of 23 mass % (pigment:water-insoluble polymer=10:1.5 (mass ratio)).

[Preparation of Water-Based Ink Composition E]

Water-based ink compositions of Examples 9E to 24E, Comparative Examples 10E, 11E, and 16E to 18E, and Reference Examples 12E to 15E were prepared from the pigment dispersions and polymer emulsions obtained from and by the materials and methods described above according to the compositions shown in Table 2E. Each water-based ink composition was prepared by stirring and mixing materials described in Table 2E in amounts described in the table at room temperature for 2 hours and filtering the resulting mixture with a membrane filter having 5 μm pores. In Table 2E, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2E

| | Examples | | | | | | | |
|---|---|---|---|---|---|---|---|---|
| Ink composition | 9E | 10E | 11E | 12E | 13E | 14E | 15E | 16E |
| Pigment dispersion K1E | 40 (5.2) | | | | | | | |
| Pigment dispersion K2E | | | | | 60 (6.8) | | | |
| Pigment dispersion K3E | | | | | | | | |
| Pigment dispersion K4E | | | | | | | | |
| Pigment dispersion K5E | | | | | | | | |
| Pigment dispersion Y1E | | 40 (5.5) | | | | | | |
| Pigment dispersion Y2E | | | | | | 50 (6.1) | | |
| Pigment dispersion Y3E | | | | | | | | |
| Pigment dispersion Y4E | | | | | | | | |
| Pigment dispersion M1E | | | 40 (6.3) | | | | | |
| Pigment dispersion M2E | | | | | | | 50 (6.3) | |
| Pigment dispersion M3E | | | | | | | | |
| Pigment dispersion M4E | | | | | | | | |
| Pigment dispersion C1E | | | | 40 (3.6) | | | | |
| Pigment dispersion C2E | | | | | | | | 40 (4.0) |
| Pigment dispersion C3E | | | | | | | | |
| Pigment dispersion C4E | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17E | 18E | 19E | 20E | 21E | 22E | 23E | 24E |
| Pigment dispersion K1E | 35 (4.6) | | | | | | | |
| Pigment dispersion K2E | | | | | 50 (5.7) | | | |
| Pigment dispersion K3E | | | | | | | | |
| Pigment dispersion K4E | | | | | | | | |
| Pigment dispersion K5E | | | | | | | | |
| Pigment dispersion Y1E | | 45 (6.2) | | | | | | |
| Pigment dispersion Y2E | | | | | | 45 (5.5) | | |
| Pigment dispersion Y3E | | | | | | | | |
| Pigment dispersion Y4E | | | | | | | | |
| Pigment dispersion M1E | | | 35 (5.5) | | | | | |
| Pigment dispersion M2E | | | | | | | 45 (5.7) | |
| Pigment dispersion M3E | | | | | | | | |
| Pigment dispersion M4E | | | | | | | | |
| Pigment dispersion C1E | | | | 45 (4.1) | | | | |
| Pigment dispersion C2E | | | | | | | | 50 (4.5) |
| Pigment dispersion C3E | | | | | | | | |
| Pigment dispersion C4E | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10E | 11E | 12E | 13E | 14E | 15E | 16E | 17E | 18E |
| Pigment dispersion K1E | | | | | | | | | |
| Pigment dispersion K2E | | | | | | | | | |
| Pigment dispersion K3E | 40 (5.2) | | | | | | | | |
| Pigment dispersion K4E | | | | | 40 (5.2) | | | | |
| Pigment dispersion K5E | | | | | | | | | 20 (4.0) |
| Pigment dispersion Y1E | | | | | | | | | |
| Pigment dispersion Y2E | | | | | | | | | |
| Pigment dispersion Y3E | | 40 (5.7) | | | | | | | |
| Pigment dispersion Y4E | | | | | | 40 (5.5) | | | |
| Pigment dispersion M1E | | | | | | | | | |
| Pigment dispersion M2E | | | | | | | | | |
| Pigment dispersion M3E | | | 40 (6.3) | | | | | | |
| Pigment dispersion M4E | | | | | | | 40 (6.3) | | |
| Pigment dispersion C1E | | | | | | | | | |
| Pigment dispersion C2E | | | | | | | | | |
| Pigment dispersion C3E | | | | 40 (3.6) | | | | | |
| Pigment dispersion C4E | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1F

### Pigment Dispersion K1F

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)).

To 98 parts of the dispersion obtained from and by the materials and method described above, 2 parts of ethyl acetate, i.e., a resin solvent, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1F (pigment-water-insoluble polymer solid concentration: 19.6 mass %) of this example.

### Example 2F

### Pigment Dispersion Y1F

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 parts of propylene oxide, a resin solvent serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain pigment dispersion Y1F (pigment-water-insoluble polymer solid concentration: 18.0 mass %) of this example.

### Example 3F

### Pigment Dispersion M1F

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of sulfolane, i.e., a resin solvent serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain a pigment dispersion M1F (pigment-water-insoluble polymer solid concentration: 19.0 mass %) of this example.

### Example 4F

### Pigment Dispersion C1F

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of 1-nitropropane, i.e., a resin solvent serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain pigment dispersion C1F (pigment-water-insoluble polymer solid concentration: 18.0 mass %) of this example.

### Example 5F

### Pigment Dispersion K2F

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the dispersion obtained from and by the materials and method described above, 5 parts of acetonylacetone, i.e., a resin solvent, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2F (pigment-water-insoluble polymer solid concentration: 19.0 mass %) of this example.

### Example 6F

### Pigment Dispersion Y2F

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of N,N-dimethylformamide, i.e., a resin solvent serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2F (pigment-water-insoluble polymer solid concentration: 17.0 mass %) of this example.

### Example 7F

### Pigment Dispersion M2F

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of 2-ethylhexyl acetate i.e., a resin solvent serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain a pigment dispersion M2F (pigment-water-insoluble polymer solid concentration: 19.0 mass %) of this example.

### Example 8F

### Pigment Dispersion C2F

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of thiophene and 0.2 parts of 2-heptanol, i.e., resin solvents serving as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain pigment dispersion C2F (pigment-water-insoluble polymer solid concentration: 18.0 mass %) of this example.

### Comparative Example 1F

### Pigment Dispersion K3F

Pigment dispersion K3F of this comparative example having a pigment-water-insoluble polymer solid concentration of 19.6 mass % (pigment:water-insoluble polymer=10:5 (mass ratio)) was prepared from and by the same materials and method for pigment dispersion K1F (Example 1F) described above except that the heat treatment was not conducted.

### Comparative Example 2F

### Pigment Dispersion Y3F

Pigment dispersion Y3F of this comparative example having a pigment-water-insoluble polymer solid concentration of 18.4 mass % (pigment:water-insoluble polymer=10:3 (mass ratio)) was prepared from and by the same materials and method for pigment dispersion Y1F (Example 2F) described above except that, during the heat treatment, propylene oxide, i.e., the resin solvent serving as the wetting agent, was not added but a mixture of 92 parts of the dispersion and 6 parts of glycerol and 2 parts of triethylene glycol mono-n-butyl ether, i.e., water-soluble organic solvents, was used.

### Reference Example 3F

### Pigment Dispersion M3F

Pigment dispersion M3F of this reference example having a pigment-water-insoluble polymer solid concentration of 19.0 mass % (pigment:water-insoluble polymer=10:2 (mass ratio)) was prepared from and by the same materials and method for pigment dispersion M1F (Example 3F) described above except that, during the heat treatment, the heating temperature was changed to 120° C. and the heating time was changed to 30 minutes.

### Reference Example 4F

### Pigment Dispersion C3F

Pigment dispersion C3F of this reference example having a pigment-water-insoluble polymer solid concentration of 18.0 mass % (pigment:water-insoluble polymer=10:10 (mass ratio)) was prepared from and by the same materials and method for pigment dispersion C1F (Example 4F) described above except that, during the heat treatment, the heating temperature was changed to 60° C. and the heating time was changed to 100 hours.

### Reference Example 5F

### Pigment Dispersion K4F

Pigment dispersion K4F of this reference example having a pigment-water-insoluble polymer solid concentration of 19.6 mass % (pigment:water-insoluble polymer=10:5 (mass ratio)) was prepared from and by the same materials and method for pigment dispersion K1F (Example 1F) described above except that, during the heat treatment, the heating time was changed to 20 minutes.

### Reference Example 6F

### Pigment Dispersion Y4F

Pigment dispersion Y4F of this reference example having a pigment-water-insoluble polymer solid concentration of 18.0 mass % (pigment:water-insoluble polymer=10:3 (mass ratio)) was prepared from and by the same materials and method for pigment dispersion Y1F (Example 2F) described above except that, during the heat treatment, the heating time was changed to 120 hours.

### Comparative Example 7F

### Pigment Dispersion M4F

Pigment dispersion M4F of this comparative example having a pigment-water-insoluble polymer solid concentration of 19.4 mass % (pigment:water-insoluble polymer=10:2 (mass ratio)) was prepared from and by the same materials and method for pigment dispersion M1F (Example 3F) described above except that, during the heat treatment, 0.05 parts of sulfolane, i.e., a resin solvent serving as a wetting agent, and 4.9 parts of 1,2-hexanediol, i.e., a water-soluble organic solvent, were used.

### Comparative Example 8F

### Pigment Dispersion C4F

Pigment dispersion C4F of this comparative example having a pigment-water-insoluble polymer solid concentration of 16.0 mass % (pigment:water-insoluble polymer=10:10 (mass ratio)) was prepared from and by the same materials and method for pigment dispersion C1F (Example 4F) described above except that, during the heat treatment, 11 parts of 1-nitropropane, i.e., the resin solvent serving as the wetting agent, and 80 parts of the dispersion were used.

### Comparative Example 9F

### Pigment Dispersion K5F

Twenty parts of MA 100 (trade name, product of Mitsubishi Chemical Corporation), i.e., carbon black serving as a pigment, 5 parts of acetonylacetone, i.e., a resin-solvent, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5F of this comparative example having a pigment-water-insoluble polymer solid concentration of 23 mass % (pigment:water-insoluble polymer=10:1.5 (mass ratio)).

[Preparation of Water-Based Ink Composition F]

Water-based ink compositions of Examples 9F to 24F, Comparative Examples 10F, 11F, and 16F to 18F, and Reference Examples 12F to 15F were prepared from the pigment dispersions and polymer emulsions obtained from and by the materials and methods described above according to the compositions shown in Table 2F. Each water-based ink composition was prepared by stirring and mixing materials described in Table 2F in amounts described in the table at room temperature for 2 hours and filtering the resulting mixture with a membrane filter having 5 μm pores. In Table 2F, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2F

| | Examples | | | | | | | |
|---|---|---|---|---|---|---|---|---|
| Ink composition | 9F | 10F | 11F | 12F | 13F | 14F | 15F | 16F |
| Pigment dispersion K1F | 40 (5.2) | | | | | | | |
| Pigment dispersion K2F | | | | | 60 (6.8) | | | |
| Pigment dispersion K3F | | | | | | | | |
| Pigment dispersion K4F | | | | | | | | |
| Pigment dispersion K5F | | | | | | | | |
| Pigment dispersion Y1F | | 40 (5.5) | | | | | | |
| Pigment dispersion Y2F | | | | | | 50 (6.1) | | |
| Pigment dispersion Y3F | | | | | | | | |
| Pigment dispersion Y4F | | | | | | | | |
| Pigment dispersion M1F | | | 40 (6.3) | | | | | |
| Pigment dispersion M2F | | | | | | | 50 (6.3) | |
| Pigment dispersion M3F | | | | | | | | |
| Pigment dispersion M4F | | | | | | | | |
| Pigment dispersion C1F | | | | 40 (3.6) | | | | |
| Pigment dispersion C2F | | | | | | | | 40 (4.0) |
| Pigment dispersion C3F | | | | | | | | |
| Pigment dispersion C4F | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17F | 18F | 19F | 20F | 21F | 22F | 23F | 24F |
| Pigment dispersion K1F | 35 (4.6) | | | | | | | |
| Pigment dispersion K2F | | | | | 50 (5.7) | | | |
| Pigment dispersion K3F | | | | | | | | |
| Pigment dispersion K4F | | | | | | | | |
| Pigment dispersion K5F | | | | | | | | |
| Pigment dispersion Y1F | | 45 (6.2) | | | | | | |
| Pigment dispersion Y2F | | | | | | 45 (5.5) | | |
| Pigment dispersion Y3F | | | | | | | | |
| Pigment dispersion Y4F | | | | | | | | |
| Pigment dispersion M1F | | | 35 (5.5) | | | | | |
| Pigment dispersion M2F | | | | | | | 45 (5.7) | |
| Pigment dispersion M3F | | | | | | | | |
| Pigment dispersion M4F | | | | | | | | |
| Pigment dispersion C1F | | | | 45 (4.1) | | | | |
| Pigment dispersion C2F | | | | | | | | 50 (4.5) |
| Pigment dispersion C3F | | | | | | | | |
| Pigment dispersion C4F | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10F | 11F | 12F | 13F | 14F | 15F | 16F | 17F | 18F |
| Pigment dispersion K1F | | | | | | | | | |
| Pigment dispersion K2F | | | | | | | | | |
| Pigment dispersion K3F | 40 (5.2) | | | | | | | | |
| Pigment dispersion K4F | | | | | 40 (5.2) | | | | |
| Pigment dispersion K5F | | | | | | | | | 20 (4.0) |
| Pigment dispersion Y1F | | | | | | | | | |
| Pigment dispersion Y2F | | | | | | | | | |
| Pigment dispersion Y3F | | 40 (5.7) | | | | | | | |
| Pigment dispersion Y4F | | | | | | 40 (5.5) | | | |
| Pigment dispersion M1F | | | | | | | | | |
| Pigment dispersion M2F | | | | | | | | | |
| Pigment dispersion M3F | | | 40 (6.3) | | | | | | |
| Pigment dispersion M4F | | | | | | | 40 (6.3) | | |
| Pigment dispersion C1F | | | | | | | | | |
| Pigment dispersion C2F | | | | | | | | | |
| Pigment dispersion C3F | | | | 40 (3.6) | | | | | |
| Pigment dispersion C4F | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1G

### Pigment Dispersion K1G

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)).

To 98 parts of the dispersion obtained from and by the materials and method described above, 2 parts of 3-methoxy-1,2-propanediol, i.e., a glycerol ether compound, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1G (pigment-water-insoluble polymer solid concentration: 19.6 mass %) of this example.

### Example 2G

### Pigment Dispersion Y1G

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 parts of 3-ethoxy-1,2-propanediol, i.e., a glycerol ether compound serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain pigment dispersion Y1G (pigment-water-insoluble polymer solid concentration: 18.0 mass %) of this example.

### Example 3G

### Pigment Dispersion M1G

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of 3-allyloxy-1,2-propanediol, i.e., a glycerol ether compound serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain a pigment dispersion M1G (pigment-water-insoluble polymer solid concentration: 19.0 mass %) of this example.

### Example 4G

### Pigment Dispersion C1G

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of 3-(octadecyloxy)-1,2-propanediol, i.e., a glycerol ether compound serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain pigment dispersion C1G (pigment-water-insoluble polymer solid concentration: 18.0 mass %) of this example.

### Example 5G

### Pigment Dispersion K2G

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the dispersion obtained from and by the materials and method described above, 5 parts of monoolein, i.e., a glycerol ether compound, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2G (pigment-water-insoluble polymer solid concentration: 19.0 mass %) of this example.

### Example 6G

### Pigment Dispersion Y2G

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of 1,2-dihydroxy-3-(2-methoxyphenoxy)propane, i.e., a glycerol ether compound serving as a wetting agent and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2G (pigment-water-insoluble polymer solid concentration: 17.0 mass %) of this example.

### Example 7G

### Pigment Dispersion M2G

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of 3-phenoxy-1,2-propanediol, i.e., a glycerol ether compound serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain a pigment dispersion M2G (pigment-water-insoluble polymer solid concentration: 19.0 mass %) of this example.

### Example 8G

### Pigment Dispersion C2G

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of monoolein and 0.2 parts of 3-allyloxy-1,2-propanediol, i.e., glycerol ether compounds serving as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain pigment dispersion C2G (pigment-water-insoluble polymer solid concentration: 18.0 mass %) of this example.

### Comparative Example 1G

### Pigment Dispersion K3G

Pigment dispersion K3G of this comparative example having a pigment-water-insoluble polymer solid concentration of 19.6 mass % (pigment:water-insoluble polymer=10:5 (mass ratio)) was prepared from and by the same materials and method for pigment dispersion K1G (Example 1G) described above except that the heat treatment was not conducted.

### Comparative Example 2G

### Pigment Dispersion Y3G

Pigment dispersion Y3G of this comparative example having a pigment-water-insoluble polymer solid concentration of 18.4 mass % (pigment:water-insoluble polymer=10:3 (mass ratio)) was prepared from and by the same materials and method for pigment dispersion Y1G (Example 2G) described above except that, during the heat treatment, 3-ethoxy-1,2-propanediol, i.e., a glycerol ether compound serving as a wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3G

### Pigment Dispersion M3G

Pigment dispersion M3G of this reference example having a pigment-water-insoluble polymer solid concentration of 19.0 mass % (pigment:water-insoluble polymer=10:2 (mass ratio)) was prepared from and by the same materials and method for pigment dispersion M1G (Example 3G) described above except that, during the heat treatment, the heating temperature was changed to 120° C. and the heating time was changed to 30 minutes.

### Reference Example 4G

### Pigment Dispersion C3G

Pigment dispersion C3G of this reference example having a pigment-water-insoluble polymer solid concentration of 18.0 mass % (pigment:water-insoluble polymer=10:10 (mass ratio)) was prepared from and by the same materials and method for pigment dispersion C1G (Example 4G) described above except that, during the heat treatment, the heating temperature was changed to 60° C. and the heating time was changed to 100 hours.

### Reference Example 5G

### Pigment Dispersion K4G

Pigment dispersion K4G of this reference example having a pigment-water-insoluble polymer solid concentration of 19.6 mass % (pigment:water-insoluble polymer=10:5 (mass ratio)) was prepared from and by the same materials and method for pigment dispersion K1G (Example 1G) described above except that, during the heat treatment, the heating time was changed to 20 minutes.

### Reference Example 6G

### Pigment Dispersion Y4G

Pigment dispersion Y4G of this reference example having a pigment-water-insoluble polymer solid concentration of 18.0 mass % (pigment:water-insoluble polymer=10:3 (mass ratio)) was prepared from and by the same materials and method for pigment dispersion Y1G (Example 2G) described above except that, during the heat treatment, the heating time was changed to 120 hours.

### Comparative Example 7G

### Pigment Dispersion M4G

Pigment dispersion M4G of this comparative example having a pigment-water-insoluble polymer solid concentration of 19.4 mass % (pigment:water-insoluble polymer=10:2 (mass ratio)) was prepared from and by the same materials and method for pigment dispersion M1G (Example 3G) described above except that, during the heat treatment, 0.05 parts of 3-allyloxy-1,2-propanediol, i.e., a glycerol ether compound serving as a wetting agent, and 4.9 parts of 1,2-hexanediol, i.e., a water-soluble organic solvent, were used.

### Comparative Example 8G

### Pigment Dispersion C4G

Pigment dispersion C4G of this comparative example having a pigment-water-insoluble polymer solid concentration of 16.0 mass % (pigment:water-insoluble polymer=10:10 (mass ratio)) was prepared from and by the same materials and method for pigment dispersion C1G (Example 4G) described above except that, during the heat treatment, 11 parts of 3-(octadecyloxy)-1,2-propanediol, i.e., the glycerol ether compound serving as the wetting agent, and 80 parts of the dispersion were used.

### Comparative Example 9G

### Pigment Dispersion K5G

Twenty parts of MA 100 (trade name, product of Mitsubishi Chemical Corporation), i.e., carbon black serving as a pigment, 5 parts of monoolein, i.e., a glycerol ether compound, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5G of this comparative example having a pigment-water-insoluble polymer solid concentration of 23 mass % (pigment:water-insoluble polymer=10:1.5 (mass ratio)).

[Preparation of Water-Based Ink Composition G]

Water-based ink compositions of Examples 9G to 24G, Comparative Examples 10G, 11G, and 16G to 18G, and Reference Examples 12G to 15G were prepared from the pigment dispersions and polymer emulsions obtained from and by the materials and methods described above according to the compositions shown in Table 2G. Each water-based ink composition was prepared by stirring and mixing materials described in Table 2G in amounts described in the table at room temperature for 2 hours and filtering the resulting mixture with a membrane filter having 5 μm pores. In Table 2G, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2G

| | Examples | | | | | | | |
|---|---|---|---|---|---|---|---|---|
| Ink composition | 9G | 10G | 11G | 12G | 13G | 14G | 15G | 16G |
| Pigment dispersion K1G | 40 (5.2) | | | | | | | |
| Pigment dispersion K2G | | | | | 60 (6.8) | | | |
| Pigment dispersion K3G | | | | | | | | |
| Pigment dispersion K4G | | | | | | | | |
| Pigment dispersion K5G | | | | | | | | |
| Pigment dispersion Y1G | | 40 (5.5) | | | | | | |
| Pigment dispersion Y2G | | | | | | 50 (6.1) | | |
| Pigment dispersion Y3G | | | | | | | | |
| Pigment dispersion Y4G | | | | | | | | |
| Pigment dispersion M1G | | | 40 (6.3) | | | | | |
| Pigment dispersion M2G | | | | | | | 50 (6.3) | |
| Pigment dispersion M3G | | | | | | | | |
| Pigment dispersion M4G | | | | | | | | |
| Pigment dispersion C1G | | | | 40 (3.6) | | | | |
| Pigment dispersion C2G | | | | | | | | 40 (4.0) |
| Pigment dispersion C3G | | | | | | | | |
| Pigment dispersion C4G | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17G | 18G | 19G | 20G | 21G | 22G | 23G | 24G |
| Pigment dispersion K1G | 35 (4.6) | | | | | | | |
| Pigment dispersion K2G | | | | | 50 (5.7) | | | |
| Pigment dispersion K3G | | | | | | | | |
| Pigment dispersion K4G | | | | | | | | |
| Pigment dispersion K5G | | | | | | | | |
| Pigment dispersion Y1G | | 45 (6.2) | | | | | | |
| Pigment dispersion Y2G | | | | | | 45 (5.5) | | |
| Pigment dispersion Y3G | | | | | | | | |
| Pigment dispersion Y4G | | | | | | | | |
| Pigment dispersion M1G | | | 35 (5.5) | | | | | |
| Pigment dispersion M2G | | | | | | | 45 (5.7) | |
| Pigment dispersion M3G | | | | | | | | |
| Pigment dispersion M4G | | | | | | | | |
| Pigment dispersion C1G | | | | 45 (4.1) | | | | |
| Pigment dispersion C2G | | | | | | | | 50 (4.5) |
| Pigment dispersion C3G | | | | | | | | |
| Pigment dispersion C4G | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10G | 11G | 12G | 13G | 14G | 15G | 16G | 17G | 18G |
| Pigment dispersion K1G | | | | | | | | | |
| Pigment dispersion K2G | | | | | | | | | |
| Pigment dispersion K3G | 40 (5.2) | | | | | | | | |
| Pigment dispersion K4G | | | | | 40 (5.2) | | | | |
| Pigment dispersion K5G | | | | | | | | | 20 (4.0) |
| Pigment dispersion Y1G | | | | | | | | | |
| Pigment dispersion Y2G | | | | | | | | | |
| Pigment dispersion Y3G | | 40 (5.7) | | | | | | | |
| Pigment dispersion Y4G | | | | | | 40 (5.5) | | | |
| Pigment dispersion M1G | | | | | | | | | |
| Pigment dispersion M2G | | | | | | | | | |
| Pigment dispersion M3G | | | 40 (6.3) | | | | | | |
| Pigment dispersion M4G | | | | | | | 40 (6.3) | | |
| Pigment dispersion C1G | | | | | | | | | |
| Pigment dispersion C2G | | | | | | | | | |
| Pigment dispersion C3G | | | | 40 (3.6) | | | | | |
| Pigment dispersion C4G | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1H

### Pigment Dispersion K1H

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)).

To 98 parts of the dispersion obtained from and by the materials and method described above, 2 parts of lactamide, i.e., an amide compound, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1H (pigment-water-insoluble polymer solid concentration: 19.6 mass %) of this example.

### Example 2H

### Pigment Dispersion Y1H

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 parts of methyl carbamate, an amide compound serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain pigment dispersion Y1H (pigment-water-insoluble polymer solid concentration: 18.0 mass %) of this example.

### Example 3H

### Pigment Dispersion M1H

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of ethyl carbamate, i.e., an amide compound serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain a pigment dispersion M1H (pigment-water-insoluble polymer solid concentration: 19.0 mass %) of this example.

### Example 4H

### Pigment Dispersion C1H

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of propionamide, i.e., an amide compound serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain pigment dispersion C1H (pigment-water-insoluble polymer solid concentration: 18.0 mass %) of this example.

### Example 5H

### Pigment Dispersion K2H

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the dispersion obtained from and by the materials and method described above, 5 parts of nicotinamide, i.e., an amide compound, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2H (pigment-water-insoluble polymer solid concentration: 19.0 mass %) of this example.

### Example 6H

### Pigment Dispersion Y2H

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of 5-methyl-2-pyrrolidone, i.e., an amide compound serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2H (pigment-water-insoluble polymer solid concentration: 17.0 mass %) of this example.

### Example 7H

### Pigment Dispersion M2H

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads/to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of 5-hydroxymethyl-2-pyrrolidone, i.e., an amide compound serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain a pigment dispersion M2H (pigment-water-insoluble polymer solid concentration: 19.0 mass %) of this example.

### Example 8H

### Pigment Dispersion C2H

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of δ-valerolactam and 0.2 parts of pyroglutamic acid, i.e., amide compounds as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain pigment dispersion C2H (pigment-water-insoluble polymer solid concentration: 18.0 mass %) of this example.

### Comparative Example 1H

### Pigment Dispersion K3H

Pigment dispersion K3H of this comparative example having a pigment-water-insoluble polymer solid concentration of 19.6 mass % (pigment:water-insoluble polymer=10:5 (mass ratio)) was prepared from and by the same materials and method for pigment dispersion K1H (Example 1H) described above except that the heat treatment was not conducted.

### Comparative Example 2H

### Pigment Dispersion Y3H

Pigment dispersion Y3H of this comparative example having a pigment-water-insoluble polymer solid concentration of 18.4 mass % (pigment:water-insoluble polymer=10:3 (mass ratio)) was prepared from and by the same materials and method for pigment dispersion Y1H (Example 2H) described above except that, during the heat treatment, methyl carbamate, i.e., an amide compound serving as a wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3H

### Pigment Dispersion M3H

Pigment dispersion M3H of this reference example having a pigment-water-insoluble polymer solid concentration of 19.0 mass % (pigment:water-insoluble polymer=10:2 (mass ratio)) was prepared from and by the same materials and method for pigment dispersion M1H (Example 3H) described above except that, during the heat treatment, the heating temperature was changed to 120° C. and the heating time was changed to 30 minutes.

### Reference Example 4H

### Pigment Dispersion C3H

Pigment dispersion C3H of this reference example having a pigment-water-insoluble polymer solid concentration of 18.0 mass % (pigment:water-insoluble polymer=10:10 (mass ratio)) was prepared from and by the same materials and method for pigment dispersion C1H (Example 4H) described above except that, during the heat treatment, the heating temperature was changed to 60° C. and the heating time was changed to 100 hours.

### Reference Example 5H

### Pigment Dispersion K4H

Pigment dispersion K4H of this reference example having a pigment-water-insoluble polymer solid concentration of 19.6 mass % (pigment:water-insoluble polymer=10:5 (mass ratio)) was prepared from and by the same materials and method for pigment dispersion K1H (Example 1H) described above except that, during the heat treatment, the heating time was changed to 20 minutes.

### Reference Example 6H

### Pigment Dispersion Y4H

Pigment dispersion Y4H of this reference example having a pigment-water-insoluble polymer solid concentration of 18.0 mass % (pigment:water-insoluble polymer=10:3 (mass ratio)) was prepared from and by the same materials and method for pigment dispersion Y1H (Example 2H) described above except that, during the heat treatment, the heating time was changed to 120 hours.

### Comparative Example 7H

### Pigment Dispersion M4H

Pigment dispersion M4H of this comparative example having a pigment-water-insoluble polymer solid concentration of 19.4 mass % (pigment:water-insoluble polymer=10:2 (mass ratio)) was prepared from and by the same materials and method for pigment dispersion M1H (Example 3H) described above except that, during the heat treatment, 0.05 parts of ethyl carbamate, i.e., an amide compound serving as a wetting agent, and 4.9 parts of 1,2-hexanediol, i.e., a water-soluble organic solvent, were used.

### Comparative Example 8H

### Pigment Dispersion C4H

Pigment dispersion C4H of this comparative example having a pigment-water-insoluble polymer solid concentration of 16.0 mass % (pigment:water-insoluble polymer=10:10 (mass ratio)) was prepared from and by the same materials and method for pigment dispersion C1H (Example 4H) described above except that, during the heat treatment, 11 parts of propionamide, i.e., an amide compound serving as the wetting agent, and 80 parts of the dispersion were used.

### Comparative Example 9H

### Pigment Dispersion K5H

Twenty parts of MA 100 (trade name, product of Mitsubishi Chemical Corporation), i.e., carbon black serving as a pigment, 5 parts of nicotinamide, i.e., an amide compound, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5H of this comparative example having a pigment-water-insoluble polymer solid concentration of 23 mass % (pigment:water-insoluble polymer 10:1.5 (mass ratio)).

[Preparation of Water-Based Ink Composition H]

Water-based ink compositions of Examples 9H to 24H, Comparative Examples 10H, 11H, and 16H to 18H, and Reference Examples 12H to 15H were prepared from the pigment dispersions and polymer emulsions obtained from and by the materials and methods described above according to the compositions shown in Table 2H. Each water-based ink composition was prepared by stirring and mixing materials described in Table 2H in amounts described in the table at room temperature for 2 hours and filtering the resulting mixture with a membrane filter having 5 μm pores. In Table 2H, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2H

| | Examples | | | | | | | |
|---|---|---|---|---|---|---|---|---|
| Ink composition | 9H | 10H | 11H | 12H | 13H | 14H | 15H | 16H |
| Pigment dispersion K1H | 40 (5.2) | | | | | | | |
| Pigment dispersion K2H | | | | | 60 (6.8) | | | |
| Pigment dispersion K3H | | | | | | | | |
| Pigment dispersion K4H | | | | | | | | |
| Pigment dispersion K5H | | | | | | | | |
| Pigment dispersion Y1H | | 40 (5.5) | | | | | | |
| Pigment dispersion Y2H | | | | | | 50 (6.1) | | |
| Pigment dispersion Y3H | | | | | | | | |
| Pigment dispersion Y4H | | | | | | | | |
| Pigment dispersion M1H | | | 40 (6.3) | | | | | |
| Pigment dispersion M2H | | | | | | | 50 (6.3) | |
| Pigment dispersion M3H | | | | | | | | |
| Pigment dispersion M4H | | | | | | | | |
| Pigment dispersion C1H | | | | 40 (3.6) | | | | |
| Pigment dispersion C2H | | | | | | | | 40 (4.0) |
| Pigment dispersion C3H | | | | | | | | |
| Pigment dispersion C4H | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17H | 18H | 19H | 20H | 21H | 22H | 23H | 24H |
| Pigment dispersion K1H | 35 (4.6) | | | | | | | |
| Pigment dispersion K2H | | | | | 50 (5.7) | | | |
| Pigment dispersion K3H | | | | | | | | |
| Pigment dispersion K4H | | | | | | | | |
| Pigment dispersion K5H | | | | | | | | |
| Pigment dispersion Y1H | | 45 (6.2) | | | | | | |
| Pigment dispersion Y2H | | | | | | 45 (5.5) | | |
| Pigment dispersion Y3H | | | | | | | | |
| Pigment dispersion Y4H | | | | | | | | |
| Pigment dispersion M1H | | | 35 (5.5) | | | | | |
| Pigment dispersion M2H | | | | | | | 45 (5.7) | |
| Pigment dispersion M3H | | | | | | | | |
| Pigment dispersion M4H | | | | | | | | |
| Pigment dispersion C1H | | | | 45 (4.1) | | | | |
| Pigment dispersion C2H | | | | | | | | 50 (4.5) |
| Pigment dispersion C3H | | | | | | | | |
| Pigment dispersion C4H | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10H | 11H | 12H | 13H | 14H | 15H | 16H | 17H | 18H |
| Pigment dispersion K1H | | | | | | | | | |
| Pigment dispersion K2H | | | | | | | | | |
| Pigment dispersion K3H | 40 (5.2) | | | | | | | | |
| Pigment dispersion K4H | | | | | 40 (5.2) | | | | |
| Pigment dispersion K5H | | | | | | | | | 20 (4.0) |
| Pigment dispersion Y1H | | | | | | | | | |
| Pigment dispersion Y2H | | | | | | | | | |
| Pigment dispersion Y3H | | 40 (5.7) | | | | | | | |
| Pigment dispersion Y4H | | | | | | 40 (5.5) | | | |
| Pigment dispersion M1H | | | | | | | | | |
| Pigment dispersion M2H | | | | | | | | | |
| Pigment dispersion M3H | | | 40 (6.3) | | | | | | |
| Pigment dispersion M4H | | | | | | | 40 (6.3) | | |
| Pigment dispersion C1H | | | | | | | | | |
| Pigment dispersion C2H | | | | | | | | | |
| Pigment dispersion C3H | | | | 40 (3.6) | | | | | |
| Pigment dispersion C4H | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1I

### Pigment Dispersion K1I

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)).

To 98 parts of the dispersion obtained from and by the materials and method described above, 2 parts of imidazole, i.e., an imidazole derivative, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1I (pigment-water-insoluble polymer solid concentration: 19.6 mass %) of this example.

### Example 2I

### Pigment Dispersion Y1I

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 parts of N-methylimidazole, an imidazole derivative serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain pigment dispersion Y1I (pigment-water-insoluble polymer solid concentration: 18.0 mass %) of this example.

### Example 3I

### Pigment Dispersion M1I

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of 2-methylimidazole, i.e., an imidazole derivative serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain a pigment dispersion M1I (pigment-water-insoluble polymer solid concentration: 19.0 mass %) of this example.

### Example 4I

### Pigment Dispersion C1I

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of 2-hydroxyimidazole, an imidazole derivative serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain pigment dispersion C1I (pigment-water-insoluble polymer solid concentration: 18.0 mass %) of this example.

### Example 5I

### Pigment Dispersion K2I

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the dispersion obtained from and by the materials and method described above, 5 parts of 4-hydroxyimidazole, i.e., an imidazole derivative, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2I (pigment-water-insoluble polymer solid concentration: 19.0 mass %) of this example.

### Example 6I

### Pigment Dispersion Y2I

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of 2-ethylimidazole, i.e., an imidazole derivative serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2I (pigment-water-insoluble polymer solid concentration: 17.0 mass %) of this example.

### Example 7I

### Pigment Dispersion M2I

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of histamine i.e., an imidazole derivative serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain a pigment dispersion M2I (pigment-water-insoluble polymer solid concentration: 19.0 mass %) of this example.

### Example 8I

### Pigment Dispersion C2I

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of imidazole acetate and 0.2 parts of 4-methylimidazole, i.e., imidazole derivatives serving as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain pigment dispersion C2I (pigment-water-insoluble polymer solid concentration: 18.0 mass %) of this example.

### Comparative Example 1I

### Pigment Dispersion K3I

Pigment dispersion K3I of this comparative example having a pigment-water-insoluble polymer solid concentration of 19.6 mass % (pigment:water-insoluble polymer=10:5 (mass ratio)) was prepared from and by the same materials and method for pigment dispersion K1I (Example 1I) described above except that the heat treatment was not conducted.

### Comparative Example 2I

### Pigment Dispersion Y3I

Pigment dispersion Y3I of this comparative example having a pigment-water-insoluble polymer solid concentration of 18.4 mass % (pigment:water-insoluble polymer=10:3 (mass ratio)) was prepared from and by the same materials and method for pigment dispersion Y1I (Example 2I) described above except that, during the heat treatment, N-methylimidazole, i.e., an imidazole derivative serving as a wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3I

### Pigment Dispersion M3I

Pigment dispersion M3I of this reference example having a pigment-water-insoluble polymer solid concentration of 19.0 mass % (pigment:water-insoluble polymer=10:2 (mass ratio)) was prepared from and by the same materials and method for pigment dispersion M1I (Example 3I) described above except that, during the heat treatment, the heating temperature was changed to 120° C. and the heating time was changed to 30 minutes.

### Reference Example 4I

### Pigment Dispersion C3I

Pigment dispersion C3I of this reference example having a pigment-water-insoluble polymer solid concentration of 18.0 mass % (pigment:water-insoluble polymer=10:10 (mass ratio)) was prepared from and by the same materials and method for pigment dispersion C1I (Example 4I) described above except that, during the heat treatment, the heating temperature was changed to 60° C. and the heating time was changed to 100 hours.

### Reference Example 5I

### Pigment Dispersion K4I

Pigment dispersion K4I of this reference example having a pigment-water-insoluble polymer solid concentration of 19.6 mass % (pigment:water-insoluble polymer=10:5 (mass ratio)) was prepared from and by the same materials and method for pigment dispersion K1I (Example 1I) described above except that, during the heat treatment, the heating time was changed to 20 minutes.

### Reference Example 6I

### Pigment Dispersion Y4I

Pigment dispersion Y4I of this reference example having a pigment-water-insoluble polymer solid concentration of 18.0 mass % (pigment:water-insoluble polymer=10:3 (mass ratio)) was prepared from and by the same materials and method for pigment dispersion Y1I (Example 2I) described above except that, during the heat treatment, the heating time was changed to 120 hours.

### Comparative Example 7I

### Pigment Dispersion M4I

Pigment dispersion M4I of this comparative example having a pigment-water-insoluble polymer solid concentration of 19.4 mass % (pigment:water-insoluble polymer=10:2 (mass ratio)) was prepared from and by the same materials and method for pigment dispersion M1I (Example 3I) described above except that, during the heat treatment, 0.05 parts of 2-methylimidazole, i.e., an imidazole derivative serving as a wetting agent, and 1,2-hexanediol, i.e., a water-soluble organic solvent, were used.

### Comparative Example 8I

### Pigment Dispersion C4I

Pigment dispersion C4I of this comparative example having a pigment-water-insoluble polymer solid concentration of 16.0 mass % (pigment:water-insoluble polymer=10:10 (mass ratio)) was prepared from and by the same materials and method for pigment dispersion C1I (Example 4I) described above except that, during the heat treatment, 11 parts of 2-hydroxyimidazole, i.e., an imidazole derivative serving as a wetting agent, and 80 parts of the dispersion were used.

### Comparative Example 9I

### Pigment Dispersion K5I

Twenty parts of MA 100 (trade name, product of Mitsubishi Chemical Corporation), i.e., carbon black serving as a pigment, 5 parts of 4-hydroxyimidazole, i.e., an imidazole derivative, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5I of this comparative example having a pigment-water-insoluble polymer solid concentration of 23 mass % (pigment:water-insoluble polymer=10:1.5 (mass ratio)).

[Preparation of Water-Based Ink Composition I]

Water-based ink compositions of Examples 9I to 24I, Comparative Examples 10I, 11I, and 16I to 18I, and Reference Examples 12I to 15I were prepared from the pigment dispersions and polymer emulsions obtained from and by the materials and methods described above according to the compositions shown in Table 2I. Each water-based ink composition was prepared by stirring and mixing materials described in Table 2I in amounts described in the table at room temperature for 2 hours and filtering the resulting mixture with a membrane filter having 5 μm pores. In Table 2I, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2I

| | Examples | | | | | | | |
|---|---|---|---|---|---|---|---|---|
| Ink composition | 9I | 10I | 11I | 12I | 13I | 14I | 15I | 16I |
| Pigment dispersion K1I | 40 (5.2) | | | | | | | |
| Pigment dispersion K2I | | | | | 60 (6.8) | | | |
| Pigment dispersion K3I | | | | | | | | |
| Pigment dispersion K4I | | | | | | | | |
| Pigment dispersion K5I | | | | | | | | |
| Pigment dispersion Y1I | | 40 (5.5) | | | | | | |
| Pigment dispersion Y2I | | | | | | 50 (6.1) | | |
| Pigment dispersion Y3I | | | | | | | | |
| Pigment dispersion Y4I | | | | | | | | |
| Pigment dispersion M1I | | | 40 (6.3) | | | | | |
| Pigment dispersion M2I | | | | | | | 50 (6.3) | |
| Pigment dispersion M3I | | | | | | | | |
| Pigment dispersion M4I | | | | | | | | |
| Pigment dispersion C1I | | | | 40 (3.6) | | | | |
| Pigment dispersion C2I | | | | | | | | 40 (4.0) |
| Pigment dispersion C3I | | | | | | | | |
| Pigment dispersion C4I | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17I | 18I | 19I | 20I | 21I | 22I | 23I | 24I |
| Pigment dispersion K1I | 35 (4.6) | | | | | | | |
| Pigment dispersion K2I | | | | | 50 (5.7) | | | |
| Pigment dispersion K3I | | | | | | | | |
| Pigment dispersion K4I | | | | | | | | |
| Pigment dispersion K5I | | | | | | | | |
| Pigment dispersion Y1I | | 45 (6.2) | | | | | | |
| Pigment dispersion Y2I | | | | | | 45 (5.5) | | |
| Pigment dispersion Y3I | | | | | | | | |
| Pigment dispersion Y4I | | | | | | | | |
| Pigment dispersion M1I | | | 35 (5.5) | | | | | |
| Pigment dispersion M2I | | | | | | | 45 (5.7) | |
| Pigment dispersion M3I | | | | | | | | |
| Pigment dispersion M4I | | | | | | | | |
| Pigment dispersion C1I | | | | 45 (4.1) | | | | |
| Pigment dispersion C2I | | | | | | | | 50 (4.5) |
| Pigment dispersion C3I | | | | | | | | |
| Pigment dispersion C4I | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10I | 11I | 12I | 13I | 14I | 15I | 16I | 17I | 18I |
| Pigment dispersion K1I | | | | | | | | | |
| Pigment dispersion K2I | | | | | | | | | |
| Pigment dispersion K3I | 40 (5.2) | | | | | | | | |
| Pigment dispersion K4I | | | | | 40 (5.2) | | | | |
| Pigment dispersion K5I | | | | | | | | 20 (4.0) | |
| Pigment dispersion Y1I | | | | | | | | | |
| Pigment dispersion Y2I | | | | | | | | | |
| Pigment dispersion Y3I | | 40 (5.7) | | | | | | | |
| Pigment dispersion Y4I | | | | | | 40 (5.5) | | | |
| Pigment dispersion M1I | | | | | | | | | |
| Pigment dispersion M2I | | | | | | | | | |
| Pigment dispersion M3I | | | 40 (6.3) | | | | | | |
| Pigment dispersion M4I | | | | | | | 40 (6.3) | | |
| Pigment dispersion C1I | | | | | | | | | |
| Pigment dispersion C2I | | | | | | | | | |
| Pigment dispersion C3I | | | | 40 (3.6) | | | | | |
| Pigment dispersion C4I | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1J

### Pigment Dispersion K1J

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)).

To 98 parts of the dispersion obtained from and by the materials and method described above, 2 parts of pyrazine, i.e., an azine compound, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1J (pigment-water-insoluble polymer solid concentration: 19.6 mass %) of this example.

### Example 2J

### Pigment Dispersion Y1J

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 part of hexahydropyrazine, i.e., an azine compound serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain pigment dispersion Y1J (pigment-water-insoluble polymer solid concentration: 18.0 mass %) of this example.

### Example 3J

### Pigment Dispersion M1J

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of pyrazine-2,3-dicarboxylic acid, i.e., an azine compound serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain a pigment dispersion M1J (pigment-water-insoluble polymer solid concentration: 19.0 mass %) of this example.

### Example 4J

### Pigment Dispersion C1J

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of pyridazine, i.e., an azine compound serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain pigment dispersion C1J (pigment-water-insoluble polymer solid concentration: 18.0 mass %) of this example.

### Example 5J

### Pigment Dispersion K2J

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the dispersion obtained from and by the materials and method described above, 5 parts of 4-pyridazine carboxylic acid, i.e., an azine compound, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2J (pigment-water-insoluble polymer solid concentration: 19.0 mass %) of this example.

### Example 6J

### Pigment Dispersion Y2J

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of cytosine, i.e., an azine compound serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2J (pigment-water-insoluble polymer solid concentration: 17.0 mass %) of this example.

### Example 7J

### Pigment Dispersion M2J

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of cytosine-5-carboxylic acid, i.e., an azine compound serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain a pigment dispersion M2J (pigment-water-insoluble polymer solid concentration: 19.0 mass %) of this example.

### Example 8J

### Pigment Dispersion C2J

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of triazine and 0.2 parts of cyanuric acid, i.e., azine compounds as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain pigment dispersion C2J (pigment-water-insoluble polymer solid concentration: 18.0 mass %) of this example.

### Comparative Example 1J

### Pigment Dispersion K3J

Pigment dispersion K3J of this comparative example having a pigment-water-insoluble polymer solid concentration of 19.6 mass % (pigment:water-insoluble polymer=10:5 (mass ratio)) was prepared from and by the same materials and method for pigment dispersion K1J (Example 1J) described above except that the heat treatment was not conducted.

### Comparative Example 2J

### Pigment Dispersion Y3J

Pigment dispersion Y3J of this comparative example having a pigment-water-insoluble polymer solid concentration of 18.4 mass % (pigment:water-insoluble polymer=10:3 (mass ratio)) was prepared from and by the same materials and method for pigment dispersion Y1J (Example 2J) described above except that, during the heat treatment, hexahydropyrazine, i.e., the azine compound serving as the wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3J

### Pigment Dispersion M3J

Pigment dispersion M3J of this reference example having a pigment-water-insoluble polymer solid concentration of 19.0 mass % (pigment:water-insoluble polymer=10:2 (mass ratio)) was prepared from and by the same materials and method for pigment dispersion M1J (Example 3J) described above except that, during the heat treatment, the heating temperature was changed to 120° C. and the heating time was changed to 30 minutes.

### Reference Example 4J

### Pigment Dispersion C3J

Pigment dispersion C3J of this reference example having a pigment-water-insoluble polymer solid concentration of 18.0 mass % (pigment:water-insoluble polymer=10:10 (mass ratio)) was prepared from and by the same materials and method for pigment dispersion C1J (Example 4J) described above except that, during the heat treatment, the heating temperature was changed to 60° C. and the heating time was changed to 100 hours.

### Reference Example 5J

### Pigment Dispersion K4J

Pigment dispersion K4J of this reference example having a pigment-water-insoluble polymer solid concentration of 19.6 mass % (pigment:water-insoluble polymer=10:5 (mass ratio)) was prepared from and by the same materials and method for pigment dispersion K1J (Example 1J) described above except that, during the heat treatment, the heating time was changed to 20 minutes.

### Reference Example 6J

### Pigment Dispersion Y4J

Pigment dispersion Y4J of this reference example having a pigment-water-insoluble polymer solid concentration of 18.0 mass % (pigment:water-insoluble polymer=10:3 (mass ratio)) was prepared from and by the same materials and method for pigment dispersion Y1J (Example 2J) described above except that, during the heat treatment, the heating time was changed to 120 hours.

### Comparative Example 7J

### Pigment Dispersion M4J

Pigment dispersion M4J of this comparative example having a pigment-water-insoluble polymer solid concentration of 19.4 mass % (pigment:water-insoluble polymer=10:2 (mass ratio)) was prepared from and by the same materials and method for pigment dispersion M1J (Example 3J) described above except that, during the heat treatment, 0.05 parts of pyrazine-2,3-dicarboxylic acid, i.e., an azine compound serving as a wetting agent, and 4.9 parts of 1,2-hexanediol, i.e., a water-soluble organic solvent, were used.

### Comparative Example 8J

### Pigment Dispersion C4J

Pigment dispersion C4J of this comparative example having a pigment-water-insoluble polymer solid concentration of 16.0 mass % (pigment:water-insoluble polymer=10:10 (mass ratio)) was prepared from and by the same materials and method for pigment dispersion C1J (Example 4J) described above except that, during the heat treatment, 11 parts of pyridazine, i.e., an azine compound serving as the wetting agent, and 80 parts of the dispersion were used.

### Comparative Example 9J

### Pigment Dispersion K5J

Twenty parts of MA 100 (trade name, product of Mitsubishi Chemical Corporation), i.e., carbon black serving as a pigment, 5 parts of 4-pyridazine carboxylic acid, i.e., an azine compound, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5J of this comparative example having a pigment-water-insoluble polymer solid concentration of 23 mass % (pigment:water-insoluble polymer=10:1.5 (mass ratio)).

[Preparation of Water-Based Ink Composition J]

Water-based ink compositions of Examples 9J to 24J, comparative Examples 10J, 11J, and 16J to 18J, and Reference Examples 12J to 15J were prepared from the pigment dispersions and polymer emulsions obtained from and by the materials and methods described above according to the compositions shown in Table 2J. Each water-based ink composition was prepared by stirring and mixing materials described in Table 2J in amounts described in the table at room temperature for 2 hours and filtering the resulting mixture with a membrane filter having 5 μm pores. In Table 2j, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2J

| | Examples | | | | | | | |
|---|---|---|---|---|---|---|---|---|
| Ink composition | 9J | 10J | 11J | 12J | 13J | 14J | 15J | 16J |
| Pigment dispersion K1J | 40 (5.2) | | | | | | | |
| Pigment dispersion K2J | | | | | 60 (6.8) | | | |
| Pigment dispersion K3J | | | | | | | | |
| Pigment dispersion K4J | | | | | | | | |
| Pigment dispersion K5J | | | | | | | | |
| Pigment dispersion Y1J | | 40 (5.5) | | | | | | |
| Pigment dispersion Y2J | | | | | | 50 (6.1) | | |
| Pigment dispersion Y3J | | | | | | | | |
| Pigment dispersion Y4J | | | | | | | | |
| Pigment dispersion M1J | | | 40 (6.3) | | | | | |
| Pigment dispersion M2J | | | | | | | 50 (6.3) | |
| Pigment dispersion M3J | | | | | | | | |
| Pigment dispersion M4J | | | | | | | | |
| Pigment dispersion C1J | | | | 40 (3.6) | | | | |
| Pigment dispersion C2J | | | | | | | | 40 (4.0) |
| Pigment dispersion C3J | | | | | | | | |
| Pigment dispersion C4J | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17J | 18J | 19J | 20J | 21J | 22J | 23J | 24J |
| Pigment dispersion K1J | 35 (4.6) | | | | | | | |
| Pigment dispersion K2J | | | | | 50 (5.7) | | | |
| Pigment dispersion K3J | | | | | | | | |
| Pigment dispersion K4J | | | | | | | | |
| Pigment dispersion K5J | | | | | | | | |
| Pigment dispersion Y1J | | 45 (6.2) | | | | | | |
| Pigment dispersion Y2J | | | | | | 45 (5.5) | | |
| Pigment dispersion Y3J | | | | | | | | |
| Pigment dispersion Y4J | | | | | | | | |
| Pigment dispersion M1J | | | 35 (5.5) | | | | | |
| Pigment dispersion M2J | | | | | | | 45 (5.7) | |
| Pigment dispersion M3J | | | | | | | | |
| Pigment dispersion M4J | | | | | | | | |
| Pigment dispersion C1J | | | | 45 (4.1) | | | | |
| Pigment dispersion C2J | | | | | | | | 50 (4.5) |
| Pigment dispersion C3J | | | | | | | | |
| Pigment dispersion C4J | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10J | 11J | 12J | 13J | 14J | 15J | 16J | 17J | 18J |
| Pigment dispersion K1J | | | | | | | | | |
| Pigment dispersion K2J | | | | | | | | | |
| Pigment dispersion K3J | 40 (5.2) | | | | | | | | |
| Pigment dispersion K4J | | | | | 40 (5.2) | | | | |
| Pigment dispersion K5J | | | | | | | | | 20 (4.0) |
| Pigment dispersion Y1J | | | | | | | | | |
| Pigment dispersion Y2J | | | | | | | | | |
| Pigment dispersion Y3J | | 40 (5.7) | | | | | | | |
| Pigment dispersion Y4J | | | | | | 40 (5.5) | | | |
| Pigment dispersion M1J | | | | | | | | | |
| Pigment dispersion M2J | | | | | | | | | |
| Pigment dispersion M3J | | | 40 (6.3) | | | | | | |
| Pigment dispersion M4J | | | | | | | 40 (6.3) | | |
| Pigment dispersion C1J | | | | | | | | | |
| Pigment dispersion C2J | | | | | | | | | |
| Pigment dispersion C3J | | | | 40 (3.6) | | | | | |
| Pigment dispersion C4J | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1K

### Pigment Dispersion K1K

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)).

To 98 parts of the dispersion obtained from and by the materials and method described above, 2 parts of 1,2,3-triazole, i.e., an azole compound, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1K (pigment-water-insoluble polymer solid concentration: 19.6 mass %) of this example.

### Example 2K

### Pigment Dispersion Y1K

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 part of 1,2,4-triazole, i.e., an azole compound serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain pigment dispersion Y1K (pigment-water-insoluble polymer solid concentration: 18.0 mass %) of this example.

### Example 3K

### Pigment Dispersion M1K

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of 1H-benzotriazole-1-methanol, i.e., an azole compound serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain a pigment dispersion M1K (pigment-water-insoluble polymer solid concentration: 19.0 mass %) of this example.

### Example 4K

### Pigment Dispersion C1K

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of pyrazole, i.e., an azole compound serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain pigment dispersion C1K (pigment-water-insoluble polymer solid concentration: 18.0 mass %) of this example.

### Example 5K

### Pigment Dispersion K2K

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the dispersion obtained from and by the materials and method described above, 5 parts of tetrazole, i.e., an azole compound, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2K (pigment-water-insoluble polymer solid concentration: 19.0 mass %) of this example.

### Example 6K

### Pigment Dispersion Y2K

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of thiazole, i.e., an azole compound serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2K (pigment-water-insoluble polymer solid concentration: 17.0 mass %) of this example.

### Example 7K

### Pigment Dispersion M2K

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of 1,2,3-triazole, i.e., an azole compound serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain a pigment dispersion M2K (pigment-water-insoluble polymer solid concentration: 19.0 mass %) of this example.

### Example 8K

### Pigment Dispersion C2K

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of oxazole and 0.2 parts of 2-aminothiazole, i.e., azole compounds serving as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain pigment dispersion C2K (pigment-water-insoluble polymer solid concentration: 18.0 mass %) of this example.

### Comparative Example 1K

### Pigment Dispersion K3K

Pigment dispersion K3K of this comparative example having a pigment-water-insoluble polymer solid concentration of 19.6 mass % (pigment:water-insoluble polymer=10:5 (mass ratio)) was prepared from and by the same materials and method for pigment dispersion K1K (Example 1K) described above except that the heat treatment was not conducted.

### Comparative Example 2K

### Pigment Dispersion Y3K

Pigment dispersion Y3K of this comparative example having a pigment-water-insoluble polymer solid concentration of 18.4 mass % (pigment:water-insoluble polymer=10:3 (mass ratio)) was prepared from and by the same materials and method for pigment dispersion Y1K (Example 2K) described above except that, during the heat treatment, 1,2,4-triazole, i.e., the azole compound serving as the wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3K

### Pigment Dispersion M3K

Pigment dispersion M3K of this reference example having a pigment-water-insoluble polymer solid concentration of 19.0 mass % (pigment:water-insoluble polymer=10:2 (mass ratio)) was prepared from and by the same materials and method for pigment dispersion M1K (Example 3K) described above except that, during the heat treatment, the heating temperature was changed to 120° C. and the heating time was changed to 30 minutes.

### Reference Example 4K

### Pigment Dispersion C3K

Pigment dispersion C3K of this reference example having a pigment-water-insoluble polymer solid concentration of 18.0 mass % (pigment:water-insoluble polymer=10:10 (mass ratio)) was prepared from and by the same materials and method for pigment dispersion C1K (Example 4K) described above except that, during the heat treatment, the heating temperature was changed to 60° C. and the heating time was changed to 100 hours.

### Reference Example 5K

### Pigment Dispersion K4K

Pigment dispersion K4K of this reference example having a pigment-water-insoluble polymer solid concentration of 19.6 mass % (pigment:water-insoluble polymer=10:5 (mass ratio)) was prepared from and by the same materials and method for pigment dispersion K1K (Example 1K) described above except that, during the heat treatment, the heating time was changed to 20 minutes.

### Reference Example 6K

### Pigment Dispersion Y4K

Pigment dispersion Y4K of this reference example having a pigment-water-insoluble polymer solid concentration of 18.0 mass % (pigment:water-insoluble polymer=10:3 (mass ratio)) was prepared from and by the same materials and method for pigment dispersion Y1K (Example 2K) described above except that, during the heat treatment, the heating time was changed to 120 hours.

### Comparative Example 7K

### Pigment Dispersion M4K

Pigment dispersion M4K of this comparative example having a pigment-water-insoluble polymer solid concentration of 19.4 mass % (pigment:water-insoluble polymer=10:2 (mass ratio)) was prepared from and by the same materials and method for pigment dispersion M1K (Example 3K) described above except that, during the heat treatment, 0.05 parts of 1H-benzotriazole-1-methanol, i.e., an azole compound serving as a wetting agent, and 4.9 parts of 1,2-hexanediol, i.e., a water-soluble organic solvent, were used.

### Comparative Example 8K

### Pigment Dispersion C4K

Pigment dispersion C4K of this comparative example having a pigment-water-insoluble polymer solid concentration of 16.0 mass % (pigment:water-insoluble polymer=10:10 (mass ratio)) was prepared from and by the same materials and method for pigment dispersion C1K (Example 4K) described above except that, during the heat treatment, 11 parts of pyrazole, i.e., an azole compound serving as the wetting agent, and 80 parts of the dispersion were used.

### Comparative Example 9K

### Pigment Dispersion K5K

Twenty parts of MA 100 (trade name, product of Mitsubishi Chemical Corporation), i.e., carbon black serving as a pigment, 5 parts of tetrazole, i.e., an azole compound, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5K of this comparative example having a pigment-water-insoluble polymer solid concentration of 23 mass % (pigment:water-insoluble polymer=10:1.5 (mass ratio)).

[Preparation of Water-Based Ink Composition K]

Water-based ink compositions of Examples 9K to 24K, comparative Examples 10K, 11K, and 16K to 18K, and Reference Examples 12K to 15K were prepared from the pigment dispersions and polymer emulsions obtained from and by the materials and methods described above according to the compositions shown in Table 2K. Each water-based ink composition was prepared by stirring and mixing materials described in Table 2K in amounts described in the table at room temperature for 2 hours and filtering the resulting mixture with a membrane filter having 5 μm pores. In Table 2K, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2K

| | Examples | | | | | | | |
|---|---|---|---|---|---|---|---|---|
| Ink composition | 9K | 10K | 11K | 12K | 13K | 14K | 15K | 16K |
| Pigment dispersion K1K | 40 (5.2) | | | | | | | |
| Pigment dispersion K2K | | | | | 60 (6.8) | | | |
| Pigment dispersion K3K | | | | | | | | |
| Pigment dispersion K4K | | | | | | | | |
| Pigment dispersion K5K | | | | | | | | |
| Pigment dispersion Y1K | | 40 (5.5) | | | | | | |
| Pigment dispersion Y2K | | | | | | 50 (6.1) | | |
| Pigment dispersion Y3K | | | | | | | | |
| Pigment dispersion Y4K | | | | | | | | |
| Pigment dispersion M1K | | | 40 (6.3) | | | | | |
| Pigment dispersion M2K | | | | | | | 50 (6.3) | |
| Pigment dispersion M3K | | | | | | | | |
| Pigment dispersion M4K | | | | | | | | |
| Pigment dispersion C1K | | | | 40 (3.6) | | | | |
| Pigment dispersion C2K | | | | | | | | 40 (4.0) |
| Pigment dispersion C3K | | | | | | | | |
| Pigment dispersion C4K | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17K | 18K | 19K | 20K | 21K | 22K | 23K | 24K |
| Pigment dispersion K1K | 35 (4.6) | | | | | | | |
| Pigment dispersion K2K | | | | | 50 (5.7) | | | |
| Pigment dispersion K3K | | | | | | | | |
| Pigment dispersion K4K | | | | | | | | |
| Pigment dispersion K5K | | | | | | | | |
| Pigment dispersion Y1K | | 45 (6.2) | | | | | | |
| Pigment dispersion Y2K | | | | | | 45 (5.5) | | |
| Pigment dispersion Y3K | | | | | | | | |
| Pigment dispersion Y4K | | | | | | | | |
| Pigment dispersion M1K | | | 35 (5.5) | | | | | |
| Pigment dispersion M2K | | | | | | | 45 (5.7) | |
| Pigment dispersion M3K | | | | | | | | |
| Pigment dispersion M4K | | | | | | | | |
| Pigment dispersion C1K | | | | 45 (4.1) | | | | |
| Pigment dispersion C2K | | | | | | | | 50 (4.5) |
| Pigment dispersion C3K | | | | | | | | |
| Pigment dispersion C4K | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10K | 11K | 12K | 13K | 14K | 15K | 16K | 17K | 18K |
| Pigment dispersion K1K | | | | | | | | | |
| Pigment dispersion K2K | | | | | | | | | |
| Pigment dispersion K3K | 40 (5.2) | | | | | | | | |
| Pigment dispersion K4K | | | | | 40 (5.2) | | | | |
| Pigment dispersion K5K | | | | | | | | | 20 (4.0) |
| Pigment dispersion Y1K | | | | | | | | | |
| Pigment dispersion Y2K | | | | | | | | | |
| Pigment dispersion Y3K | | 40 (5.7) | | | | | | | |
| Pigment dispersion Y4K | | | | | | 40 (5.5) | | | |
| Pigment dispersion M1K | | | | | | | | | |
| Pigment dispersion M2K | | | | | | | | | |
| Pigment dispersion M3K | | | 40 (6.3) | | | | | | |
| Pigment dispersion M4K | | | | | | | 40 (6.3) | | |
| Pigment dispersion C1K | | | | | | | | | |
| Pigment dispersion C2K | | | | | | | | | |
| Pigment dispersion C3K | | | | 40 (3.6) | | | | | |
| Pigment dispersion C4K | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1L

### Pigment Dispersion K1L

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5-(mass ratio)).

To 98 parts of the dispersion obtained from and by the materials and method described above, 2 parts of guanidine, i.e., an amidine derivative, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1L (pigment-water-insoluble polymer solid concentration: 19.6 mass %) of this example.

### Example 2L

### Pigment Dispersion Y1L

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 parts of 1-methyl-3-nitro-1-nitrosoguanidine, an amidine derivative serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain pigment dispersion Y1L (pigment-water-insoluble polymer solid concentration: 18.0 mass %) of this example.

### Example 3L

### Pigment Dispersion M1L

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of 1-amyl-3-nitro-1-nitrosoguanidine, i.e., an amidine derivative serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain a pigment dispersion M1L (pigment-water-insoluble polymer solid concentration: 19.0 mass %) of this example.

### Example 4L

### Pigment Dispersion C1L

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of nitroguanidine, i.e., an amidine derivative serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain pigment dispersion C1L (pigment-water-insoluble polymer solid concentration: 18.0 mass %) of this example.

### Example 5L

### Pigment Dispersion K2L

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the pigment dispersion obtained from and by the materials and method described above, 5 parts of sulfaguanidine, i.e., an amidine derivative, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2L (pigment-water-insoluble polymer solid concentration: 19.0 mass %) of this example.

### Example 6L

### Pigment Dispersion Y2L

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of guanidinoacetic acid, i.e., an amidine derivative serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2L (pigment-water-insoluble polymer solid concentration: 17.0 mass %) of this example.

### Example 7L

### Pigment Dispersion M2L

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of aminoguanidine, i.e., an amidine derivative serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain a pigment dispersion M2L (pigment-water-insoluble polymer solid concentration: 19.0 mass %) of this example.

### Example 8L

### Pigment Dispersion C2L

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of canavanine and 0.2 parts of arginine, i.e., amidine derivatives serving as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain pigment dispersion C2L (pigment-water-insoluble polymer solid concentration: 18.0 mass %) of this example.

### Comparative Example 1L

### Pigment Dispersion K3L

Pigment dispersion K3L of this comparative example having a pigment-water-insoluble polymer solid concentration of 19.6 mass % (pigment:water-insoluble polymer=10:5 (mass ratio)) was prepared from and by the same materials and method for pigment dispersion K1L (Example 1L) described above except that the heat treatment was not conducted.

### Comparative Example 2L

### Pigment Dispersion Y3L

Pigment dispersion Y3L of this comparative example having a pigment-water-insoluble polymer solid concentration of 18.4 mass % (pigment:water-insoluble polymer=10:1 (mass ratio)) was prepared from and by the same materials and method for pigment dispersion Y1L (Example 2L) described above except that, during the heat treatment, 1-methyl-3-nitro-1-nitrosoguanidine, i.e., an amidine derivative serving as a wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3L

### Pigment Dispersion M3L

Pigment dispersion M3L of this reference example having a pigment-water-insoluble polymer solid concentration of 19.0 mass % (pigment:water-insoluble polymer=10:2 (mass ratio)) was prepared from and by the same materials and method for pigment dispersion M1L (Example 3L) described above except that, during the heat treatment, the heating temperature was changed to 120° C. and the heating time was changed to 30 minutes.

### Reference Example 4L

### Pigment Dispersion C3L

Pigment dispersion C3L of this reference example having a pigment-water-insoluble polymer solid concentration of 18.0 mass % (pigment:water-insoluble polymer=10:10 (mass ratio)) was prepared from and by the same materials and method for pigment dispersion C1L (Example 4L) described above except that, during the heat treatment, the heating temperature was changed to 60° C. and the heating time was changed to 100 hours.

### Reference Example 5L

### Pigment Dispersion K4L

Pigment dispersion K4L of this reference example having a pigment-water-insoluble polymer solid concentration of 19.6 mass % (pigment:water-insoluble polymer=10:5 (mass ratio)) was prepared from and by the same materials and method for pigment dispersion K1L (Example 1L) described above except that, during the heat treatment, the heating time was changed to 20 minutes.

### Reference Example 6L

### Pigment Dispersion Y4L

Pigment dispersion Y4L of this reference example having a pigment-water-insoluble polymer solid concentration of 18.0 mass % (pigment:water-insoluble polymer=10:3 (mass ratio)) was prepared from and by the same materials and method for pigment dispersion Y1L (Example 2L) described above except that, during the heat treatment, the heating time was changed to 120 hours.

### Comparative Example 7L

### Pigment Dispersion M4L

Pigment dispersion M4L of this comparative example having a pigment-water-insoluble polymer solid concentration of 19.4 mass % (pigment:water-insoluble polymer=10:2 (mass ratio)) was prepared from and by the same materials and method for pigment dispersion M1L (Example 3L) described above except that, during the heat treatment, 0.05 parts of 1-amyl-3-nitro-1-nitrosoguanidine, i.e., an amidine derivative serving as a wetting agent, and 4.9 parts of 1,2-hexanediol, i.e., a water-soluble organic solvent, were used.

### Comparative Example 8L

### Pigment Dispersion C4L

Pigment dispersion C4L of this comparative example having a pigment-water-insoluble polymer solid concentration of 16.0 mass % (pigment:water-insoluble polymer=10:10 (mass ratio)) was prepared from and by the same materials and method for pigment dispersion C1L (Example 4L) described above except that, during the heat treatment, 11 parts of nitroguanidine, i.e., an amidine derivative serving as the wetting agent, and 80 parts of the dispersion were used.

### Comparative Example 9L

### Pigment Dispersion K5L

Twenty parts of MA 100 (trade name, product of Mitsubishi Chemical Corporation), i.e., carbon black serving as a pigment, 5 parts of sulfaguanidine, i.e., an amidine derivative, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5L of this comparative example having a pigment-water-insoluble polymer solid concentration of 23 mass % (pigment:water-insoluble polymer=10:1.5 (mass ratio)).

[Preparation of Water-Based Ink Composition L]

Water-based ink compositions of Examples 9L to 24L, Comparative Examples 10L, 11L, and 16L to 18L, and Reference Examples 12L to 15L were prepared from the pigment dispersions and polymer emulsions obtained from and by the materials and methods described above according to the compositions shown in Table 2L. Each water-based ink composition was prepared by stirring and mixing materials described in Table 2L in amounts described in the table at room temperature for 2 hours and filtering the resulting mixture with a membrane filter having 5 μm pores. In Table 2L, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2L

| | Examples | | | | | | | |
|---|---|---|---|---|---|---|---|---|
| Ink composition | 9L | 10L | 11L | 12L | 13L | 14L | 15L | 16L |
| Pigment dispersion K1L | 40 (5.2) | | | | | | | |
| Pigment dispersion K2L | | | | | 60 (6.8) | | | |
| Pigment dispersion K3L | | | | | | | | |
| Pigment dispersion K4L | | | | | | | | |
| Pigment dispersion K5L | | | | | | | | |
| Pigment dispersion Y1L | | 40 (5.5) | | | | | | |
| Pigment dispersion Y2L | | | | | | 50 (6.1) | | |
| Pigment dispersion Y3L | | | | | | | | |
| Pigment dispersion Y4L | | | | | | | | |
| Pigment dispersion M1L | | | 40 (6.3) | | | | | |
| Pigment dispersion M2L | | | | | | | 50 (6.3) | |
| Pigment dispersion M3L | | | | | | | | |
| Pigment dispersion M4L | | | | | | | | |
| Pigment dispersion C1L | | | | 40 (3.6) | | | | |
| Pigment dispersion C2L | | | | | | | | 40 (4.0) |
| Pigment dispersion C3L | | | | | | | | |
| Pigment dispersion C4L | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17L | 18L | 19L | 20L | 21L | 22L | 23L | 24L |
| Pigment dispersion K1L | 35 (4.6) | | | | | | | |
| Pigment dispersion K2L | | | | | 50 (5.7) | | | |
| Pigment dispersion K3L | | | | | | | | |
| Pigment dispersion K4L | | | | | | | | |
| Pigment dispersion K5L | | | | | | | | |
| Pigment dispersion Y1L | | 45 (6.2) | | | | | | |
| Pigment dispersion Y2L | | | | | | 45 (5.5) | | |
| Pigment dispersion Y3L | | | | | | | | |
| Pigment dispersion Y4L | | | | | | | | |
| Pigment dispersion M1L | | | 35 (5.5) | | | | | |
| Pigment dispersion M2L | | | | | | | 45 (5.7) | |
| Pigment dispersion M3L | | | | | | | | |
| Pigment dispersion M4L | | | | | | | | |
| Pigment dispersion C1L | | | | 45 (4.1) | | | | |
| Pigment dispersion C2L | | | | | | | | 50 (4.5) |
| Pigment dispersion C3L | | | | | | | | |
| Pigment dispersion C4L | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10L | 11L | 12L | 13L | 14L | 15L | 16L | 17L | 18L |
| Pigment dispersion K1L | | | | | | | | | |
| Pigment dispersion K2L | | | | | | | | | |
| Pigment dispersion K3L | 40 (5.2) | | | | | | | | |
| Pigment dispersion K4L | | | | | 40 (5.2) | | | | |
| Pigment dispersion K5L | | | | | | | | | 20 (4.0) |
| Pigment dispersion Y1L | | | | | | | | | |
| Pigment dispersion Y2L | | | | | | | | | |
| Pigment dispersion Y3L | | 40 (5.7) | | | | | | | |
| Pigment dispersion Y4L | | | | | | 40 (5.5) | | | |
| Pigment dispersion M1L | | | | | | | | | |
| Pigment dispersion M2L | | | | | | | | | |
| Pigment dispersion M3L | | | 40 (6.3) | | | | | | |
| Pigment dispersion M4L | | | | | | | 40 (6.3) | | |
| Pigment dispersion C1L | | | | | | | | | |
| Pigment dispersion C2L | | | | | | | | | |
| Pigment dispersion C3L | | | | 40 (3.6) | | | | | |
| Pigment dispersion C4L | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1M

### Pigment Dispersion K1M

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)).

To 98 parts of the dispersion obtained from and by the materials and method described above, 2 parts of 2-pyridinol, i.e., a hydroxypyridine derivative, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1M (pigment-water-insoluble polymer solid concentration: 19.6 mass %) of this example.

### Example 2M

### Pigment Dispersion Y1M

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 parts of 3-methyl-2-pyridinol, i.e., a hydroxypyridine derivative serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain pigment dispersion Y1M (pigment-water-insoluble polymer solid concentration: 18.0 mass %) of this example.

### Example 3M

### Pigment Dispersion M1M

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of 6-methyl-2-pyridinol, i.e., a hydroxypyridine derivative serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain a pigment dispersion M1M (pigment-water-insoluble polymer solid concentration: 19.0 mass %) of this example.

### Example 4M

### Pigment Dispersion C1M

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of 2-pyridinemethanol, i.e., a hydroxypyridine derivative serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain pigment dispersion C1M (pigment-water-insoluble polymer solid concentration: 18.0 mass %) of this example.

### Example 5M

### Pigment Dispersion K2M

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the dispersion obtained from and by the materials and method described above, 5 parts of 2-pyridine ethanol, i.e., a hydroxypyridine derivative, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2M (pigment-water-insoluble polymer solid concentration: 19.0 mass %) of this example.

### Example 6M

### Pigment Dispersion Y2M

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio))

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of 4-pyridine ethanol, i.e., a hydroxypyridine derivative serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2M (pigment-water-insoluble polymer solid concentration: 17.0 mass %) of this example.

### Example 7M

### Pigment Dispersion M2M

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of 3-pyridine propanol, i.e., a hydroxypyridine derivative serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain a pigment dispersion M2M (pigment-water-insoluble polymer solid concentration: 19.0 mass %) of this example.

### Example 8M

### Pigment Dispersion C2M

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of α-methyl-2-pyridinemethanol and 0.2 parts of 2,3-pyridinediol, i.e., hydroxypyridine derivatives serving as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain pigment dispersion C2M (pigment-water-insoluble polymer solid concentration: 18.0 mass %) of this example.

### Comparative Example 1M

### Pigment Dispersion K3M

Pigment dispersion K3M of this comparative example having a pigment-water-insoluble polymer solid concentration of 19.6 mass % (pigment:water-insoluble polymer=10:5 (mass ratio)) was prepared from and by the same materials and method for pigment dispersion K1M (Example 1M) described above except that the heat treatment was not conducted.

### Comparative Example 2M

### Pigment Dispersion Y3M

Pigment dispersion Y3M of this comparative example having a pigment-water-insoluble polymer solid concentration of 18.4 mass % (pigment:water-insoluble polymer=10:3 (mass ratio)) was prepared from and by the same materials and method for pigment dispersion Y1M (Example 2M) described above except that, during the heat treatment, 3-methyl-2-pyridinol, i.e., a hydroxypyridine derivative serving as a wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3M

### Pigment Dispersion M3M

Pigment dispersion M3M of this reference example having a pigment-water-insoluble polymer solid concentration of 19.0 mass % (pigment:water-insoluble polymer=10:2 (mass ratio)) was prepared from and by the same materials and method for pigment dispersion M1M (Example 3M) described above except that, during the heat treatment, the heating temperature was changed to 120° C. and the heating time was changed to 30 minutes.

### Reference Example 4M

### Pigment Dispersion C3M

Pigment dispersion C3M of this reference example having a pigment-water-insoluble polymer solid concentration of 18.0 mass % (pigment:water-insoluble polymer=10:10 (mass ratio)) was prepared from and by the same materials and method for pigment dispersion C1M (Example 4M) described above except that, during the heat treatment, the heating temperature was changed to 60° C. and the heating time was changed to 100 hours.

### Reference Example 5M

### Pigment Dispersion K4M

Pigment dispersion K4M of this reference example having a pigment-water-insoluble polymer solid concentration of 19.6 mass % (pigment:water-insoluble polymer=10:5 (mass ratio)) was prepared from and by the same materials and method for pigment dispersion K1M (Example 1M) described above except that, during the heat treatment, the heating time was changed to 20 minutes.

### Reference Example 6M

### Pigment Dispersion Y4M

Pigment dispersion Y4M of this reference example having a pigment-water-insoluble polymer solid concentration of 18.0 mass % (pigment:water-insoluble polymer=10:3 (mass ratio)) was prepared from and by the same materials and method for pigment dispersion Y1M (Example 2M) described above except that, during the heat treatment, the heating time was changed to 120 hours.

### Comparative Example 7M

### Pigment Dispersion M4M

Pigment dispersion M4M of this comparative example having a pigment-water-insoluble polymer solid concentration of 19.4 mass % (pigment:water-insoluble polymer=10:2 (mass ratio)) was prepared from and by the same materials and method for pigment dispersion M1M (Example 3M) described above except that, during the heat treatment, 0.05 parts of 6-methyl-2-pyridinol, i.e., a hydroxypyridine derivative serving as a wetting agent, and 4.9 parts of 1,2-hexanediol, i.e., a water-soluble organic solvent, were used.

### Comparative Example 8M

### Pigment Dispersion C4M

Pigment dispersion C4M of this comparative example having a pigment-water-insoluble polymer solid concentration of 16.0 mass % (pigment:water-insoluble polymer=10:10 (mass ratio)) was prepared from and by the same materials and method for pigment dispersion C1M (Example 4M) described above except that, during the heat treatment, 11 parts of 2-pyridine methanol, i.e., a hydroxypyridine derivative serving as a wetting agent, and 80 parts of the dispersion were used.

### Comparative Example 9M

### Pigment Dispersion K5M

Twenty parts of MA 100 (trade name, product of Mitsubishi Chemical Corporation), i.e., carbon black serving as a pigment, 5 parts of 2-pyridine ethanol, i.e., a hydroxypyridine derivative, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5M of this comparative example having a pigment-water-insoluble polymer solid concentration of 23 mass % (pigment:water-insoluble polymer=10:1.5 (mass ratio)).

[Preparation of Water-Based Ink Composition M]

Water-based ink compositions of Examples 9M to 24M, Comparative Examples 10M, 11M, and 16M to 18M, and Reference Examples 12M to 15M were prepared from the pigment dispersions and polymer emulsions obtained from and by the materials and methods described above according to the compositions shown in Table 2M. Each water-based ink composition was prepared by stirring and mixing materials described in Table 2M in amounts described in the table at room temperature for 2 hours and filtering the resulting mixture with a membrane filter having 5 μm pores. In Table 2M, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2M

| | Examples | | | | | | | |
|---|---|---|---|---|---|---|---|---|
| Ink composition | 9M | 10M | 11M | 12M | 13M | 14M | 15M | 16M |
| Pigment dispersion K1M | 40 (5.2) | | | | | | | |
| Pigment dispersion K2M | | | | | 60 (6.8) | | | |
| Pigment dispersion K3M | | | | | | | | |
| Pigment dispersion K4M | | | | | | | | |
| Pigment dispersion K5M | | | | | | | | |
| Pigment dispersion Y1M | | 40 (5.5) | | | | | | |
| Pigment dispersion Y2M | | | | | | 50 (6.1) | | |
| Pigment dispersion Y3M | | | | | | | | |
| Pigment dispersion Y4M | | | | | | | | |
| Pigment dispersion M1M | | | 40 (6.3) | | | | | |
| Pigment dispersion M2M | | | | | | | 50 (6.3) | |
| Pigment dispersion M3M | | | | | | | | |
| Pigment dispersion M4M | | | | | | | | |
| Pigment dispersion C1M | | | | 40 (3.6) | | | | |
| Pigment dispersion C2M | | | | | | | | 40 (4.0) |
| Pigment dispersion C3M | | | | | | | | |
| Pigment dispersion C4M | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17M | 18M | 19M | 20M | 21M | 22M | 23M | 24M |
| Pigment dispersion K1M | 35 (4.6) | | | | | | | |
| Pigment dispersion K2M | | | | | 50 (5.7) | | | |
| Pigment dispersion K3M | | | | | | | | |
| Pigment dispersion K4M | | | | | | | | |
| Pigment dispersion K5M | | | | | | | | |
| Pigment dispersion Y1M | | 45 (6.2) | | | | | | |
| Pigment dispersion Y2M | | | | | | 45 (5.5) | | |
| Pigment dispersion Y3M | | | | | | | | |
| Pigment dispersion Y4M | | | | | | | | |
| Pigment dispersion M1M | | | 35 (5.5) | | | | | |
| Pigment dispersion M2M | | | | | | | 45 (5.7) | |
| Pigment dispersion M3M | | | | | | | | |
| Pigment dispersion M4M | | | | | | | | |
| Pigment dispersion C1M | | | | 45 (4.1) | | | | |
| Pigment dispersion C2M | | | | | | | | 50 (4.5) |
| Pigment dispersion C3M | | | | | | | | |
| Pigment dispersion C4M | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10M | 11M | 12M | 13M | 14M | 15M | 16M | 17M | 18M |
| Pigment dispersion K1M | | | | | | | | | |
| Pigment dispersion K2M | | | | | | | | | |
| Pigment dispersion K3M | 40 (5.2) | | | | | | | | |
| Pigment dispersion K4M | | | | | 40 (5.2) | | | | |
| Pigment dispersion K5M | | | | | | | | | 20 (4.0) |
| Pigment dispersion Y1M | | | | | | | | | |
| Pigment dispersion Y2M | | | | | | | | | |
| Pigment dispersion Y3M | | 40 (5.7) | | | | | | | |
| Pigment dispersion Y4M | | | | | | 40 (5.5) | | | |
| Pigment dispersion M1M | | | | | | | | | |
| Pigment dispersion M2M | | | | | | | | | |
| Pigment dispersion M3M | | | 40 (6.3) | | | | | | |
| Pigment dispersion M4M | | | | | | | 40 (6.3) | | |
| Pigment dispersion C1M | | | | | | | | | |
| Pigment dispersion C2M | | | | | | | | | |
| Pigment dispersion C3M | | | | 40 (3.6) | | | | | |
| Pigment dispersion C4M | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1N

### Pigment Dispersion K1N

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)).

To 98 parts of the dispersion obtained from and by the materials and method described above, 2 parts of purine, i.e., a purine derivative, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1N (pigment-water-insoluble polymer solid concentration: 19.6 mass %) of this example.

### Example 2N

### Pigment Dispersion Y1N

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 parts of 2-amino-6-mercaptopurine, i.e., a purine derivative serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain pigment dispersion Y1N (pigment-water-insoluble polymer solid concentration: 18.0 mass %) of this example.

### Example 3N

### Pigment Dispersion M1N

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of guanine, i.e., a purine derivative serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain a pigment dispersion M1N (pigment-water-insoluble polymer solid concentration: 19.0 mass %) of this example.

### Example 4N

### Pigment Dispersion C1N

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of 2′-deoxyguanosine, i.e., a purine derivative serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain pigment dispersion C1N (pigment-water-insoluble polymer solid concentration: 18.0 mass %) of this example.

### Example 5N

### Pigment Dispersion K2N

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the pigment dispersion obtained from and by the materials and method described above, 5 parts of methylguanine, i.e., a purine derivative, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2N (pigment-water-insoluble polymer solid concentration: 19.0 mass %) of this example.

### Example 6N

### Pigment Dispersion Y2N

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of xanthine, i.e., a purine derivative serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2N (pigment-water-insoluble polymer solid concentration: 17.0 mass %) of this example.

### Example 7N

### Pigment Dispersion M2N

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of theophylline, i.e., a purine derivative serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain a pigment dispersion M2N (pigment-water-insoluble polymer solid concentration: 19.0 mass %) of this example.

### Example 8N

### Pigment Dispersion C2N

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of theobromine and 0.2 parts of adenosine, i.e., purine derivatives serving as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain pigment dispersion C2N (pigment-water-insoluble polymer solid concentration: 18.0 mass %) of this example.

### Comparative Example 1N

### Pigment Dispersion K3N

Pigment dispersion K3N of this comparative example having a pigment-water-insoluble polymer solid concentration of 19.6 mass % (pigment:water-insoluble polymer=10:5 (mass ratio)) was prepared from and by the same materials and method for pigment dispersion K1N (Example 1N) described above except that the heat treatment was not conducted.

### Comparative Example 2N

### Pigment Dispersion Y3N

Pigment dispersion Y3N of this comparative example having a pigment-water-insoluble polymer solid concentration of 18.4 mass % (pigment:water-insoluble polymer=10:3 (mass ratio)) was prepared from and by the same materials and method for pigment dispersion Y1N (Example 2N) described above except that, during the heat treatment, 2-amino-6-mercaptopurine, i.e., a purine derivative serving as a wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3N

### Pigment Dispersion M3N

Pigment dispersion M3N of this reference example having a pigment-water-insoluble polymer solid concentration of 19.0 mass % (pigment:water-insoluble polymer=10:2 (mass ratio)) was prepared from and by the same materials and method for pigment dispersion M1N (Example 3N) described above except that, during the heat treatment, the heating temperature was changed to 120° C. and the heating time was changed to 30 minutes.

### Reference Example 4N

### Pigment Dispersion C3N

Pigment dispersion C3N of this reference example having a pigment-water-insoluble polymer solid concentration of 18.0 mass % (pigment:water-insoluble polymer=10:10 (mass ratio)) was prepared from and by the same materials and method for pigment dispersion C1N (Example 4N) described above except that, during the heat treatment, the heating temperature was changed to 60° C. and the heating time was changed to 100 hours.

### Reference Example 5N

### Pigment Dispersion K4N

Pigment dispersion K4N of this reference example having a pigment-water-insoluble polymer solid concentration of 19.6 mass % (pigment:water-insoluble polymer=10:5 (mass ratio)) was prepared from and by the same materials and method for pigment dispersion K1N (Example 1N) described above except that, during the heat treatment, the heating time was changed to 20 minutes.

### Reference Example 6N

### Pigment Dispersion Y4N

Pigment dispersion Y4N of this reference example having a pigment-water-insoluble polymer solid concentration of 18.0 mass % (pigment:water-insoluble polymer=10:3 (mass ratio)) was prepared from and by the same materials and method for pigment dispersion Y1N (Example 2N) described above except that, during the heat treatment, the heating time was changed to 120 hours.

### Comparative Example 7N

### Pigment Dispersion M4N

Pigment dispersion M4N of this comparative example having a pigment-water-insoluble polymer solid concentration of 19.4 mass % (pigment:water-insoluble polymer=10:2 (mass ratio)) was prepared from and by the same materials and method for pigment dispersion M1N (Example 3N) described above except that, during the heat treatment, 0.05 parts of guanine, i.e., a purine derivative serving as a wetting agent, and 4.9 parts of 1,2-hexanediol, i.e., a water-soluble organic solvent, were used.

### Comparative Example 8N

### Pigment Dispersion C4N

Pigment dispersion C4N of this comparative example having a pigment-water-insoluble polymer solid concentration of 16.0 mass % (pigment:water-insoluble polymer=10:10 (mass ratio)) was prepared from and by the same materials and method for pigment dispersion C1N (Example 4N) described above except that, during the heat treatment, 11 parts of 2′-deoxyguanosine, i.e., a purine derivative serving as a wetting agent, and 80 parts of the dispersion were used.

### Comparative Example 9N

### Pigment Dispersion K5N

Twenty parts of MA 100 (trade name, product of Mitsubishi Chemical Corporation), i.e., carbon black serving as a pigment, 5 parts of methylguanine, i.e., a purine derivative, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5N of this comparative example having a pigment-water-insoluble polymer solid concentration of 23 mass % (pigment:water-insoluble polymer=10:1.5 (mass ratio)).

[Preparation of Water-Based Ink Composition N]

Water-based ink compositions of Examples 9N to 24N, comparative Examples 10N, 11N, and 16N to 18N, and Reference Examples 12N to 15N were prepared from the pigment dispersions and polymer emulsions obtained from and by the materials and methods described above according to the compositions shown in Table 2N. Each water-based ink composition was prepared by stirring and mixing materials described in Table 2N in amounts described in the table at room temperature for 2 hours and filtering the resulting mixture with a membrane filter having 5 μm pores. In Table 2N, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2N

| | Examples | | | | | | | |
|---|---|---|---|---|---|---|---|---|
| Ink composition | 9N | 10N | 11N | 12N | 13N | 14N | 15N | 16N |
| Pigment dispersion K1N | 40 (5.2) | | | | | | | |
| Pigment dispersion K2N | | | | | 60 (6.8) | | | |
| Pigment dispersion K3N | | | | | | | | |
| Pigment dispersion K4N | | | | | | | | |
| Pigment dispersion K5N | | | | | | | | |
| Pigment dispersion Y1N | | 40 (5.5) | | | | | | |
| Pigment dispersion Y2N | | | | | | 50 (6.1) | | |
| Pigment dispersion Y3N | | | | | | | | |
| Pigment dispersion Y4N | | | | | | | | |
| Pigment dispersion M1N | | | 40 (6.3) | | | | | |
| Pigment dispersion M2N | | | | | | | 50 (6.3) | |
| Pigment dispersion M3N | | | | | | | | |
| Pigment dispersion M4N | | | | | | | | |
| Pigment dispersion C1N | | | | 40 (3.6) | | | | |
| Pigment dispersion C2N | | | | | | | | 40 (4.0) |
| Pigment dispersion C3N | | | | | | | | |
| Pigment dispersion C4N | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17N | 18N | 19N | 20N | 21N | 22N | 23N | 24N |
| Pigment dispersion K1N | 35 (4.6) | | | | | | | |
| Pigment dispersion K2N | | | | | 50 (5.7) | | | |
| Pigment dispersion K3N | | | | | | | | |
| Pigment dispersion K4N | | | | | | | | |
| Pigment dispersion K5N | | | | | | | | |
| Pigment dispersion Y1N | | 45 (6.2) | | | | | | |
| Pigment dispersion Y2N | | | | | | 45 (5.5) | | |
| Pigment dispersion Y3N | | | | | | | | |
| Pigment dispersion Y4N | | | | | | | | |
| Pigment dispersion M1N | | | 35 (5.5) | | | | | |
| Pigment dispersion M2N | | | | | | | 45 (5.7) | |
| Pigment dispersion M3N | | | | | | | | |
| Pigment dispersion M4N | | | | | | | | |
| Pigment dispersion C1N | | | | 45 (4.1) | | | | |
| Pigment dispersion C2N | | | | | | | | 50 (4.5) |
| Pigment dispersion C3N | | | | | | | | |
| Pigment dispersion C4N | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10N | 11N | 12N | 13N | 14N | 15N | 16N | 17N | 18N |
| Pigment dispersion K1N | | | | | | | | | |
| Pigment dispersion K2N | | | | | | | | | |
| Pigment dispersion K3N | 40 (5.2) | | | | | | | | |
| Pigment dispersion K4N | | | | | 40 (5.2) | | | | |
| Pigment dispersion K5N | | | | | | | | | 20 (4.0) |
| Pigment dispersion Y1N | | | | | | | | | |
| Pigment dispersion Y2N | | | | | | | | | |
| Pigment dispersion Y3N | | 40 (5.7) | | | | | | | |
| Pigment dispersion Y4N | | | | | | 40 (5.5) | | | |
| Pigment dispersion M1N | | | | | | | | | |
| Pigment dispersion M2N | | | | | | | | | |
| Pigment dispersion M3N | | | 40 (6.3) | | | | | | |
| Pigment dispersion M4N | | | | | | | 40 (6.3) | | |
| Pigment dispersion C1N | | | | | | | | | |
| Pigment dispersion C2N | | | | | | | | | |
| Pigment dispersion C3N | | | | 40 (3.6) | | | | | |
| Pigment dispersion C4N | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### Example 1O

### Pigment Dispersion K1O

An aqueous sodium hydroxide solution was added to a water-insoluble polymer 1 solution prepared by dissolving 10 parts of dry solid of water-insoluble polymer 1 in 50 parts of methyl ethyl ketone to conduct neutralization. To the resulting mixture, 20 parts of carbon black MA100 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid-concentration of 20 mass % (pigment:water-insoluble polymer=10:5 (mass ratio)).

To 98 parts of the dispersion obtained from and by the materials and method described above, 2 parts of 4-hydroxypiperidine, i.e., a hydroxy cyclic amine compound, was added as a wetting agent, and the resulting mixture was thoroughly mixed. The resulting dispersion mixture was sealed in a polypropylene container, heat-treated for 5 hours in a 70° C. environment, and naturally cooled to room temperature to prepare a pigment dispersion K1O (pigment-water-insoluble polymer solid concentration: 19.6 mass %) of this example.

### Example 2O

### Pigment Dispersion Y1O

An aqueous sodium hydroxide solution was added to a water-insoluble polymer 2 solution prepared by dissolving 6 parts of dry solid of water-insoluble polymer 2 in 45 parts of methyl ethyl ketone to conduct neutralization. To the resulting mixture, 20 parts of C. I. pigment yellow 74, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:3 (mass ratio)). Into a four-necked flask equipped with a stirrer and a reflux condenser, 90 parts of the dispersion obtained from and by the materials and method described above was charged, and 7.5 parts of glycerol and 2 parts of triethylene glycol mono-n-butyl ether, i.e., water-soluble organic solvents, and 0.5 parts of N-methyl-3-hydroxypiperidine, a hydroxy cyclic amine compound serving as a wetting agent, were added thereto, followed by thorough stirring and mixing. The resulting dispersion mixture was heat-treated under stirring and refluxing for 50 hours while heating at 70° C. Then the mixture was naturally cooled to room temperature to obtain pigment dispersion Y1O (pigment-water-insoluble polymer solid concentration: 18.0 mass %) of this example.

### Example 3O

### Pigment Dispersion M1O

An aqueous sodium hydroxide solution was added to a water-insoluble polymer 3 solution prepared by dissolving 4 parts of dry solid of water-insoluble polymer 3 in 20 parts of methyl ethyl ketone to conduct neutralization. To the resulting mixture, 20 parts of C. I. pigment violet 19, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:2 (mass ratio)). To 95 parts of the dispersion obtained from and by the materials and method described above, 1.95 parts of 1,2-hexanediol, i.e., a water-soluble organic solvent, 3 parts of N-methyl-3-hydroxymethylpiperidine, i.e., a hydroxy cyclic amine compound serving as a wetting agent, and 0.05 parts of Proxel XL2 (trade name, product of AVECIA Co.) serving as a preservative were added, and the resulting mixture was thoroughly mixed. The resulting dispersion mixture was sealed in a polypropylene container and heat-treated for 100 hours in a 65° C. environment. Then the mixture was naturally cooled to room temperature to obtain a pigment dispersion M1O (pigment-water-insoluble polymer solid concentration: 19.0 mass %) of this example.

### Example 4O

### Pigment Dispersion C1O

An aqueous sodium hydroxide solution was added to a water-insoluble polymer 4 solution prepared by dissolving 20 parts of dry solid of water-insoluble polymer 4 in 80 parts of methyl ethyl ketone to conduct neutralization. To the resulting mixture, 20 parts of C. I. pigment blue 15:4, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:10 (mass ratio)). Into a four-necked flask equipped with a stirrer and a reflux condenser, 90 parts of the dispersion obtained from and by the materials and method described above was charged, and 7 parts of glycerol and 2 parts of triethylene glycol mono-n-butyl ether, i.e., water-soluble organic solvents, and 1 part of N-(2-hydroxyethyl)piperazine, a hydroxy cyclic amine compound serving as a wetting agent, were added thereto, followed by thorough stirring and mixing. The resulting dispersion mixture was heat-treated under stirring and refluxing for 2 hours while heating at 95° C. Then the mixture was naturally cooled to room temperature to obtain pigment dispersion C1O (pigment-water-insoluble polymer solid concentration: 18.0 mass %) of this example.

### Example 5O

### Pigment Dispersion K2O

An aqueous potassium hydroxide solution was added to a water-insoluble polymer 2 solution prepared by dissolving 10 parts of dry solid of water-insoluble polymer 2 in 50 parts of methyl ethyl ketone to conduct neutralization. To the resulting mixture, 15 parts of carbon black MA7 (trade name, product of Mitsubishi Chemical Corporation), i.e., a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:6.7 (mass ratio)).

To 95 parts of the dispersion obtained from and by the materials and method described above, 5 parts of N-(2-hydroxyethyl)morpholine, i.e., a hydroxy cyclic amine compound, was added as a wetting agent, and the resulting mixture was thoroughly mixed. The resulting dispersion mixture was sealed in a polypropylene container, heat-treated for 20 hours in a 90° C. environment, and naturally cooled to room temperature to prepare a pigment dispersion K2O (pigment-water-insoluble polymer solid concentration: 19.0 mass %) of this example.

### Example 6O

### Pigment Dispersion Y2O

An aqueous ammonia solution was added to a water-insoluble polymer 3 solution prepared by dissolving 4 parts of dry solid of water-insoluble polymer 3 in 20 parts of methyl ethyl ketone to conduct neutralization. To the resulting mixture, 10 parts of C. I. pigment yellow 180, i.e., an organic pigment serving as a coloring matter, was added. The resulting mixture was dispersed for 10 hours in a ball mill with zirconia beads to prepare a kneaded material. To the resulting kneaded material, 150 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:4 (mass ratio)).

Into a four-necked flask equipped with a stirrer and a reflux condenser, 85 parts of the dispersion obtained from and by the materials and method described above was charged, and 4.9 parts of maltitol, i.e., a water-soluble organic solvent, 10 parts of N-(2-hydroxyethyl)pyrrole, i.e., a hydroxy cyclic amine compound serving as a wetting agent, and 0.1 parts of Denicide CSA (trade name, product of Nagase ChemteX Corporation) serving as a preservative were added thereto, followed by thorough stirring and mixing. The resulting dispersion mixture was heat-treated under stirring and refluxing for 72 hours while heating at 65° C. Then the mixture was naturally cooled to room temperature to obtain a pigment dispersion Y2O (pigment-water-insoluble polymer solid concentration: 17.0 mass %) of this example.

### Example 7O

### Pigment Dispersion M2O

An aqueous triethanolamine solution was added to a water-insoluble polymer 4 solution prepared by dissolving 5 parts of dry solid of water-insoluble polymer 4 in 20 parts of methyl ethyl ketone to conduct neutralization. To the resulting mixture, 10 parts of C. I. pigment red 122, i.e., an organic pigment serving as a coloring matter, was added. The resulting mixture was dispersed for 10 hours in a ball mill with zirconia beads to prepare a kneaded material. To the resulting kneaded material, 100 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:5 (mass ratio)). To 95 parts of the resulting dispersion obtained from and by the materials and method described above, 4.9 parts of triethylene glycol, i.e., a water-soluble organic solvent, and 0.1 parts of pyrrolinol, i.e., a hydroxy cyclic amine compound serving as a wetting agent, were added, and the resulting mixture was thoroughly stirred and mixed. The resulting dispersion mixture was sealed in a polypropylene container and heat-treated for 100 hours in a 70° C. environment. Then the mixture was naturally cooled to room temperature to obtain a pigment dispersion M2O (pigment-water-insoluble polymer solid concentration: 19.0 mass %) of this example.

### Example 8O

### Pigment Dispersion C2O

An aqueous lithium hydroxide solution was added to a water-insoluble polymer 1 solution prepared by dissolving 8 parts of dry solid of water-insoluble polymer 1 in 30 parts of methyl ethyl ketone to conduct neutralization. To the resulting mixture, 10 parts of C. I. pigment blue 15:3, i.e., an organic pigment serving as a coloring matter, was added. The resulting mixture was dispersed for 10 hours in a ball mill with zirconia beads to prepare a kneaded material. To the resulting kneaded material, 120 parts of ion exchange water was added, followed by stirring and mixing, and the resulting mixture was transferred to an evaporator to remove all methyl ethyl ketone and part of water while heating at 60° C. in a reduced pressure environment to thereby prepare a dispersion having a solid concentration of 20 mass % (pigment:water-insoluble polymer=10:8 (mass ratio)). Into a four-necked flask equipped with a stirrer and a reflux condenser, 90 parts of the dispersion obtained from and by the materials and method described above was charged, and 7.6 parts of trimethylolpropane and 2 parts of 1,2-hexanediol, i.e., water-soluble organic solvents, and 0.2 parts of N-(2-hydroxyethyl)ethylene imine and 0.2 parts of 3-oxypyrazole, i.e., hydroxy cyclic amine compounds serving as wetting agents, were added thereto, followed by thorough stirring and mixing. The resulting dispersion mixture was heat-treated under stirring and refluxing for 30 minutes while heating at 100° C. Then the mixture was naturally cooled to room temperature to obtain pigment dispersion C2O (pigment-water-insoluble polymer solid concentration: 18.0 mass %) of this example.

### Comparative Example 1O

### Pigment Dispersion K3O

Pigment dispersion K3O of this comparative example having a pigment-water-insoluble polymer solid concentration of 19.6 mass % (pigment:water-insoluble polymer=10:5 (mass ratio)) was prepared from and by the same materials and method for pigment dispersion K1O (Example 1O) described above except that the heat treatment was not conducted.

### Comparative Example 2O

### Pigment Dispersion Y3O

Pigment dispersion Y3O of this comparative example having a pigment-water-insoluble polymer solid concentration of 18.4 mass % (pigment:water-insoluble polymer=10:3 (mass ratio)) was prepared from and by the same materials and method for pigment dispersion Y1O (Example 2O) described above except that, during the heat treatment, N-methyl-3-hydroxypiperidine, i.e., a hydroxy cyclic amine compound serving as a wetting agent, was not added but a mixture of 92 parts of the dispersion, and 6 parts of glycerol and 2 parts of triethylene glycol mono-n-butyl ether, i.e., water-soluble organic solvents, was used.

### Reference Example 3O

### Pigment Dispersion M3O

Pigment dispersion M3O of this reference example having a pigment-water-insoluble polymer solid concentration of 19.0 mass % (pigment:water-insoluble polymer=10:2 (mass ratio)) was prepared from and by the same materials and method for pigment dispersion M1O (Example 3O) described above except that, during the heat treatment, the heating temperature was changed to 120° C. and the heating time was changed to 30 minutes.

### Reference Example 4O

### Pigment Dispersion C3O

Pigment dispersion C3O of this reference example having a pigment-water-insoluble polymer solid concentration of 18.0 mass % (pigment:water-insoluble polymer=10:10 (mass ratio)) was prepared from and by the same materials and method for pigment dispersion C1O (Example 4O) described above except that, during the heat treatment, the heating temperature was changed to 60° C. and the heating time was changed to 100 hours.

### Reference Example 5O

### Pigment Dispersion K4O

Pigment dispersion K4O of this reference example having a pigment-water-insoluble polymer solid concentration of 19.6 mass % (pigment:water-insoluble polymer=10:5 (mass ratio)) was prepared from and by the same materials and method for pigment dispersion K1O (Example 1O) described above except that, during the heat treatment, the heating time was changed to 20 minutes.

### Reference Example 6O

### Pigment Dispersion Y4O

Pigment dispersion Y4O of this reference example having a pigment-water-insoluble polymer solid concentration of 18.0 mass % (pigment:water-insoluble polymer=10:3 (mass ratio)) was prepared from and by the same materials and method for pigment dispersion Y1O (Example 2O) described above except that, during the heat treatment, the heating time was changed to 120 hours.

### Comparative Example 7O

### Pigment Dispersion M4O

Pigment dispersion M4O of this comparative example having a pigment-water-insoluble polymer solid concentration of 19.4 mass % (pigment:water-insoluble polymer=10:2 (mass ratio)) was prepared from and by the same materials and method for pigment dispersion M1O (Example 3O) described above except that, during the heat treatment, 0.05 parts of N-methyl-3-hydroxymethylpiperidine, i.e., a hydroxy cyclic amine compound serving as a wetting agent, and 4.9 parts of 1,2-hexanediol, i.e., a water-soluble organic solvent, were used.

### Comparative Example 8O

### Pigment Dispersion C4O

Pigment dispersion C4O of this comparative example having a pigment-water-insoluble polymer solid concentration of 16.0 mass % (pigment:water-insoluble polymer=10:10 (mass ratio)) was prepared from and by the same materials and method for pigment dispersion C1N (Example 4N) described above except that, during the heat treatment, 11 parts of N-(2-hydroxyethyl)piperazine, a hydroxy cyclic amine compound serving as a wetting agent, and 80 parts of the dispersion were used.

### Comparative Example 9O

### Pigment Dispersion K5O

Twenty parts of MA 100 (trade name, product of Mitsubishi Chemical Corporation), i.e., carbon black serving as a pigment, 5 parts of N-(2-hydroxyethyl)morpholine, i.e., a hydroxy cyclic amine compound, 30 parts of a 1 mass % aqueous solution of Surfynol 440 (trade name, product of Air Products and Chemicals. Inc.), i.e., an acetylene glycol-based surfactant serving as a defoaming agent, and 30 parts of ion exchange water were mixed and stirred. The resulting mixture was dispersed in a nanomizer. To the resulting mixture, 15 parts of a 20 mass % aqueous solution of JONCRYL 611 (trade name, product of BASF Japan Ltd., weight-average molecular weight: 8100, acid value: 53 KOH mg/g), i.e., a styrene-acrylic acid-based resin water-soluble polymer serving as a dispersion resin, neutralized with triethanolamine was added, and the resulting mixture was stirred and mixed for 30 hours in a 25° C. environment. The resulting dispersion mixture was sealed in a polypropylene container and heat-treated for 20 hours in a 70° C. environment. Then the mixture was naturally cooled to room temperature to prepare pigment dispersion K5O of this comparative example having a pigment-water-insoluble polymer solid concentration of 23 mass % (pigment:water-insoluble polymer=10:1.5 (mass ratio)).

[Preparation of Water-Based Ink Composition O]

Water-based ink compositions of Examples 9O to 24O, Comparative Examples 10O, 11O, and 16O to 18O, and Reference Examples 12O to 15O were prepared from the pigment dispersions and polymer emulsions obtained from and by the materials and methods described above according to the compositions shown in Table 2O. Each water-based ink composition was prepared by stirring and mixing materials described in Table 2O in amounts described in the table at room temperature for 2 hours and filtering the resulting mixture with a membrane filter having 5 μm pores. In Table 2O, all figures are in terms of mass %, the figures inside the parentheses associated with the pigment dispersions indicate pigment solid concentrations, and the figures inside the parentheses associated with the polymer emulsions indicate polymer solid concentrations. Moreover, “balance” for ion exchange water indicates that the ion exchange water was added so that the total amount of the ink is 100 mass %.

TABLE 2O

| | Examples | | | | | | | |
|---|---|---|---|---|---|---|---|---|
| Ink composition | 9O | 10O | 11O | 12O | 13O | 14O | 15O | 16O |
| Pigment dispersion K1O | 40 (5.2) | | | | | | | |
| Pigment dispersion K2O | | | | | 60 (6.8) | | | |
| Pigment dispersion K3O | | | | | | | | |
| Pigment dispersion K4O | | | | | | | | |
| Pigment dispersion K5O | | | | | | | | |
| Pigment dispersion Y1O | | 40 (5.5) | | | | | | |
| Pigment dispersion Y2O | | | | | | 50 (6.1) | | |
| Pigment dispersion Y3O | | | | | | | | |
| Pigment dispersion Y4O | | | | | | | | |
| Pigment dispersion M1O | | | 40 (6.3) | | | | | |
| Pigment dispersion M2O | | | | | | | 50 (6.3) | |
| Pigment dispersion M3O | | | | | | | | |
| Pigment dispersion M4O | | | | | | | | |
| Pigment dispersion C1O | | | | 40 (3.6) | | | | |
| Pigment dispersion C2O | | | | | | | | 40 (4.0) |
| Pigment dispersion C3O | | | | | | | | |
| Pigment dispersion C4O | | | | | | | | |
| Polymer emulsion 1 | 5 (1.0) | | | | | | | 5 (1.0) |
| Polymer emulsion 2 | | 5 (1.0) | | | | | 5 (1.0) | |
| Polymer emulsion 3 | | | 5 (1.0) | | | 5 (1.0) | | |
| Polymer emulsion 4 | | | | 5 (1.0) | 5 (1.0) | | | |
| Glycerol | 10 | 7 | 10 | 7 | 15 | 10 | 15 | 10 |
| Triethylene glycol | 5 | | 2 | | | 2 | | |
| Trimethylolpropane | 3 | 5 | 3 | 5 | | 2 | | |
| 2-Pyrrolidone | 2 | | 2 | 2 | 2 | 1 | 2 | |
| Urea | | 2 | | | 1 | | 2 | |
| 1,2-Hexanediol | 2 | 2 | | 1 | 2 | 1 | 2 | |
| Triethylene glycol | 2 | 2 | 2 | 1 | 2 | 1 | 2 | 1 |
| monobutyl ether | | | | | | | | |
| Olfine E1010 | | 0.2 | | | 0.5 | 0.2 | | 0.2 |
| Surfynol 104 | 0.1 | | 0.6 | 0.2 | 0.5 | 0.2 | 0.5 | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |
| | Examples | | | | | | | |
| Ink composition | 17O | 18O | 19O | 20O | 21O | 22O | 23O | 24O |
| Pigment dispersion K1O | 35 (4.6) | | | | | | | |
| Pigment dispersion K2O | | | | | 50 (5.7) | | | |
| Pigment dispersion K3O | | | | | | | | |
| Pigment dispersion K4O | | | | | | | | |
| Pigment dispersion K5O | | | | | | | | |
| Pigment dispersion Y1O | | 45 (6.2) | | | | | | |
| Pigment dispersion Y2O | | | | | | 45 (5.5) | | |
| Pigment dispersion Y3O | | | | | | | | |
| Pigment dispersion Y4O | | | | | | | | |
| Pigment dispersion M1O | | | 35 (5.5) | | | | | |
| Pigment dispersion M2O | | | | | | | 45 (5.7) | |
| Pigment dispersion M3O | | | | | | | | |
| Pigment dispersion M4O | | | | | | | | |
| Pigment dispersion C1O | | | | 45 (4.1) | | | | |
| Pigment dispersion C2O | | | | | | | | 50 (4.5) |
| Pigment dispersion C3O | | | | | | | | |
| Pigment dispersion C4O | | | | | | | | |
| Polymer emulsion 1 | | | | | | | | 4 (0.8) |
| Polymer emulsion 2 | | | | | | 4 (0.8) | | |
| Polymer emulsion 3 | | | 4 (0.8) | | | | | |
| Polymer emulsion 4 | 4 (0.8) | | | | | | | |
| Glycerol | 10 | 7 | 15 | 10 | 10 | 8 | 15 | 10 |
| Triethylene glycol | 2 | | | 2 | 2 | | | |
| Trimethylolpropane | 3 | 5 | 2 | | 2 | 5 | | |
| 2-Pyrrolidone | 1 | | | 3 | 2 | | 2 | 2 |
| Urea | 1 | | | | 1 | | | |
| 1,2-Hexanediol | 3 | | 1 | 3 | 5 | | 3 | |
| Triethylene glycol | 2 | 5 | 2 | 3 | 5 | 5 | 3 | 2 |
| monobutyl ether | | | | | | | | |
| Olfine E1010 | | 0.2 | | | 0.5 | 0.3 | | 0.3 |
| Surfynol 104 | 0.3 | | 0.1 | 0.2 | 0.5 | 0.1 | | 0.1 |
| Triethanolamine | 1 | 1 | 1 | 1 | 1 | 1 | 1 | 1 |
| Ethylene diamine | 0.02 | 0.02 | 0.02 | 0.02 | 0.02 | 0.02 | 0.02 | 0.02 |
| tetraacetic acid disodium | | | | | | | | |
| salt | | | | | | | | |
| Benzotriazole | 0.01 | 0.01 | 0.01 | 0.01 | 0.01 | 0.01 | 0.01 | 0.01 |
| Ion exchange water | Balance | Balance | Balance | Balance | Balance | Balance | Balance | Balance |

| | Comparative | | | | | | | | |
|---|---|---|---|---|---|---|---|---|---|
| | Examples | | Reference Examples | | | | Comparative Examples | | |
| Ink composition | 10O | 11O | 12O | 13O | 14O | 15O | 16O | 17O | 18O |
| Pigment dispersion K1O | | | | | | | | | |
| Pigment dispersion K2O | | | | | | | | | |
| Pigment dispersion K3O | 40 (5.2) | | | | | | | | |
| Pigment dispersion K4O | | | | | 40 (5.2) | | | | |
| Pigment dispersion K5O | | | | | | | | | 20 (4.0) |
| Pigment dispersion Y1O | | | | | | | | | |
| Pigment dispersion Y2O | | | | | | | | | |
| Pigment dispersion Y3O | | 40 (5.7) | | | | | | | |
| Pigment dispersion Y4O | | | | | | 40 (5.5) | | | |
| Pigment dispersion M1O | | | | | | | | | |
| Pigment dispersion M2O | | | | | | | | | |
| Pigment dispersion M3O | | | 40 (6.3) | | | | | | |
| Pigment dispersion M4O | | | | | | | 40 (6.3) | | |
| Pigment dispersion C1O | | | | | | | | | |
| Pigment dispersion C2O | | | | | | | | | |
| Pigment dispersion C3O | | | | 40 (3.6) | | | | | |
| Pigment dispersion C4O | | | | | | | | 50 (4.0) | |
| Polymer emulsion 1 | 5 (1.0) | | | | 5 (1.0) | | | | |
| Polymer emulsion 2 | | 5 (1.0) | | | | 5 (1.0) | | | |
| Polymer emulsion 3 | | | 5 (1.0) | | | | 5 (1.0) | | |
| Polymer emulsion 4 | | | | 5 (1.0) | | | | 5 (1.0) | |
| Glycerol | 10 | 7 | 10 | 7 | 10 | 7 | 10 | 7 | 20 |
| Triethylene glycol | 5 | | 2 | | 5 | | 2 | | |
| Trimethylolpropane | 3 | 5 | 3 | 5 | 3 | 5 | 3 | 5 | |
| 2-Pyrrolidone | 2 | | 2 | 2 | 2 | | 2 | 2 | |
| Urea | | 2 | | | | 2 | | | |
| 1,2-Hexanediol | 2 | 2 | | 1 | 2 | 2 | | 1 | |
| Triethylene glycol | 2 | 2 | 2 | 1 | 2 | 2 | 2 | 1 | 10 |
| monobutyl ether | | | | | | | | | |
| Olfine E1010 | | 0.2 | | | | 0.2 | 1.1 | | 1 |
| Surfynol 104 | 0.1 | 0.2 | 0.6 | 0.2 | 0.1 | | 0.6 | 0.2 | |
| Triethanolamine | 1 | 1 | 1 | 1 | 1 | 1 | 1 | 1 | 0.5 |
| Ethylene diamine | 0.02 | 0.02 | 0.02 | 0.02 | 0.02 | 0.02 | 0.02 | 0.02 | |
| tetraacetic acid disodium | | | | | | | | | |
| salt | | | | | | | | | |
| Benzotriazole | 0.01 | 0.01 | 0.01 | 0.01 | 0.01 | 0.01 | 0.01 | 0.01 | 0.05 |
| Ion exchange water | Balance | Balance | Balance | Balance | Balance | Balance | Balance | Balance | Balance |

### <Evaluation of Pigment Dispersion and Water-Based Ink Composition>

### (1) Storage Stability

Pigment dispersions of Examples, Comparative Examples, and Reference Examples prepared as above and water-based compositions of Examples, Comparative Examples, and Reference Examples prepared as above were left in the following environments (I) to (III).

(I) Left to stand for 1 month at 60° C.
(II) Left to stand in a frozen state for 1 month.
(III) Left to stand for 2 weeks at 60° C. and then for one week in a frozen state.

The viscosities and particle diameters of the pigment dispersions and water-based ink compositions left to stand in the above-described three conditions were compared between after preparation and after being left to stand. The criteria for evaluation were as follows.

Viscosity

AA: Variation range was less than ±3% under all conditions.
A: Variation range was not less than ±3% but less than ±5% under some conditions.
B: Variation range was not less than ±5% but less than ±10% under some conditions.
C: Variation range was not less than ±10% but less than ±15% under some conditions.
D: Variation range was not less than ±15% under some conditions.

Particle Diameter

AA: Variation range was less than ±5% under all conditions.
A: Variation range was not less than ±5% but less than ±10% under some conditions.
B: Variation range was not less than ±10% but less than ±20% under some conditions.
C: Variation range was not less than ±20% but less than ±30% under some conditions.
D: Variation range was not less than ±30% under some conditions.

The evaluation results are shown in Tables 3A to 3O below.

TABLE 3A

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1A | 2A | 3A | 4A | 5A | 6A | 7A | 8A | 1A | 2A | 3A | 4A | 5A | 6A | 7A | 8A | 9A |
| Viscosity | AA | AA | A | AA | AA | A | A | A | D | C | C | B | D | C | C | D | B |
| Particle | AA | A | A | A | AA | B | A | B | D | D | C | C | B | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9A | 10A | 11A | 12A | 13A | 14A | 15A | 16A | 17A | 18A | 19A | 20A | 21A |
| Viscosity | AA | AA | A | AA | AA | A | A | A | AA | AA | A | AA | AA |
| Particle | AA | A | A | A | AA | B | B | A | A | A | A | A | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22A | 23A | 24A | 10A | 11A | 12A | 13A | 14A | 15A | 16A | 17A | 18A |
| Viscosity | A | A | A | D | D | B | C | D | C | D | D | B |
| Particle | A | B | A | D | D | C | D | D | D | C | D | C |
| diameter | | | | | | | | | | | | |

TABLE 3B

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1B | 2B | 3B | 4B | 5B | 6B | 7B | 8B | 1B | 2B | 3B | 4B | 5B | 6B | 7B | 8B | 9B |
| Viscosity | AA | A | A | AA | AA | A | A | A | D | C | C | B | D | C | C | D | B |
| Particle | AA | A | A | A | A | B | B | B | D | D | C | C | B | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9B | 10B | 11B | 12B | 13B | 14B | 15B | 16B | 17B | 18B | 19B | 20B | 21B |
| Viscosity | AA | A | A | AA | AA | A | A | A | AA | A | A | A | AA |
| Particle | AA | A | A | A | A | B | B | A | A | A | A | A | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22B | 23B | 24B | 10B | 11B | 12B | 13B | 14B | 15B | 16B | 17B | 18B |
| Viscosity | A | A | A | D | D | B | C | D | C | D | D | B |
| Particle | B | B | A | D | D | C | D | D | D | C | D | C |
| diameter | | | | | | | | | | | | |

TABLE 3C

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1C | 2C | 3C | 4C | 5C | 6C | 7C | 8C | 1C | 2C | 3C | 4C | 5C | 6C | 7C | 8C | 9C |
| Viscosity | AA | A | A | AA | A | A | A | A | D | C | C | C | D | C | C | D | B |
| Particle | AA | A | A | A | A | B | B | B | D | D | C | C | C | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9C | 10C | 11C | 12C | 13C | 14C | 15C | 16C | 17C | 18C | 19C | 20C | 21C |
| Viscosity | A | A | A | AA | A | A | A | A | A | A | A | A | A |
| Particle | AA | A | A | A | A | B | B | B | A | A | A | A | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22C | 23C | 24C | 10C | 11C | 12C | 13C | 14C | 15C | 16C | 17C | 18C |
| Viscosity | A | A | A | D | D | C | C | D | C | D | D | B |
| Particle | B | B | B | D | D | C | D | D | D | C | D | C |
| diameter | | | | | | | | | | | | |

TABLE 3D

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1D | 2D | 3D | 4D | 5D | 6D | 7D | 8D | 1D | 2D | 3D | 4D | 5D | 6D | 7D | 8D | 9D |
| Viscosity | AA | A | A | A | A | A | A | A | D | C | C | B | D | C | C | D | B |
| Particle | A | A | A | AA | A | B | B | B | D | D | C | C | B | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9D | 10D | 11D | 12D | 13D | 14D | 15D | 16D | 17D | 18D | 19D | 20D | 21D |
| Viscosity | AA | A | A | A | A | A | A | A | A | A | A | A | A |
| Particle | A | A | A | AA | A | B | A | B | A | A | A | A | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22D | 23D | 24D | 10D | 11D | 12D | 13D | 14D | 15D | 16D | 17D | 18D |
| Viscosity | A | A | A | D | D | B | C | D | C | D | D | B |
| Particle | B | B | B | D | D | C | D | D | D | C | D | C |
| diameter | | | | | | | | | | | | |

TABLE 3E

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1E | 2E | 3E | 4E | 5E | 6E | 7E | 8E | 1E | 2E | 3E | 4E | 5E | 6E | 7E | 8E | 9E |
| Viscosity | A | A | A | A | A | B | A | A | D | C | C | C | D | C | C | D | B |
| Particle | A | A | B | A | A | B | B | B | D | D | C | C | D | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9E | 10E | 11E | 12E | 13E | 14E | 15E | 16E | 17E | 18E | 19E | 20E | 21E |
| Viscosity | A | A | A | A | A | B | A | A | A | A | A | A | A |
| Particle | A | A | B | A | A | B | B | B | A | A | A | A | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22E | 23E | 24E | 10E | 11E | 12E | 13E | 14E | 15E | 16E | 17E | 18E |
| Viscosity | B | A | A | D | D | C | C | D | C | D | D | B |
| Particle | B | B | B | D | D | C | D | D | D | C | D | C |
| diameter | | | | | | | | | | | | |

TABLE 3F

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1F | 2F | 3F | 4F | 5F | 6F | 7F | 8F | 1F | 2F | 3F | 4F | 5F | 6F | 7F | 8F | 9F |
| Viscosity | AA | AA | A | AA | AA | A | A | A | D | C | C | B | D | C | C | D | B |
| Particle | AA | A | A | A | AA | B | A | B | D | D | C | C | B | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9F | 10F | 11F | 12F | 13F | 14F | 15F | 16F | 17F | 18F | 19F | 20F | 21F |
| Viscosity | AA | AA | A | AA | AA | A | A | A | AA | A | A | AA | AA |
| Particle | AA | A | A | A | AA | B | B | A | A | A | A | A | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22F | 23F | 24F | 10F | 11F | 12F | 13F | 14F | 15F | 16F | 17F | 18F |
| Viscosity | A | A | A | D | D | B | C | D | C | D | D | B |
| Particle | A | B | A | D | D | C | D | D | D | C | D | C |
| diameter | | | | | | | | | | | | |

TABLE 3G

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1G | 2G | 3G | 4G | 5G | 6G | 7G | 8G | 1G | 2G | 3G | 4G | 5G | 6G | 7G | 8G | 9G |
| Viscosity | AA | AA | A | AA | AA | A | A | A | D | C | C | B | D | C | C | D | B |
| Particle | AA | A | A | A | AA | B | A | B | D | D | C | C | B | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9G | 10G | 11G | 12G | 13G | 14G | 15G | 16G | 17G | 18G | 19G | 20G | 21G |
| Viscosity | AA | AA | A | AA | AA | A | A | A | AA | A | A | AA | AA |
| Particle | AA | A | A | A | AA | B | B | A | A | A | A | A | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22G | 23G | 24G | 10G | 11G | 12G | 13G | 14G | 15G | 16G | 17G | 18G |
| Viscosity | A | A | A | D | D | B | C | D | C | D | D | B |
| Particle | A | B | A | D | D | C | D | D | D | C | D | C |
| diameter | | | | | | | | | | | | |

TABLE 3H

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1H | 2H | 3H | 4H | 5H | 6H | 7H | 8H | 1H | 2H | 3H | 4H | 5H | 6H | 7H | 8H | 9H |
| Viscosity | A | AA | A | A | A | B | A | A | D | C | C | D | D | C | C | D | B |
| Particle | A | A | B | AA | A | B | B | B | D | D | C | C | C | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9H | 10H | 11H | 12H | 13H | 14H | 15H | 16H | 17H | 18H | 19H | 20H | 21H |
| Viscosity | A | AA | A | A | A | B | A | B | A | A | A | A | A |
| Particle | A | A | B | AA | A | B | B | B | A | A | A | AA | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22H | 23H | 24H | 10H | 11H | 12H | 13H | 14H | 15H | 16H | 17H | 18H |
| Viscosity | B | B | A | D | D | D | C | D | C | D | D | B |
| Particle | B | B | B | D | D | C | D | D | D | C | D | C |
| diameter | | | | | | | | | | | | |

TABLE 3I

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1I | 2I | 3I | 4I | 5I | 6I | 7I | 8I | 1I | 2I | 3I | 4I | 5I | 6I | 7I | 8I | 9I |
| Viscosity | A | AA | A | A | A | B | A | A | D | C | C | D | D | C | C | D | B |
| Particle | A | A | B | AA | A | B | B | B | D | D | C | C | C | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9I | 10I | 11I | 12I | 13I | 14I | 15I | 16I | 17I | 18I | 19I | 20I | 21I |
| Viscosity | A | AA | A | A | A | B | A | B | A | A | A | A | A |
| Particle | A | A | B | AA | A | B | B | B | A | A | A | AA | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22I | 23I | 24I | 10I | 11I | 12I | 13I | 14I | 15I | 16I | 17I | 18I |
| Viscosity | B | B | A | D | D | D | C | D | C | D | D | B |
| Particle | B | B | B | D | D | C | D | D | D | C | D | C |
| diameter | | | | | | | | | | | | |

TABLE 3J

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1J | 2J | 3J | 4J | 5J | 6J | 7J | 8J | 1J | 2J | 3J | 4J | 5J | 6J | 7J | 8J | 9J |
| Viscosity | A | AA | A | A | A | B | A | A | D | C | C | D | D | C | C | D | B |
| Particle | A | A | B | AA | A | B | B | B | D | D | C | C | C | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9J | 10J | 11J | 12J | 13J | 14J | 15J | 16J | 17J | 18J | 19J | 20J | 21J |
| Viscosity | A | AA | A | A | A | B | A | B | A | A | A | A | A |
| Particle | A | A | B | AA | A | B | B | B | A | A | A | AA | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22J | 23J | 24J | 10J | 11J | 12J | 13J | 14J | 15J | 16J | 17J | 18J |
| Viscosity | B | B | A | D | D | D | C | D | C | D | D | B |
| Particle | B | B | B | D | D | C | D | D | D | C | D | C |
| diameter | | | | | | | | | | | | |

TABLE 3K

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1K | 2K | 3K | 4K | 5K | 6K | 7K | 8K | 1K | 2K | 3K | 4K | 5K | 6K | 7K | 8K | 9K |
| Viscosity | A | AA | A | A | A | B | A | A | D | C | C | D | D | C | C | D | B |
| Particle | A | A | B | AA | A | B | B | B | D | D | C | C | C | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9K | 10K | 11K | 12K | 13K | 14K | 15K | 16K | 17K | 18K | 19K | 20K | 21K |
| Viscosity | A | AA | A | A | A | B | A | B | A | A | A | A | A |
| Particle | A | A | B | AA | A | B | B | B | A | A | A | AA | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22K | 23K | 24K | 10K | 11K | 12K | 13K | 14K | 15K | 16K | 17K | 18K |
| Viscosity | B | B | A | D | D | D | C | D | C | D | D | B |
| Particle | B | B | B | D | D | C | D | D | D | C | D | C |
| diameter | | | | | | | | | | | | |

TABLE 3L

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1L | 2L | 3L | 4L | 5L | 6L | 7L | 8L | 1L | 2L | 3L | 4L | 5L | 6L | 7L | 8L | 9L |
| Viscosity | A | AA | A | A | A | B | A | A | D | C | C | D | D | C | C | D | B |
| Particle | A | A | B | AA | A | B | B | B | D | D | C | C | C | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9L | 10L | 11L | 12L | 13L | 14L | 15L | 16L | 17L | 18L | 19L | 20L | 21L |
| Viscosity | A | AA | A | A | A | B | A | B | A | A | A | A | A |
| Particle | A | A | B | AA | A | B | B | B | A | A | A | AA | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22L | 23L | 24L | 10L | 11L | 12L | 13L | 14L | 15L | 16L | 17L | 18L |
| Viscosity | B | B | A | D | D | D | C | D | C | D | D | B |
| Particle | B | B | B | D | D | C | D | D | D | C | D | C |
| diameter | | | | | | | | | | | | |

TABLE 3M

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1M | 2M | 3M | 4M | 5M | 6M | 7M | 8M | 1M | 2M | 3M | 4M | 5M | 6M | 7M | 8M | 9M |
| Viscosity | A | AA | A | A | A | B | A | A | D | C | C | D | D | C | C | D | B |
| Particle | A | A | B | AA | A | B | B | B | D | D | C | C | C | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9M | 10M | 11M | 12M | 13M | 14M | 15M | 16M | 17M | 18M | 19M | 20M | 21M |
| Viscosity | A | AA | A | A | A | B | A | B | A | A | A | A | A |
| Particle | A | A | B | AA | A | B | B | B | A | A | A | AA | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22M | 23M | 24M | 10M | 11M | 12M | 13M | 14M | 15M | 16M | 17M | 18M |
| Viscosity | B | B | A | D | D | D | C | D | C | D | D | B |
| Particle | B | B | B | D | D | C | D | D | D | C | D | C |
| diameter | | | | | | | | | | | | |

TABLE 3N

| Pigment dispersion | | | |
|---|---|---|---|
| | Comparative | Reference | Comparative |
| Examples | Examples | Examples | Examples |

| | 1N | 2N | 3N | 4N | 5N | 6N | 7N | 8N | 1N | 2N | 3N | 4N | 5N | 6N | 7N | 8N | 9N |
|---|---|---|---|---|---|---|---|---|---|---|---|---|---|---|---|---|---|
| Viscosity | A | AA | A | A | A | B | A | A | D | C | C | D | D | C | C | D | B |
| Particle | A | A | B | AA | A | B | B | B | D | D | C | C | C | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9N | 10N | 11N | 12N | 13N | 14N | 15N | 16N | 17N | 18N | 19N | 20N | 21N |
| Viscosity | A | AA | A | A | A | B | A | B | A | A | A | A | A |
| Particle | A | A | B | AA | A | B | B | B | A | A | A | AA | A |
| diameter | | | | | | | | | | | | | |

| | Water-based ink composition | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22N | 23N | 24N | 10N | 11N | 12N | 13N | 14N | 15N | 16N | 17N | 18N |
| Viscosity | B | B | A | D | D | D | C | D | C | D | D | B |
| Particle | B | B | B | D | D | C | D | D | D | C | D | C |
| diameter | | | | | | | | | | | | |

TABLE 3O

| | Pigment dispersion | | | | | | | | | | | | | | | | |
|---|---|---|---|---|---|---|---|---|---|---|---|---|---|---|---|---|---|
| | | | | | | | | | Comparative | | Reference | | | | Comparative | | |
| | Examples | | | | | | | | Examples | | Examples | | | | Examples | | |
| | 1O | 2O | 3O | 4O | 5O | 6O | 7O | 8O | 1O | 2O | 3O | 4O | 5O | 6O | 7O | 8O | 9O |
| Viscosity | A | AA | A | A | A | B | A | A | D | C | C | D | D | C | C | D | B |
| Particle | A | A | B | AA | A | B | B | B | D | D | C | C | C | D | C | C | C |
| diameter | | | | | | | | | | | | | | | | | |

| | Water-based ink composition | | | | | | | | | | | | |
|---|---|---|---|---|---|---|---|---|---|---|---|---|---|
| | Examples | | | | | | | | | | | | |
| | 9O | 10O | 11O | 12O | 13O | 14O | 15O | 16O | 17O | 18O | 19O | 20O | 21O |
| Viscosity | A | AA | A | A | A | B | A | B | A | A | A | A | A |
| Particle | A | A | B | AA | A | B | B | B | A | A | A | AA | A |
| diameter | | | | | | | | | | | | | |

| | Water-based ink compositioO | | | | | | | | | | | |
|---|---|---|---|---|---|---|---|---|---|---|---|---|
| | | | | Comparative | | Reference | | | | Comparative | | |
| | Examples | | | Examples | | Examples | | | | Examples | | |
| | 22O | 23O | 24O | 10O | 11O | 12O | 13O | 14O | 15O | 16O | 17O | 18O |
| Viscosity | B | B | A | D | D | D | C | D | C | D | D | B |
| Particle | B | B | B | D | D | C | D | D | D | C | D | C |
| diameter | | | | | | | | | | | | |

### (2) Ejection Stability

Each of the water-ink compositions of Examples, Comparative Examples, and Reference Examples described above was charged in an ink jet printer, PX-G5300 (trade name, product of Seiko Epson Corporation). A4 photomatte paper/pigment only (trade name, Seiko Epson Corporation) was used as a recording medium. Mixed images including characters, filled regions, and photographic images were printed continuously on 1,000 sheets at 20° C. to 25° C. and 40% RH to 60% RH. The print setting was “Paper type: normal, Print quality: normal”. The obtained prints were observed with naked eye to check whether problems such as nonlinear flight and missing dots had occurred in printed images. The criteria for evaluation were as follows.

Nonlinear Flight and Missing Dots

AA: Neither nonlinear flight nor missing dots were observed up to 1,000 sheets of continuous printing.
A: Neither nonlinear flight nor missing dots were observed up to 500 sheets of continuous printing.
B: Neither nonlinear flight nor missing dots were observed up to 200 sheets of continuous printing.
C: Nonlinear flight or missing dots occurred before 200 sheets of continuous printing but the number of such problems was less than 10.
D: Ten or more nonlinear flight or missing dots occurred before 200 sheet's of continuous printing.

The evaluation results are shown in Tables 4A to 4O below.

TABLE 4A

| | Water-based ink composition | | | | | | | | | | | | | | | |
|---|---|---|---|---|---|---|---|---|---|---|---|---|---|---|---|---|
| | Examples | | | | | | | | | | | | | | | |
| | 9A | 10A | 11A | 12A | 13A | 14A | 15A | 16A | 17A | 18A | 19A | 20A | 21A | 22A | 23A | 24A |
| Nonlinear flight | AA | AA | A | AA | AA | B | A | B | AA | A | A | AA | AA | A | B | B |
| and missing | | | | | | | | | | | | | | | | |
| dots | | | | | | | | | | | | | | | | |

| | Water-based ink composition | | | | | | | | |
|---|---|---|---|---|---|---|---|---|---|
| | Comparative | | | | | | Comparative | | |
| | Examples | | Reference Examples | | | | Examples | | |
| | 10A | 11A | 12A | 13A | 14A | 15A | 16A | 17A | 18A |
| Nonlinear flight | C | D | C | C | C | C | C | D | C |
| and missing | | | | | | | | | |
| dots | | | | | | | | | |

TABLE 4B

| | Water-based ink composition | | | | | | | | | | | | | | | |
|---|---|---|---|---|---|---|---|---|---|---|---|---|---|---|---|---|
| | Examples | | | | | | | | | | | | | | | |
| | 9B | 10B | 11B | 12B | 13B | 14B | 15B | 16B | 17B | 18B | 19B | 20B | 21B | 22B | 23B | 24B |
| Nonlinear flight | AA | A | A | AA | AA | B | B | B | AA | A | A | A | AA | B | B | B |
| and missing | | | | | | | | | | | | | | | | |
| dots | | | | | | | | | | | | | | | | |

| | Water-based ink composition | | | | | | | | |
|---|---|---|---|---|---|---|---|---|---|
| | Comparative | | | | | | Comparative | | |
| | Examples | | Reference Examples | | | | Examples | | |
| | 10B | 11B | 12B | 13B | 14B | 15B | 16B | 17B | 18B |
| Nonlinear flight | C | D | C | C | C | C | C | D | C |
| and missing | | | | | | | | | |
| dots | | | | | | | | | |

TABLE 4C

| | Water-based ink composition | | | | | | | | | | | | | | | |
|---|---|---|---|---|---|---|---|---|---|---|---|---|---|---|---|---|
| | Examples | | | | | | | | | | | | | | | |
| | 9C | 10C | 11C | 12C | 13C | 14C | 15C | 16C | 17C | 18C | 19C | 20C | 21C | 22C | 23C | 24C |
| Nonlinear flight | A | A | A | AA | A | B | B | B | AA | A | A | A | A | B | B | B |
| and missing dots | | | | | | | | | | | | | | | | |

| | Water-based ink composition | | | | | | | | |
|---|---|---|---|---|---|---|---|---|---|
| | Comparative | | | | | | Comparative | | |
| | Examples | | Reference Examples | | | | Examples | | |
| | 10C | 11C | 12C | 13C | 14C | 15C | 16C | 17C | 18C |
| Nonlinear flight | D | D | C | C | D | C | D | D | C |
| and missing | | | | | | | | | |
| dots | | | | | | | | | |

TABLE 4D

| | Water-based ink composition | | | | | | | | | | | | | | | |
|---|---|---|---|---|---|---|---|---|---|---|---|---|---|---|---|---|
| | Examples | | | | | | | | | | | | | | | |
| | 9D | 10D | 11D | 12D | 13D | 14D | 15D | 16D | 17D | 18D | 19D | 20D | 21D | 22D | 23D | 24D |
| Nonlinear flight | AA | A | A | A | A | B | A | B | A | A | A | A | A | B | B | B |
| and | | | | | | | | | | | | | | | | |
| missing dots | | | | | | | | | | | | | | | | |

| | Water-based ink composition | | | | | | | | |
|---|---|---|---|---|---|---|---|---|---|
| | Comparative | | | | | | Comparative | | |
| | Examples | | Reference Examples | | | | Examples | | |
| | 10D | 11D | 12D | 13D | 14D | 15D | 16D | 17D | 18D |
| Nonlinear flight | C | D | C | C | C | C | C | D | C |
| and missing | | | | | | | | | |
| dots | | | | | | | | | |

TABLE 4E

| | Water-based ink composition | | | | | | | | | | | | | | | |
|---|---|---|---|---|---|---|---|---|---|---|---|---|---|---|---|---|
| | Examples | | | | | | | | | | | | | | | |
| | 9E | 10E | 11E | 12E | 13E | 14E | 15E | 16E | 17E | 18E | 19E | 20E | 21E | 22E | 23E | 24E |
| Nonlinear flight | A | A | B | A | A | B | B | B | A | A | A | A | A | B | B | B |
| and missing | | | | | | | | | | | | | | | | |
| dots | | | | | | | | | | | | | | | | |

| | Water-based ink composition | | | | | | | | |
|---|---|---|---|---|---|---|---|---|---|
| | Comparative | | | | | | Comparative | | |
| | Examples | | Reference Examples | | | | Examples | | |
| | 10E | 11E | 12E | 13E | 14E | 15E | 16E | 17E | 18E |
| Nonlinear flight | D | D | C | D | D | D | D | D | C |
| and missing | | | | | | | | | |
| dots | | | | | | | | | |

TABLE 4F

| | Water-based ink composition | | | | | | | | | | | | | | | |
|---|---|---|---|---|---|---|---|---|---|---|---|---|---|---|---|---|
| | Examples | | | | | | | | | | | | | | | |
| | 9F | 10F | 11F | 12F | 13F | 14F | 15F | 16F | 17F | 18F | 19F | 20F | 21F | 22F | 23F | 24F |
| Nonlinear flight | AA | AA | A | AA | AA | B | B | A | AA | A | A | AA | AA | A | B | B |
| and missing | | | | | | | | | | | | | | | | |
| dots | | | | | | | | | | | | | | | | |

| | Water-based ink composition | | | | | | | | |
|---|---|---|---|---|---|---|---|---|---|
| | Comparative | | | | | | Comparative | | |
| | Examples | | Reference Examples | | | | Examples | | |
| | 10F | 11F | 12F | 13F | 14F | 15F | 16F | 17F | 18F |
| Nonlinear flight | C | D | C | C | C | C | C | D | C |
| and missing | | | | | | | | | |
| dots | | | | | | | | | |

TABLE 4G

| | Water-based ink composition | | | | | | | | | | | | | | | |
|---|---|---|---|---|---|---|---|---|---|---|---|---|---|---|---|---|
| | Examples | | | | | | | | | | | | | | | |
| | 9G | 10G | 11G | 12G | 13G | 14G | 15G | 16G | 17G | 18G | 19G | 20G | 21G | 22G | 23G | 24G |
| Nonlinear flight | AA | AA | A | A | AA | B | B | A | AA | A | A | AA | A | A | B | B |
| and missing | | | | | | | | | | | | | | | | |
| dots | | | | | | | | | | | | | | | | |

| | Water-based ink composition | | | | | | | | |
|---|---|---|---|---|---|---|---|---|---|
| | Comparative | | | | | | Comparative | | |
| | Examples | | Reference Examples | | | | Examples | | |
| | 10G | 11G | 12G | 13G | 14G | 15G | 16G | 17G | 18G |
| Nonlinear flight | C | D | C | C | C | C | C | D | C |
| and missing | | | | | | | | | |
| dots | | | | | | | | | |

TABLE 4H

| | Water-based ink composition | | | | | | | | | | | | | | | |
|---|---|---|---|---|---|---|---|---|---|---|---|---|---|---|---|---|
| | Examples | | | | | | | | | | | | | | | |
| | 9H | 10H | 11H | 12H | 13H | 14H | 15H | 16H | 17H | 18H | 19H | 20H | 21H | 22H | 23H | 24H |
| Nonlinear flight | A | AA | A | A | A | B | B | B | A | A | A | A | A | B | B | B |
| and | | | | | | | | | | | | | | | | |
| missing dots | | | | | | | | | | | | | | | | |

| | Water-based ink composition | | | | | | | | |
|---|---|---|---|---|---|---|---|---|---|
| | Comparative | | | | | | Comparative | | |
| | Examples | | Reference Examples | | | | Examples | | |
| | 10H | 11H | 12H | 13H | 14H | 15H | 16H | 17H | 18H |
| Nonlinear flight | D | D | D | C | D | D | D | D | C |
| and missing | | | | | | | | | |
| dots | | | | | | | | | |

TABLE 4I

| | Water-based ink composition | | | | | | | | | | | | | | | | | | | | | | | | |
|---|---|---|---|---|---|---|---|---|---|---|---|---|---|---|---|---|---|---|---|---|---|---|---|---|---|
| | | | | | | | | | | | | | | | | | Comparative | | Reference | | | | Comparative | | |
| | Examples | | | | | | | | | | | | | | | | Examples | | Examples | | | | Examples | | |
| | 9I | 10I | 11I | 12I | 13I | 14I | 15I | 16I | 17I | 18I | 19I | 20I | 21I | 22I | 23I | 24I | 10I | 11I | 12I | 13I | 14I | 15I | 16I | 17I | 18I |
| Nonlinear | A | AA | A | A | A | B | B | B | A | A | A | A | A | B | B | B | D | D | D | C | D | D | D | D | C |
| flight and | | | | | | | | | | | | | | | | | | | | | | | | | |
| missing | | | | | | | | | | | | | | | | | | | | | | | | | |
| dots | | | | | | | | | | | | | | | | | | | | | | | | | |

TABLE 4J

| | Water-based ink composition | | | | | | | | | | | | | | | | | | | | | | | | |
|---|---|---|---|---|---|---|---|---|---|---|---|---|---|---|---|---|---|---|---|---|---|---|---|---|---|
| | | | | | | | | | | | | | | | | | Comparative | | Reference | | | | Comparative | | |
| | Examples | | | | | | | | | | | | | | | | Examples | | Examples | | | | Examples | | |
| | 9J | 10J | 11J | 12J | 13J | 14J | 15J | 16J | 17J | 18J | 19J | 20J | 21J | 22J | 23J | 24J | 10J | 11J | 12J | 13J | 14J | 15J | 16J | 17J | 18J |
| Nonlinear | A | AA | A | A | A | B | B | B | A | A | A | A | A | B | B | B | D | D | D | C | D | D | D | D | C |
| flight | | | | | | | | | | | | | | | | | | | | | | | | | |
| and | | | | | | | | | | | | | | | | | | | | | | | | | |
| missing | | | | | | | | | | | | | | | | | | | | | | | | | |
| dots | | | | | | | | | | | | | | | | | | | | | | | | | |

TABLE 4K

| | Water-based ink composition | | | | | | | | | | | | | | | |
|---|---|---|---|---|---|---|---|---|---|---|---|---|---|---|---|---|
| | Examples | | | | | | | | | | | | | | | |
| | 9K | 10K | 11K | 12K | 13K | 14K | 15K | 16K | 17K | 18K | 19K | 20K | 21K | 22K | 23K | 24K |
| Nonlinear flight | A | AA | A | A | A | B | B | B | A | A | A | A | A | B | B | B |
| and missing | | | | | | | | | | | | | | | | |
| dots | | | | | | | | | | | | | | | | |

| | Water-based ink composition | | | | | | | | |
|---|---|---|---|---|---|---|---|---|---|
| | Comparative | | | | | | Comparative | | |
| | Examples | | Reference Examples | | | | Examples | | |
| | 10K | 11K | 12K | 13K | 14K | 15K | 16K | 17K | 18K |
| Nonlinear flight | D | D | D | C | D | D | D | D | C |
| and missing | | | | | | | | | |
| dots | | | | | | | | | |

TABLE 4L

| | Water-based ink composition | | | | | | | | | | | | | | | |
|---|---|---|---|---|---|---|---|---|---|---|---|---|---|---|---|---|
| | Examples | | | | | | | | | | | | | | | |
| | 9L | 10L | 11L | 12L | 13L | 14L | 15L | 16L | 17L | 18L | 19L | 20L | 21L | 22L | 23L | 24L |
| Nonlinear flight | A | AA | A | A | A | B | B | B | A | A | A | A | A | B | B | B |
| and missing | | | | | | | | | | | | | | | | |
| dots | | | | | | | | | | | | | | | | |

| | Water-based ink composition | | | | | | | | |
|---|---|---|---|---|---|---|---|---|---|
| | Comparative | | | | | | Comparative | | |
| | Examples | | Reference Examples | | | | Examples | | |
| | 10L | 11L | 12L | 13L | 14L | 15L | 16L | 17L | 18L |
| Nonlinear flight | D | D | D | C | D | D | D | D | C |
| and missing | | | | | | | | | |
| dots | | | | | | | | | |

TABLE 4M

| | Water-based ink composition | | | | | | | | | | | | | | | |
|---|---|---|---|---|---|---|---|---|---|---|---|---|---|---|---|---|
| | Examples | | | | | | | | | | | | | | | |
| | 9M | 10M | 11M | 12M | 13M | 14M | 15M | 16M | 17M | 18M | 19M | 20M | 21M | 22M | 23M | 24M |
| Nonlinear flight | A | AA | A | A | A | B | B | B | A | A | A | A | A | B | B | B |
| and missing | | | | | | | | | | | | | | | | |
| dots | | | | | | | | | | | | | | | | |

| | Water-based ink composition | | | | | | | | |
|---|---|---|---|---|---|---|---|---|---|
| | Comparative | | | | | | Comparative | | |
| | Examples | | Reference Examples | | | | Examples | | |
| | 10M | 11M | 12M | 13M | 14M | 15M | 16M | 17M | 18M |
| Nonlinear flight | D | D | D | C | D | D | D | D | C |
| and missing | | | | | | | | | |
| dots | | | | | | | | | |

TABLE 4N

| | Water-based ink composition | | | | | | | | | | | | | | | |
|---|---|---|---|---|---|---|---|---|---|---|---|---|---|---|---|---|
| | Examples | | | | | | | | | | | | | | | |
| | 9N | 10N | 11N | 12N | 13N | 14N | 15N | 16N | 17N | 18N | 19N | 20N | 21N | 22N | 23N | 24N |
| Nonlinear flight | A | AA | A | A | A | B | B | B | A | A | A | A | A | B | B | B |
| and missing | | | | | | | | | | | | | | | | |
| dots | | | | | | | | | | | | | | | | |

| | Water-based ink composition | | | | | | | | |
|---|---|---|---|---|---|---|---|---|---|
| | Comparative | | | | | | Comparative | | |
| | Examples | | Reference Examples | | | | Examples | | |
| | 10N | 11N | 12N | 13N | 14N | 15N | 16N | 17N | 18N |
| Nonlinear flight | D | D | D | C | D | D | D | D | C |
| and missing | | | | | | | | | |
| dots | | | | | | | | | |

TABLE 4O

| | Water-based ink composition | | | | | | | | | | | | | | | |
|---|---|---|---|---|---|---|---|---|---|---|---|---|---|---|---|---|
| | Examples | | | | | | | | | | | | | | | |
| | 9O | 10O | 11O | 12O | 13O | 14O | 15O | 16O | 17O | 18O | 19O | 20O | 21O | 22O | 23O | 24O |
| Nonlinear flight | A | AA | A | A | A | B | B | B | A | A | A | A | A | B | B | B |
| and missing | | | | | | | | | | | | | | | | |
| dots | | | | | | | | | | | | | | | | |

| | Water-based ink composition | | | | | | | | |
|---|---|---|---|---|---|---|---|---|---|
| | Comparative | | | | | | Comparative | | |
| | Examples | | Reference Examples | | | | Examples | | |
| | 10O | 11O | 12O | 13O | 14O | 15O | 16O | 17O | 18O |
| Nonlinear flight | D | D | D | C | D | D | D | D | C |
| and missing | | | | | | | | | |
| dots | | | | | | | | | |

As obvious from the results shown in Tables 3A to 3O and 4A to 4O, the storage stability (viscosity fluctuation and particle size fluctuation) of the pigment dispersions of Examples was satisfactory. The storage stability (viscosity fluctuation and particle size fluctuation) of the water-based ink compositions of Examples containing the pigment dispersions was also satisfactory, and their ejection stability when used in the ink jet printer was not particularly problematic.

In contrast, the pigment dispersions of Comparative Examples showed poor storage stability (viscosity fluctuation and particle size fluctuation). The water-based ink compositions of Comparative Examples containing the pigment dispersions had no storage stability (viscosity fluctuation and particle size fluctuation) or ejection stability when used in the ink jet printer.

As described above, the pigment dispersion of the present invention has good storage stability and the water-based ink containing the pigment dispersion has good storage stability and ejection stability. Thus, the water-based ink composition containing the pigment dispersion of the present invention shows good ejection stability when applied to an ink jet recording method using a high driving frequency and can create high resolution prints.

1. A pigment dispersion at least comprising a pigment, a water-insoluble polymer that coats the pigment to make the pigment dispersible in water, a wetting agent, and water,
wherein the pigment dispersion is prepared by heating a dispersion at least containing the pigment, the water-insoluble polymer, and 0.1 mass % to 10 mass % of the wetting agent relative to the total amount of the dispersion.

2. The pigment dispersion according to claim 1, at least comprising the pigment, the water-insoluble polymer that coats the pigment to make the pigment dispersible in water, the wetting agent, and water,
wherein the pigment dispersion is prepared by heating a dispersion at least containing a dispersoid constituted by the pigment coated with the water-insoluble polymer, 0.1 mass % to 10 mass % of the wetting agent relative to the total amount of the dispersion, and water.

3. The pigment dispersion according to claim 1, wherein the wetting agent contained in the dispersion is at least one selected from the group consisting of an acetylene glycol-based surfactant, an acetylene alcohol-based surfactant, a siloxane-based surfactant, a fluorine-based surfactant, a polyoxyalkylene-based nonionic surfactant, an anionic surfactant, a resin solvent, an amide compound, an imidazole derivative, an azine compound, an azole compound, an amidine derivative, a hydroxypyridine derivative, a purine derivative, a hydroxy cyclic amine compound, and a glycerol ether compound represented by formula (I): 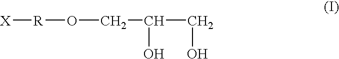
wherein R represents a linear, branched, or cyclic alkyl group having 1 to 20 carbon atoms and optionally containing a double bond, a triple bond, or a substituent, or a substituted or unsubstituted aryl group; and
X represents a hydrogen atom, a hydroxyl group, or a linear or branched alkoxy group having 1 to 5 carbon atoms.

4. The pigment dispersion according to claim 1, wherein the heating temperature during the heat treatment is in the range of 65° C. to 100° C. and the heating time is in the range of 30 minutes to 100 hours.

5. The pigment dispersion according to claim 1, wherein the dispersion further contains a water-soluble organic solvent.

6. The pigment dispersion according to claim 5, wherein the water-soluble organic solvent is at least one selected from the group consisting of a monohydric alcohol, a polyhydric alcohol, a sugar, a glycol ether, and a 1,2-alkyldiol.

7. A method for producing a pigment dispersion for use in a water-based ink composition, the method comprising:
a heat treatment step of heating a dispersion at least containing a pigment, a water-insoluble polymer that coats the pigment to make the pigment dispersible in water, and a wetting agent,
wherein, in the heat treatment step, the total amount of the wetting agent is in the range of 0.1 mass % to 10 mass % relative to the total amount of the dispersion.

8. The method for producing a pigment dispersion according to claim 7, wherein the heat treatment step comprises heating a dispersion at least containing a dispersoid constituted by the pigment coated with the water-insoluble polymer, the wetting agent, and water, and
in the heat treatment step, the total amount of the wetting agent is in the range of 0.1 mass % to 10 mass % relative to the total amount of the dispersion.

9. The method for producing a pigment dispersion according to claim 7, wherein the wetting agent is at least one selected from the group consisting of an acetylene glycol-based surfactant, an acetylene alcohol-based surfactant, a siloxane-based surfactant, a fluorine-based surfactant, a polyoxyalkylene-based nonionic surfactant, an anionic surfactant, a resin solvent, an amide compound, an imidazole derivative, an azine compound, an azole compound, an amidine derivative, a hydroxypyridine derivative, a purine derivative, a hydroxy cyclic amine compound, and a glycerol ether compound represented by formula (I): 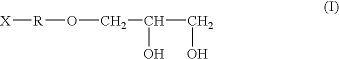
wherein R represents a linear, branched, or cyclic alkyl group having 1 to 20 carbon atoms and optionally containing a double bond, a triple bond, or a substituent, or a substituted or unsubstituted aryl group;
and X represents a hydrogen atom, a hydroxyl group, or a linear or branched alkoxy group having 1 to 5 carbon atoms.

10. The method for producing the pigment dispersion according to claim 7, wherein, in the heat treatment step, the heating temperature is in the range of 65° C. to 100° C. and the heating time is in the range of 30 minutes to 100 hours.

11. The method for producing the pigment dispersion according to claim 7, wherein the dispersion further contains a water-soluble organic solvent.

12. The method for producing the pigment dispersion according to claim 11, wherein the water-soluble organic solvent is at least one selected from the group consisting of a monohydric alcohol, a polyhydric alcohol, a sugar, a glycol ether, and a 1,2-alkyldiol.

13. A water-based ink composition comprising the pigment dispersion according to claim 1 or a pigment dispersion obtained by the method for producing a pigment dispersion according to claim 7.

14. The water-based ink composition according to claim 13, comprising at least one penetrant selected from the group consisting of a monohydric alcohol, a glycol ether, and a 1,2-alkyldiol.

15. The water-based ink composition according to claim 13, comprising at least one humectant selected from the group consisting of a polyhydric alcohol, a sugar, a lactam, and a urea.

16. The water-based ink composition according to claim 13, further comprising a polymer emulsion.

17. An ink jet recording method comprising: ejecting droplets of an ink composition and causing the droplets to adhere on a recording medium to conduct printing, wherein the water-based ink composition according to claim 13 is used.

18. A recorded matter recorded by the ink jet recording method according to claim 17.
